(19) United States
(12) Patent Application Publication
(10) Pub. No.: US 2010/0043580 A1
(43) Pub. Date: Feb. 25, 2010

(54) Curvilinear gear and method

(76) Inventor: Leo Bernier, North Hampton, NH (US)

Correspondence Address: Mark D Lorusso;Lorusso & Associates, Po Box 21915, Portsmouth, NH, 03802, US

(21) Appl. No.: 12/310,830

(22) PCT Filed: Sep. 7, 2007
(86) PCT No.: PCT/US07/19474

§ 371 Date: Mar. 9, 2009

Related U.S. Application Data
(60) Provisional application No. 60/842,724, filed on Sep. 7, 2006.

(51) Int. Cl. F16H 55/17; F16H 15/04; F16D 3/34

(52) U.S. Cl. 74/412 R; 476/55; 464/109

(57) ABSTRACT

A curvilinear gear system and method for transferring force and speed through a wide range of angles is disclosed. The system can optionally incorporate curvilinear U joints to increase effective range of angles to tailor the system to specific applications. The system includes complimentary gear heads, one of which is a curvilinear gear such as a hemispherical gear. A method of using the gear systems in a transmission apparatus is also disclosed.

### BACKGROUND OF THE INVENTION

The disclosure relates to mechanical gears and methods of using the gears for a wide variety of applications.

### DESCRIPTION OF THE ART

Gears, which can be described as toothed wheels, cylinders, or other machine elements that mesh with other toothed elements to transmit motion, or to change speed or direction, come in a wide variety of shapes and configurations. When two or more gears interact, the torque and the angular speed associated with an input gear are usually different than those produced by an output gear. This difference in torque and speed is a function of the difference in the radius of each gear.

The radius is measured from the gear axis of rotation to the point where one gear physically interacts with another. This radius is referred to as the “Lever Arm” of the gear as shown in FIG. 1. Referring to FIG. 2, the head of a gear often is geometrically circular with teeth formed or embedded on an outer (or inner) surface of the gear. In low torque applications, the toothed wheel can be replaced with a friction surface.

Gears usually are assembled in pairs. An input gear provides a torque and an angular speed along its axis of rotation that produces a force and a surface speed at the point of interaction of the gears. This force and surface speed is transferred to an output gear which transforms the force into a new torque and a new angular speed that may differ from that of the input gear. Two examples of this fundamental gear concept are shown in FIG. 3. The system on the left is a spur gear. The system on the right is a bevel gear in which the gears each occupy planes perpendicular to the other.

As stated, there are many different types of gears. The gear shown in FIG. 2 is known as a spur gear. A spur gear has teeth radially arrayed on the rim of the gear parallel to its axis of rotation. Other types of gears have been developed and improved over time to support specific applications. For example, when accuracy is important, a worm gear is often used. A bevel gear, such as that shown in FIG. 3, is often used to provide a change in direction. If a door is configured to open and close parallel to a wall to which it is attached, a rack and pinion gear arrangement is often used. Other examples are well known in the art.

Although different gear types may have different configurations, most, if not all, share the following characteristics:
1. Gears typically have a circular geometry. The rack portion of the rack and pinion gear is one exception to this rule.
2. Most gears operate by rotating about some fixed axis of rotation.
3. The speed on the surface of a gear head is a function of the angular velocity and the radius of the gear (the lever arm). The point of interaction is the touch point where a gear delivers a force at a certain speed to some other object, often times another gear.
4. The torque/force relationship of a gear remains constant. This results from the fact that Torque=Force×Lever Arm.

Some have looked at alternative gear designs such as hemispherical gears. For example, U.S. Pat. No. 6,467,374 discloses the use of one or more hemispherical gears to transmit torque and speed in a transmission application. The hemispherical gear of the '374 patent employs a mounting fork, the tines of which are attached to a bearing affixed to the gear at its large diameter so as to form pivot points to allow the gear head to pivot about a central axis. A double universal joint or other constant speed device such as a flexible shaft are attached to the gear head at some point along the central axis to allow the gear to rotate about the axis up to as much as 70° from the central axis. A control lever pivotally attached to a point on the major diameter of the gear provides a means to control the gear's pivot angle relative to the central axis.

The '374 patent hemispherical gear configuration provides continuously variable velocity transmission from one gear to another, but is considerably restricted due to the bearing and mounting fork configuration and the control mechanism. The gear is restricted by the limitations of having two mounting or contact points to secure the gear. This configuration essentially restricts movement to 2° of freedom and creates problems with respect to stabilization of the gear head.

What is needed and what I have developed is a gear system that has a greater range of motion and a greater angular variability between interacting gear heads. The gear system of my invention is not limited by the last two recited characteristics for gears.

### SUMMARY OF THE INVENTION

The disclosure covers a curvilinear gear that permits the dimension of the lever arm of a gear to vary continuously and/or intermittently between two points. The gear's geometry allows the point of interaction between two curvilinear gears to continuously change on the same gear head. In this manner, multiple lever arms are supported on one gear head. This novel concept also permits a surface of a gear head to be formed as any linear/non-linear shape, including elliptical and hemispherical shapes.

In one aspect of the disclosure, the gear comprises a hemispherical gear head with a friction surface or a surface substantially covered with gear teeth. The gear interacts with another gear having similar surface features to produce an infinite number of gear ratios between two limits.

In another aspect of the disclosure, two gear heads can be positioned and used to improve upon, and replace, conventional universal joint systems. The primary improvement over the conventional technology is that the torque and the angular velocity can be changed between two points in three dimensional space with no heat and vibration problems.

In a further aspect of the disclosure, two curvilinear gear heads can be incorporated into gear system for a power transmission device to continuously and variably change the gear ratio between the two gear heads, thereby reducing the number of gears needed in the power transmission device. The power transmission embodiment demonstrates the compatibility of the curvilinear gear and curvilinear U Joint concepts disclosure herein. These and other aspects of the invention will be apparent from a reading of the following detailed description along with a review of the appended drawings.

### BRIEF DESCRIPTION OF THE DRAWINGS

FIG. 1 is a diagrammatic representation of how force is generated by a common gear.

FIG. 2 is a perspective view of a spur gear.

FIG. 3 shows perspective views of prior art gear systems.

FIG. 4 is a diagrammatic representation in cross section of the comparative forces generated by a conventional prior art gear and a curvilinear gear.

FIG. 5 is another diagrammatic representation in cross section of the comparative forces generated by a conventional prior art gear and a hemispherical gear.

FIG. 6 is a sectional view of a hemispherical gear according to one embodiment of the disclosure.

FIG. 7 is a hemispherical gear system according to one embodiment of the disclosure.

FIG. 8 shows the range of motion of the hemispherical gear system shown in FIG. 7 when the gear head pivot points remain fixed.

FIG. 8A shows the range of motion of the hemispherical gear system shown in FIG. 7 when one shaft remains fixed.

FIG. 9 shows a sectional view of a hemispherical gear head and bearing assembly according to one embodiment of the disclosure.

FIG. 10 is a diagrammatic representation with exploded view of teeth and tooth-receiving cavities in two adjacent rows according to one embodiment of the disclosure.

FIG. 11 shows the interaction of gear heads relative to gear head quadrants on hemispherical gear heads according to one embodiment of the disclosure.

FIG. 12 shows selected teeth rows and circumference angles for the rows for a hemispherical gear head in cross section according to one embodiment of the disclosure.

FIG. 13 shows a range of gear head interaction orientations for a hemispherical gear system with the output shaft fixed according to one embodiment of the disclosure.

FIG. 13A shows multiple views of a curvilinear gear system according to one embodiment of the disclosure.

FIG. 13B shows an exploded view of a curvilinear gear system according to one embodiment of the invention.

FIG. 14 shows a fixed output shaft and stabilized input shaft for a hemispherical gear assembly according to one embodiment of the disclosure.

FIG. 15 shows a fixed input shaft and stabilized output shaft for a hemispherical gear assembly according to another embodiment of the disclosure.

FIG. 16 shows stabilized input and output shafts for a hemispherical gear assembly according to a further embodiment of the invention with the gear heads oriented at 45°.

FIG. 17 shows stabilized input and output shafts for a hemispherical gear assembly according to a further embodiment of the invention with the gear heads oriented with a first gear having an interaction point at the minor diameter and a second gear having an interaction point at the major diameter.

FIG. 18 shows stabilized input and output shafts for a hemispherical gear assembly according to a further embodiment of the invention with the gear heads oriented with a first gear having an interaction point at the major diameter and a second gear having an interaction point at the minor diameter.

FIG. 19 shows a hemispherical gear assembly with conventional universal joints according to another embodiment of the disclosure.

FIG. 20 shows the gear assembly of FIG. 19 with multiple conventional universal joints attached to each hemispherical gear head.

FIG. 21 shows the gear assembly of FIG. 20 with the conventional universal joints displaced in an upward direction.

FIG. 22 shows the gear assembly of FIG. 20 with the conventional universal joints displaced in a downward direction.

FIG. 23 is a diagrammatic representation of a hemispherical gear with conventional universal joints and their conventional operating angles.

FIG. 24 shows a comparison of a curvilinear universal gear and a curvilinear universal joint according to one embodiment of the disclosure.

FIG. 25 shows a range of gear head interaction orientations for a hemispherical universal joint system according to one embodiment of the disclosure.

FIG. 26 shows a drive train concept with gear head G_{A} oriented at 0°.

FIG. 27 shows a drive train concept with gear head G_{A} oriented at 45°.

FIG. 28 shows a drive train concept with gear head G_{A} oriented at 90°.

FIG. 29 shows a comparison of a conventional spur gear and a curvilinear flat gear.

FIG. 30 shows a side and front profile of a curvilinear flat gear.

FIG. 31 shows a flat gear interacting with a hemispherical gear.

FIG. 32 shows a drive train with a curvilinear universal joint, two gear heads and two flat gears in an “up” position according to one embodiment of the disclosure.

FIG. 33 shows a drive train with a curvilinear universal joint, two gear heads and two flat gears in a “neutral” position according to one embodiment of the disclosure.

FIG. 34 shows a drive train with a curvilinear universal joint two gear heads and two flat gears in a “down” position according to one embodiment of the disclosure.

FIG. 35 shows teeth footprints on a curvilinear gear and the relation of gear teeth to circular pitch according to one embodiment of the disclosure.

FIG. 36 shows two interacting curvilinear gear heads and interacting teeth row sets according to one embodiment of the disclosure.

FIG. 37 shows segments through a curvilinear gear according to one embodiment of the disclosure.

FIG. 38 shows the interaction of a curvilinear pinion and curvilinear gear according to one embodiment of the disclosure.

FIG. 39 shows the pitch point of interacting teeth on interacting curvilinear gears relative to pitch circles according to one embodiment of the disclosure.

FIG. 39A shows the ideal point of contact between the teeth of interacting curvilinear gears according to one embodiment of the disclosure.

FIG. 39B shows the pull point of contact between the teeth of interacting gears with different teeth dimensions according to one embodiment of the disclosure.

FIG. 40 shows the pitch point of interacting teeth on interacting curvilinear gears relative to pitch circles according to one embodiment of the invention.

FIG. 40A shows the ideal point of contact between the teeth of interacting gears according to one embodiment of the disclosure.

FIG. 40B shows the push point of contact between the teeth of interacting curvilinear gears with different teeth dimensions according to one embodiment of the disclosure.

FIG. 41 shows a curvilinear gear system according to one embodiment of the disclosure.

FIG. 42 shows rows positioned on a curvilinear gear according to one embodiment of the disclosure.

FIG. 43 illustrates different quadrants of interacting curvilinear gear heads according to one embodiment of the disclosure.

FIG. 44 shows an exploded view of the point of interaction between two curvilinear gear heads in a curvilinear gear system.

FIG. 45 shows the footprint of a tooth on a curvilinear gear according to one embodiment of the disclosure.

FIG. 46 shows the calculation of gear teeth and row spacing for a curvilinear gear head according to one embodiment of the disclosure.

FIG. 47 shows a prior art universal joint.

FIG. 48 shows a prior art universal joint.

FIG. 49 shows various prior art universal joint configurations.

FIG. 50 shows another prior art universal joint.

FIG. 51 shows a curvilinear U Joint according to one embodiment of the disclosure.

FIG. 52 is a sectional view of modified gear heads for a curvilinear U Joint system according to another embodiment of the disclosure.

FIG. 53 is a sectional view of a curvilinear U Joint system with interacting modified curvilinear gear heads in different rotational orientations according to one embodiment of the disclosure.

FIG. 54 is a sectional view of another modified curvilinear gear head for a curvilinear U Joint system according to further embodiment of the disclosure.

FIG. 54A shows a sectional view of a modified curvilinear gear head for a curvilinear U Joint according to a further embodiment of the disclosure.

FIG. 54B shows a high load curvilinear U Joint system according to another embodiment of the disclosure.

FIG. 55 shows alternative gear head embodiments in cross section for curvilinear U Joint systems according to multiple embodiments of the disclosure.

FIG. 56 shows a spline embodiment for the surface of a curvilinear gear head for curvilinear U Joint systems according to another embodiment of the disclosure.

FIG. 57 shows a partial sectional view of the performance range of a spline embodiment for the surface of curvilinear U Joint systems according to another embodiment of the disclosure.

FIG. 58 shows a spline system for a modified curvilinear gear head for curvilinear U Joint systems according to a further embodiment of the disclosure.

FIG. 59 shows a sectional view of a modified curvilinear gear head for curvilinear U Joint systems according to a further embodiment of the disclosure.

FIG. 60 shows a side sectional view of a curvilinear U Joint system with modified curvilinear gear heads according to a further embodiment of the disclosure.

FIG. 61 shows a side sectional view of a curvilinear U Joint system with modified curvilinear gear heads and movable shafts according to yet another embodiment of the disclosure.

FIG. 61A shows an exploded sectional view of a modified curvilinear gear head and movable shaft according to yet another embodiment of the disclosure.

FIG. 61B shows a side, top and sectional view of a modified curvilinear gear head according to yet another embodiment of the invention.

FIG. 61C shows multiple views of a curvilinear U Joint system with modified curvilinear gear heads and movable shafts according to yet another embodiment of the invention.

FIG. 61D shows an exploded view of a curvilinear U Joint system with modified curvilinear gear heads and movable shafts according to yet another embodiment of the invention.

FIG. 61E shows multiple positions of interaction between a modified curvilinear gear head and a complimentary curvilinear gear head with involute sections according to a yet further embodiment of the invention.

FIG. 62 shows a side sectional view of a curvilinear U Joint system with modified curvilinear gear heads and cam actuated shafts according to a further embodiment of the disclosure.

FIG. 62A shows an exploded sectional view of a modified curvilinear gear head and shaft assembly used in a cam actuated curvilinear U Joint system according to a further embodiment of the disclosure.

FIG. 62B shows a top sectional view of a cam actuated curvilinear U Joint system with harness according to a further embodiment of the disclosure.

FIG. 62C shows a side sectional view of a cam actuated curvilinear U Joint system with harness according to a further embodiment of the disclosure.

FIG. 62D shows a front sectional view of a cam actuated curvilinear U Joint system with harness according to a further embodiment of the disclosure.

FIG. 62E shows a top sectional view and exploded view of a harness system for a cam actuated curvilinear U Joint system according to a further embodiment of the disclosure.

FIG. 62F shows a side sectional view of a modified curvilinear gear head used in a curvilinear U Joint system and a curvilinear U Joint system with interacting gear heads oriented in different angles of rotation.

FIG. 62G shows a cam for a cam actuated curvilinear U Joint system according to a further embodiment of the disclosure.

FIG. 62H shows multiple views of a harness system for a cam actuated curvilinear U Joint system according to a further embodiment of the disclosure.

FIG. 62I shows an exploded view of a harness system for a cam actuated curvilinear U Joint system according to a further embodiment of the disclosure.

FIG. 63 shows a side sectional view of a further modified curvilinear gear head in a curvilinear U Joint system according to yet another embodiment of the disclosure.

FIG. 64 shows a side sectional view of a curvilinear gear head used in a friction-based curvilinear U Joint system according to another embodiment of the disclosure.

FIG. 64A shows a side sectional view of a friction-based curvilinear U Joint system according to another embodiment of the disclosure.

FIG. 65 shows a side sectional view of another modified curvilinear gear head as used in a curvilinear U Joint system according to yet another embodiment of the disclosure.

FIG. 65A shows a side sectional view of a curvilinear U Joint system with the modified curvilinear gear head shown in FIG. 65 according to yet another embodiment of the disclosure.

FIG. 66 shows a side sectional view of a modified curvilinear gear head the compliments the gear head shown in FIG. 65 according to yet another embodiment of the disclosure.

FIG. 67 shows a spline system for the modified curvilinear gear head shown in FIG. 66 according to yet another embodiment of the disclosure.

FIG. 68 shows a curvilinear U Joint System with the modified gear heads shown in FIGS. 65 and 66 according to a yet another embodiment of the disclosure.

FIG. 69 shows an exploded side sectional view of the modified curvilinear gear head shown in FIG. 65 according to a yet another embodiment of the disclosure.

FIG. 70 shows an exploded side sectional view of the modified curvilinear gear head shown in FIG. 66 according to a yet another embodiment of the disclosure.

FIG. 71 shows top, side and front views of a curvilinear U Joint system including gear head harness with hemispherical curvilinear gear heads according to one embodiment of the disclosure.

FIG. 72 shows a top view of a curvilinear U Joint harness according to one embodiment of the disclosure.

FIG. 73 shows a side view of a curvilinear U Joint harness according to one embodiment of the disclosure.

FIG. 74 shows front view of a curvilinear U Joint harness according to one embodiment of the disclosure.

FIG. 75 shows a prior art transmission.

FIG. 76 shows a curvilinear U Joint system with gear heads oriented in different positions of angular rotation according to one embodiment of the disclosure.

FIG. 77 shows a curvilinear U Joint system with a fixed output shaft according to another embodiment of the disclosure.

FIG. 78 shows a curvilinear U Joint system with a fixed input shaft according to another embodiment of the disclosure.

FIG. 79 shows a curvilinear gear system with both the fixed input and output shafts disconnected from the curvilinear gear heads according to a further embodiment of the disclosure.

FIG. 80 shows the curvilinear gear system of FIG. 79 with the pinion gear at the 0° angle of rotation.

FIG. 81 shows the curvilinear gear system of FIG. 79 with the pinion gear at the 90° angle of rotation.

FIG. 82 shows the curvilinear gear system of FIG. 79 with the pinion gear at the 45° angle of rotation with each gear head attached to one of the fixed input and output shafts with conventional universal joints and a central shaft according to a yet further embodiment of the disclosure.

FIG. 83 shows the curvilinear gear system of FIG. 79 with the pinion gear at the 45° angle of rotation with each gear head attached to one of the fixed input and output shafts with two single conventional universal joints, one double conventional universal joint and two central shafts according to a yet further embodiment of the disclosure.

FIG. 84 shows the curvilinear gear system shown in FIG. 83 with the pinion gear head rotated to 90°.

FIG. 85 shows the curvilinear gear system shown in FIG. 83 with the pinion gear head rotated to 0°.

FIG. 86 shows a diagrammatical breakdown of the angles of rotation of the universal joints used in the curvilinear gear system shown in FIG. 83.

FIG. 87 shows a comparison between a curvilinear gear system and a curvilinear U Joint system according to embodiments of the disclosure.

FIG. 88 shows a curvilinear U Joint system with interacting gear heads and fixed shafts rotated through different angles of orientation according to one embodiment of the disclosure.

FIG. 89 shows a curvilinear transmission with a curvilinear gear system and two curvilinear U Joint systems according to a yet further embodiment of the disclosure.

FIG. 90 shows the curvilinear transmission of FIG. 89 with the curvilinear pinion interacting with the curvilinear gear at 45°.

FIG. 91 shows the curvilinear transmission of FIG. 89 with the curvilinear pinion interacting with the curvilinear gear at 90°.

FIG. 92 shows a side sectional view of the curvilinear transmission shown in FIG. 89 with modified U Joint gear heads with the curvilinear pinion at 0° according to further embodiment of the disclosure.

FIG. 93 shows a side sectional view of the curvilinear transmission shown in FIG. 89 with modified U Joint gear heads with the curvilinear pinion at 45° according to further embodiment of the disclosure.

FIG. 94 shows a side sectional view of the curvilinear transmission shown in FIG. 89 with modified U Joint gear heads with the curvilinear pinion approaching 90° according to further embodiment of the disclosure.

FIG. 95 shows a top view of a control system and an enclosure for the curvilinear transmission shown in FIG. 89 according to one embodiment of the disclosure.

FIG. 96 shows a front elevational view of a control system and an enclosure for the curvilinear transmission shown in FIG. 89 according to one embodiment of the disclosure.

FIG. 97 shows a side elevational view of a control system and an enclosure for the curvilinear transmission shown in FIG. 89 according to one embodiment of the disclosure.

FIG. 98 shows a top view of a control system and an enclosure without gear heads for the curvilinear transmission shown in FIG. 89 according to one embodiment of the disclosure.

FIG. 99 shows a front elevational view of a control system and an enclosure without gear heads for the curvilinear transmission shown in FIG. 89 according to one embodiment of the disclosure.

FIG. 100 shows a side elevational view of a control system and an enclosure without gear heads for the curvilinear transmission shown in FIG. 89 according to one embodiment of the disclosure.

FIG. 101 shows back view of an enclosure for the curvilinear transmission shown in FIG. 89 according to one embodiment of the disclosure.

FIG. 102 shows a side view of an input side of an enclosure for the curvilinear transmission shown in FIG. 89 according to one embodiment of the disclosure.

FIG. 103 shows a side view of an output side of an enclosure for the curvilinear transmission shown in FIG. 89 according to one embodiment of the disclosure.

FIG. 104 shows a bottom view of an enclosure for the curvilinear transmission shown in FIG. 89 according to one embodiment of the disclosure.

FIG. 105 shows a top view of a control system for the curvilinear transmission shown in FIG. 89 according to one embodiment of the disclosure.

FIG. 106 shows a front view of a control system for the curvilinear transmission shown in FIG. 89 according to one embodiment of the disclosure.

FIG. 107 shows a side view of a control system for the curvilinear transmission shown in FIG. 89 according to one embodiment of the disclosure.

FIG. 108 shows a sectional view of a curvilinear transmission and an enclosure according to another embodiment of the invention.

FIG. 109 shows a side elevational view of the output end of a curvilinear transmission enclosure according to one embodiment of the invention.

FIG. 110 is an exploded view of a curvilinear transmission and an enclosure according to another embodiment of the invention.

FIG. 111 is a solid model of a curvilinear transmission and an enclosure according to another embodiment of the invention.

### DETAILED DESCRIPTION OF THE INVENTION

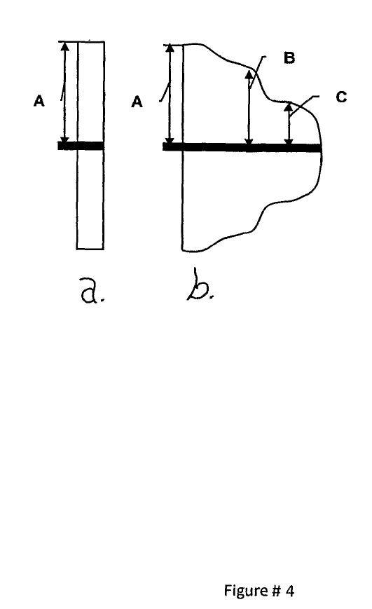

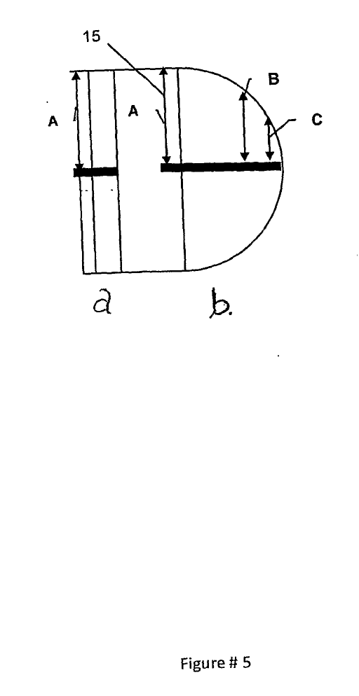

In one aspect of the invention as illustrated in FIGS. 4 and 5, a curvilinear gear, (designated b in FIG. 4), enables the lever arm 15 of the gear to change in length, such as at points A, B and C, whereas the lever arm of a spur gear (designated a in FIG. 4), remains constant across the cross-section or width of the gear. The change in the lever arm length changes as the point of interaction with a second gear changes. The degree of change of torque, force and speed is directly proportional to the distance of the point of interaction from the axis of rotation. One aspect of this concept is illustrated as a hemispherical gear as represented a b in FIG. 5.

A benefit of this gear arrangement is the ability to perform the same function as multiple gear assemblies such as those found in a drive train or automobile transmission. One set of curvilinear gears can continuously change torque, speed, and direction in both high and low torque applications. Change in direction is accommodated by a universal joint as explained more fully below. The end result is a simplification of gear systems without a compromise in function.

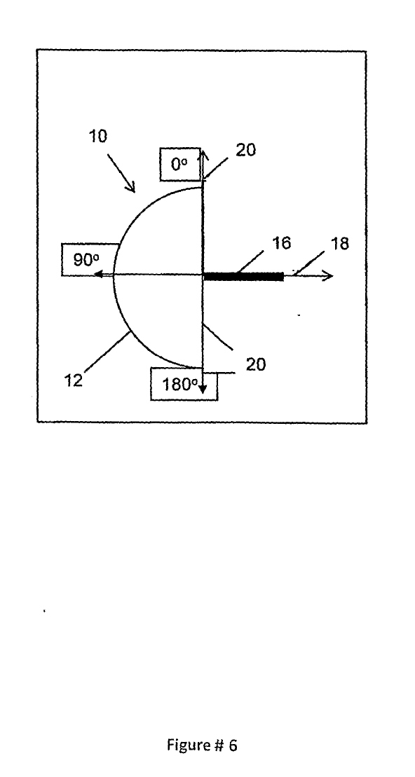

One illustrative embodiment is a hemispherical gear 10 having a circular cross-section gear head as shown in FIG. 6. As described, gear 10 has a hemispherical gear head surface 12 and a flat circular surface 14 bordering on the hemispherical surface for mounting to a shaft or other attachment. Gear surface 12 may be a friction surface or comprised of gear teeth as more fully described below. Gear 10 has a lever arm 15 (shown in FIG. 5) that changes length, longer to shorter, when traveling from the major diameter to the minor diameter of gear 10 as represented in FIG. 5 as lever arm lengths “A,” “B” and “C.” To rotate gear 10, a shaft 16 is attached to surface 14 coextensive with a central axis or axis of rotation 18 of gear 10.

The axis running perpendicularly to the axis of rotation is the gear head axis 20. The angle of the gear is measured from the gear head axis to the angle produced by circular surface 14. FIG. 6 shows the gear in a 0° position.

The connection between a shaft to the gear head can be fixed, pivoting and/or universally rotational as with a ball/cup configuration. With a fixed axis, gear head axis 20 and central axis 18 are oriented perpendicularly. With a pivoting axis, gear head axis 20 can range from about 0° to about 90° relative to central axis 18 along two axes. The size of the gear relative to the size of the teeth impacts the range. A large gear with small teeth will minimize the range while a small gear with relatively large teeth will increase the range. With a ball/cup configuration, the gear head axis/central axis orientation is omnidirectional about three axes and may range from about 0° to about 90° along any of the axes.

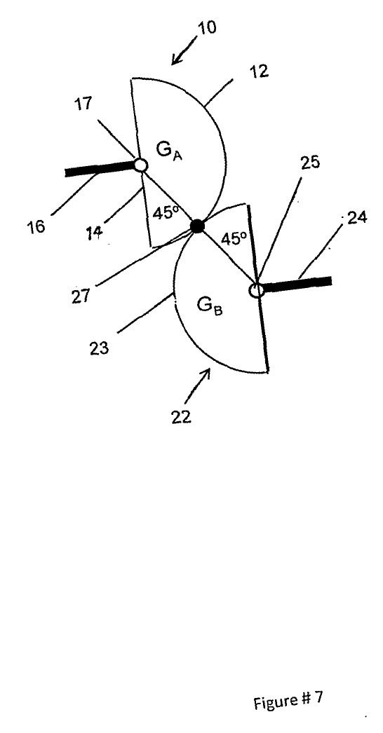

To transmit torque and speed, a second gear 22 interacting with gear surface 12 is required. Referring to FIG. 7, second gear 22 is also configured as a hemispherical gear having a hemispherical face 23 with a pivoting shaft 24 attached by a pivot point 25 to a second gear flat circular surface 26. It should be understood that second gear 22 may have a variety of different geometric configurations including, but not limited to, an elliptical surface, combined curvilinear and involute segments as shown in FIGS. In the hemispherical embodiment, shaft 16 is attached by a pivot point 17 to circular surface 14. When gear 10 rotates about its axis of rotation and interacts with second gear 22, a force and speed passes from gear 10 to second gear 22 at a point of interaction 27. At the point of interaction, the force and speed is the same for both gears 10 and 22. The angular speed and torque of each gear, however, is a function of the lever arm of each gear. The lever arm of each gear is determined by the distance between the point of interaction and each gear's axis of rotation. When the point of interaction for each gear is at 45° as shown in FIG. 7, the torque and angular velocity of both gears is the same.

As shown in FIG. 7, the point of interaction is set at 45° for each gear so the lever arms are identical. At this point, the gears act like spur gears having the same lever arm and the same radius. If each gear is permitted to rotate about its pivot point, the point of interaction will change, which will change the length of the lever arm of each gear. The torque and angular velocity of each gear will also change as a result.

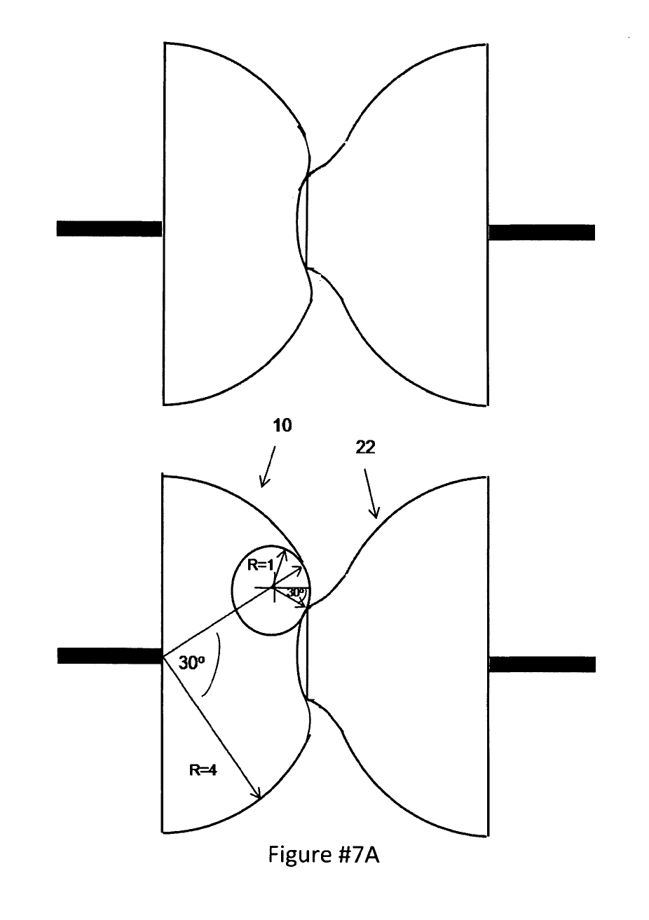

FIG. 8 illustrates the interaction of input gear 10 and second gear 22 at two extreme points and one midpoint of interaction. In the embodiment shown, both gears have fixed pivot points. In the first segment shown at left, input gear 10 has a point of interaction at its major diameter while output second gear 22 has a point of interaction at its minor diameter. In the second segment, each gear has a point of interaction at a midpoint diameter so that each has the same lever arm, torque and angular velocity. In the third segment at right, input gear 10 has a point of interaction at its minor diameter while output second gear 22 has a point of interaction at its major diameter. Important to this gear configuration is that the torque ratio and velocity ratio between the two gears varies continuously between two set limits as the gear heads rotate approximately 90°. The limits are determined by the size of the gears, i.e., their radii.

In contrast to gear heads with pivot points, if one gear head (such as gear 22 shown in FIG. 8A), has a fixed shaft, the angular range of motion of the input gear 10 (also commonly known in the art as the pinion gear), is +/−45°. In this configuration, the pivot point of pinion 10 moves in both a vertical and horizontal direction.

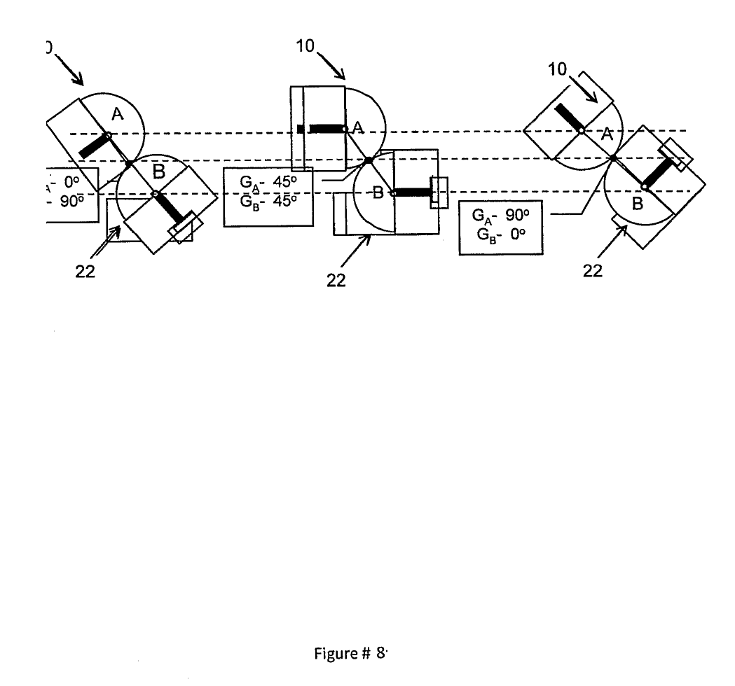

Referring now to FIG. 9, an embodiment of the hemispherical gear head is shown with a bearing 26 used to connect the gear head to shaft 16. This configuration provides a pivoting shaft/gear head arrangement. Attachment of the bearing, gear head and shaft can be accomplished by any means well known to those skilled in the art. The section designated “a” represents a section of the gear head that may be removed to accommodate bearing 26.

For low torque applications, friction surfaces may be used for the gear heads. Illustrative examples include rubber, neoprene and polymers. Friction surfaces have relatively few applications compared to gear teeth (described below) due to their inability to transfer energy in high torque applications.

Transitional physical mechanisms that can handle higher torque requirements than friction surfaces but do not use intermeshing gear teeth include gears with Velcro® surfaces and gear teeth interacting with a bed of rods. Torque capacity for such systems requires testing on a case-by-case basis.

For high torque applications, intermeshing or interlocking structures, such as gear teeth, are required to efficiently deliver the force from one gear to another. Although not intuitively obvious, when gear teeth are used for a curvilinear gear system, the teeth should be designed to accommodate intermeshing gear rotations of from about 0° to about 90° for one gear and from about 90° to about 0° for the other. This means that the interlocking mechanism for any θ for angles between 0° and 45° must be compatible for any 90°-θ for angles between 45° and 90°. The design of the gear teeth on the two complimentary circumferences is inter-dependent.

To create gear teeth, the following conditions should be considered to create an effective interlocking mechanism. First, the C_{θ} and the C_{90°-θ} form a complimentary set of circumferences. As used herein C is defined as the circumference around the hemispherical face of a hemispherical gear head at a particular angle. A tooth of the same size and geometry should fit equally well on both C_{θ} and C_{90°-}_{θ}. Second, gear teeth should be designed for each set of complimentary circumferences. The placement of the teeth will appear as circumferential rows on the head of the gear.

Third, the teeth should be dimensioned to permit a finite number of teeth to fit substantially on all complimentary and interacting circumferences. This is an important factor as space left over on a circumference after the teeth have been positioned is undesirable, and may be unacceptable if allowable tolerances are exceeded. Fourth, the tooth size need not remain a constant on different rows in the gear head. The geometry of gear teeth for a hemispherical gear can vary by row. For any complimentary set of circumferences, however, the geometry must be the same, and the size of the teeth should remain constant.

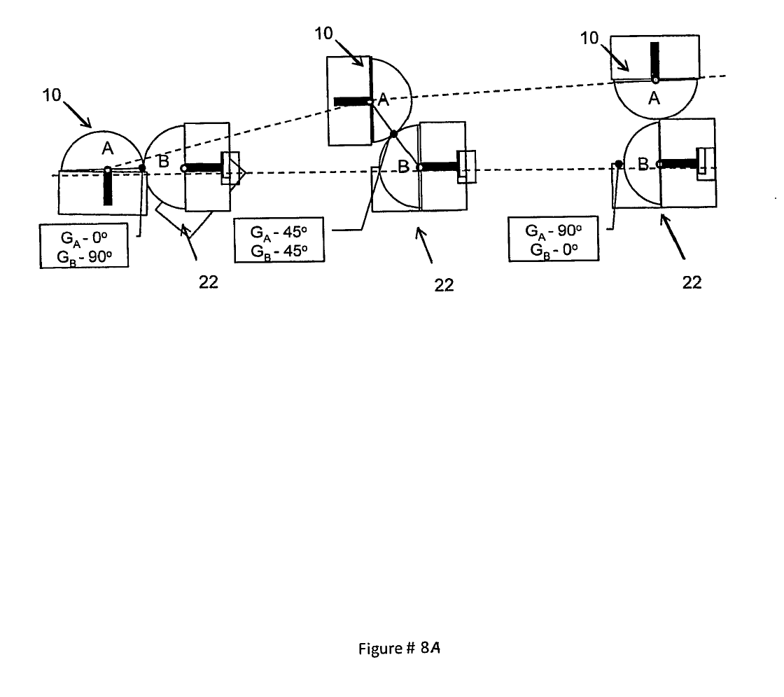

Fifth, the spacing between rows does not have to be constant or the same, but should be configured to assure a smooth transition between rows. Sixth, moving up the gear axis from the major diameter to the minor diameter, each new row of teeth should be positioned at the outer boundary of the teeth of the previous row as shown in FIG. 10.

As a seventh requirement, all teeth must be perpendicular to the head of the gear to ensure proper teeth interaction. Eighth, gear teeth can be arranged in many different forms. One illustrative option is to alternate concave and convex teeth, either by row or by tooth. A second illustrative option is to place all convex teeth on one gear and all concave teeth on a complimentary gear. It should be understood that these illustrative examples are not meant to limit the options for gear teeth arrangements.

A ninth and final consideration requires the layout of gear teeth to be identical on interacting gear teeth. This requirement enables one to focus on the layout of gear teeth on an initial gear, which subsequently can be used as a template to prepare the layout of gear teeth on a complimentary gear that interacts with the initial gear.

Referring to FIG. 10, in one embodiment, rows are comprised of teeth with tooth-receiving cavities 28 positioned between teeth 30. The cavities 28 are dimensioned to receive in a temporary locking engagement teeth 30 from an opposing gear. As each row may likely have a different number of teeth than other rows, positioning of teeth in a complimentary or different row of the other gear may prove difficult if the spacing between rows is not maintained uniformly even though row width for any complimentary set of circumferences can vary. With respect to arrangement of teeth, there are two basic alternatives. The first is to alternate teeth with tooth-receiving cavities. The second is to form one gear with rows of projecting teeth and form a second gear with rows of teeth-receiving cavities. Repeating pattern arrangements such as two adjacent teeth followed by one or more tooth-receiving cavities can also be implemented, but would be more difficult to accomplish.

For maximum effect and to ensure proper gear head interaction, the dimensions of teeth on complimentary gear surfaces should be maintained substantially the same to ensure similar strength capacities as strength requirements dictate tooth size. The layout of teeth on interacting gear surfaces should be identical.

With the last consideration in mind, tooth design and layout can be focused on a single gear as any gear interacting with the single gear will require teeth designs and layouts that compliment the single gear. Furthermore, tooth design and layout can be focused on a subsection of the gear, e.g., θ between 0° and 45°, because the teeth design and layout of the remaining gear sections, e.g., θ between 45° and 90°, are determined primarily by the tooth design and layout selections made for the initial gear subsection.

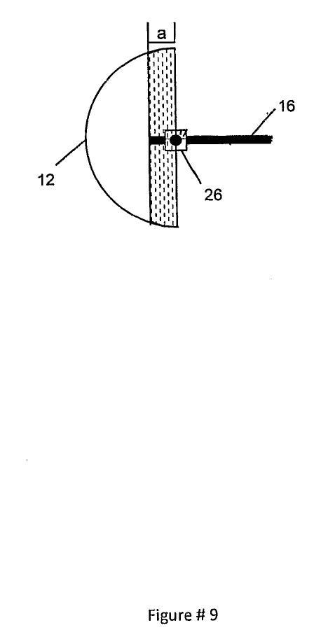

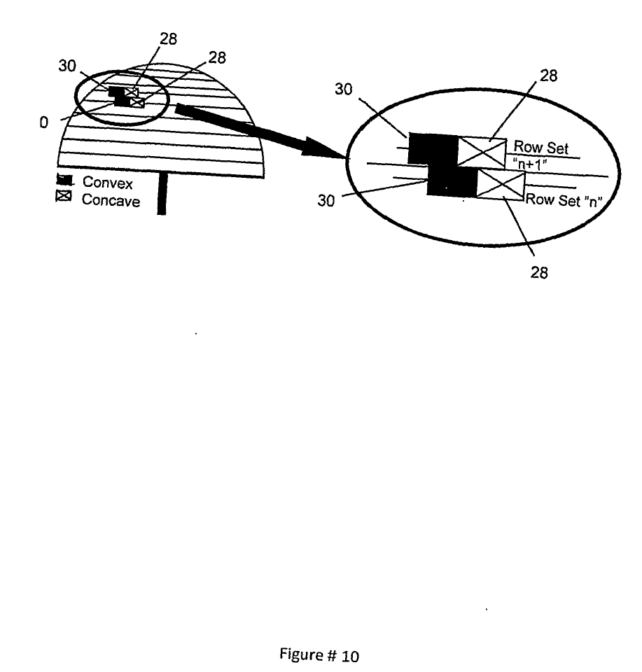

More specifically as shown in FIG. 11, the gears can be viewed in quadrants: pinion gear 10 (G_{A}) has quadrants G_{AU} and G_{AL}; and gear 22 (G_{B}) has quadrants G_{BL} and G_{BU}. As G_{A} pivots from 0° to +45°, G_{AL} interacts with G_{BU} as G_{B} pivots from 45° to 90°. G_{AL} is an inverse image of G_{BL}; G_{AU} is an inverse image of G_{BU}. Because of this relationship, the interlocking mechanism of G_{AL} and G_{BU} can be replicated for G_{AU} and G_{BL}. This further enables an interlocking mechanism to be designed using either pair of G_{AU} and G_{BL} or G_{AL} and G_{BU}. The process of designing teeth for the curvilinear gear system will be further disclosed with the following illustrative embodiment.

The following is an illustrative method to design teeth and teeth layouts for a curvilinear gear. It should be appreciated that other methods exist as known to those skilled in the art. The considerations for any method used are those outlined in this description, the focus being to produce positive force and speed transmission from one gear to another.

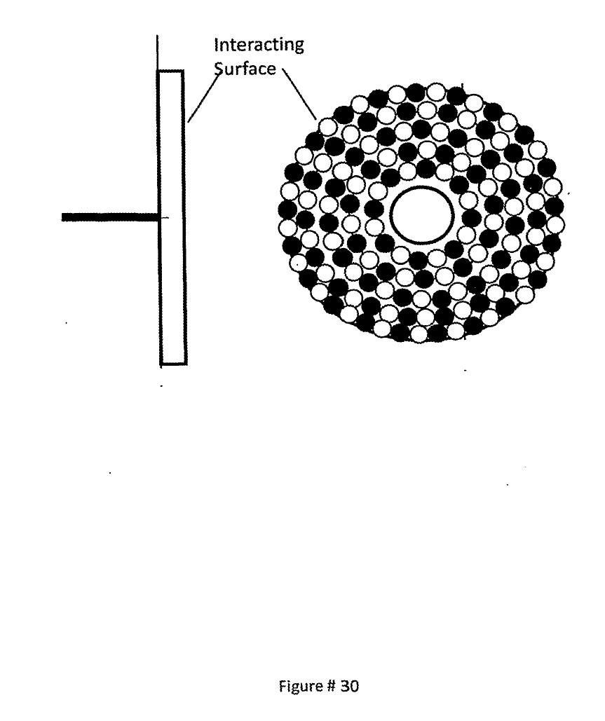

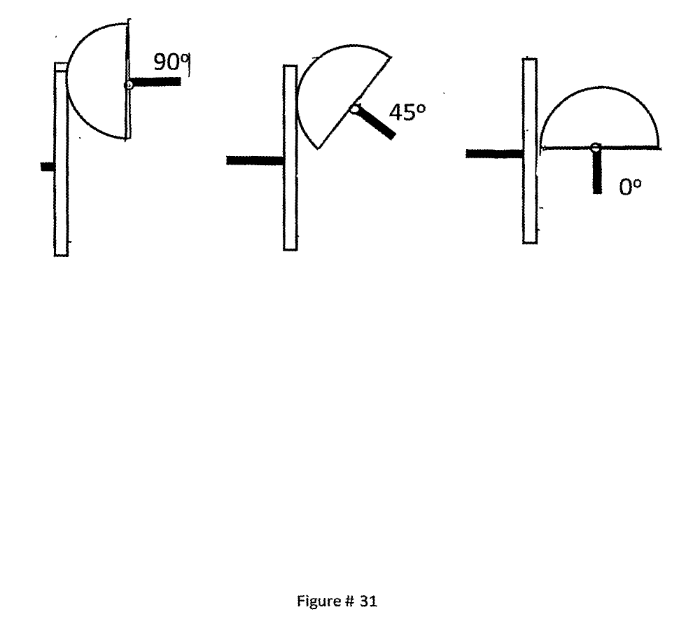

Accordingly, an illustrative embodiment for tooth design involves the following. As shown in FIG. 35, hemispherical gear 10 has a series of teeth rows with convex teeth 30 alternating with concave tooth receiving portions 28. To establish a tooth design, pinion gear 10 is placed in contact with gear 22 to form a gear set wherein teeth of at least one row from each gear are releasably interlocked. The rows with the interlocked teeth are designated as “n,” and have a target thickness of 0.2 inches for illustrative purposes. For further purpose of illustration, the gears in FIG. 36 have an outside diameter of 8 inches.

To provide a conceptual framework for designing teeth, of the approximately dozen gear types commonly used, the spur gear will be used to illustrate the method of designing curvilinear gear teeth. For spur gears to mesh correctly, the gears must have the same circular pitch. For purposes of this disclosure, circular pitch shall mean the distance between the leading edge of a first tooth and the leading edge of a second tooth adjacent to the first at a midpoint of the length of each tooth as shown in FIG. 35.

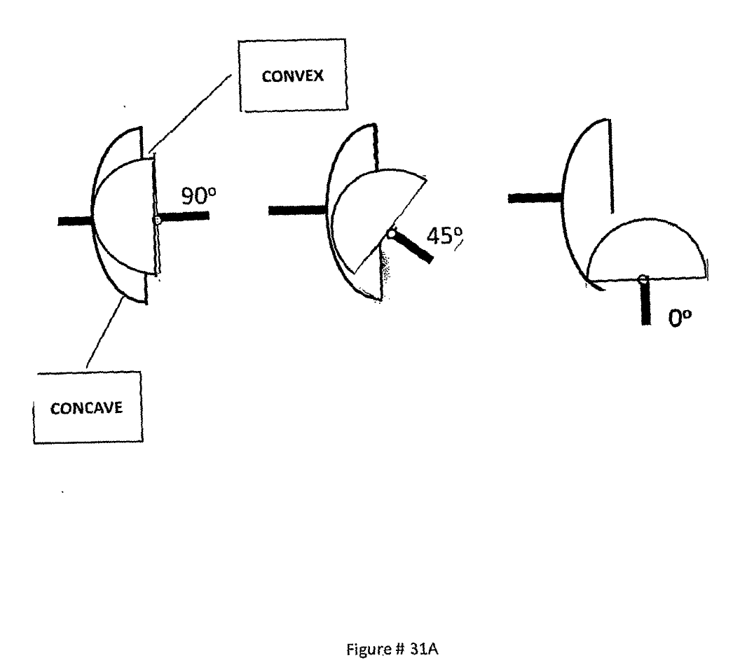

A hemispherical gear can be constructed by laminating a series of spur gears with each successive spur gear having an incrementally larger diameter that the prior adjacent gear to arrive at a hemispherical gear as shown in FIG. 37. Each tooth of each section has to be modified so that each tooth is perpendicular to the head of each gear. With this conceptual construct each laminate section shall represent a row of teeth such that the teeth of one laminate section of a pinion gear 10 will interact uniquely with the teeth of one laminate section of the output gear 22 at any given time of gear interaction. For purposes of this disclosure, the interacting laminate sections will be a laminate set.

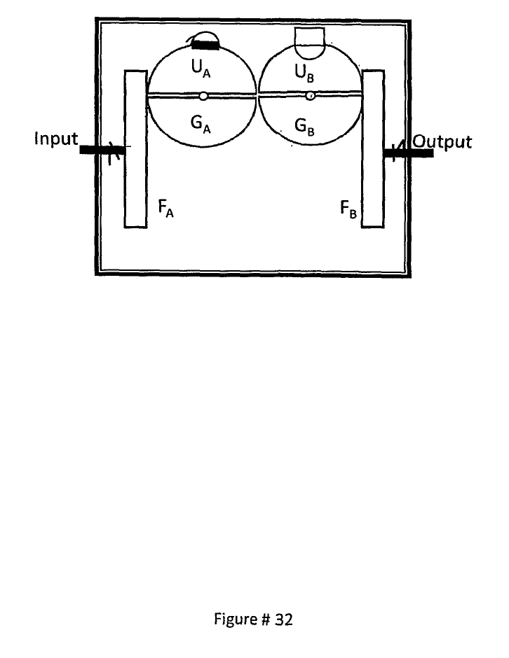

For the laminate sections to interact correctly, the teeth must be perpendicular to a tangent line formed at the point of contact for the laminate set as shown in FIG. 38. With this requirement, the curvilinear gear acts more as a bevel gear described above. For two gears to mesh properly, the circular pitch of each gear must be substantially similar to the circular pitch of the other.

The circular pitch of each laminate of a laminate set is dictated by the geometric parameters of the pinion and the gear. Thus, the likelihood of having gears with mathematically equivalent circular pitches is of a very low probability due to, among other issues including materials, manufacturing tolerances. Due to the almost inevitable result that no two gears will be completely geometrically and dimensionally identical, the circular pitches of the gears subsequently will not be exactly the same. The need for precision will most likely be dictated by the specific application being made of the gear sets. Higher torque applications will require greater precision with respect to allowable tolerances. The problem of tolerance manifests itself in one of two possibilities, which will be referred to as “push” and “pull.”

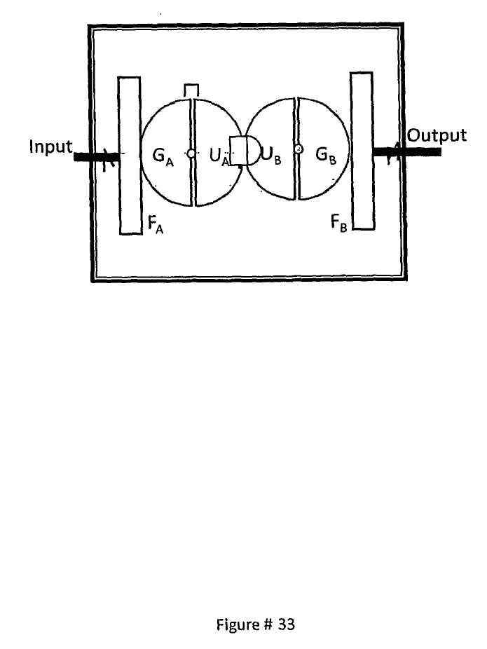

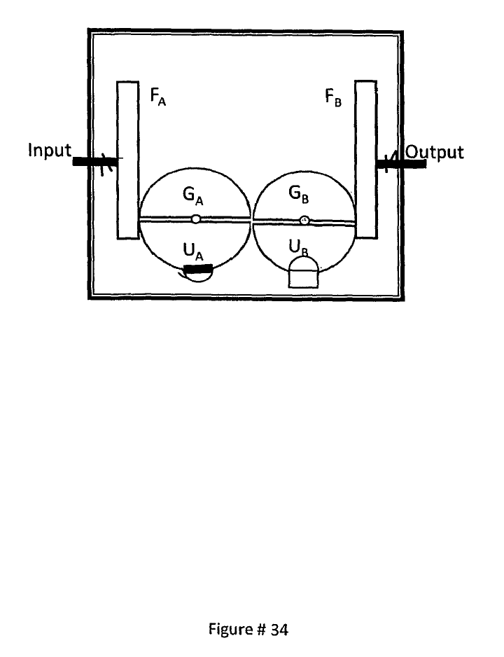

Referring to FIG. 39, when the pinion has a smaller circular pitch than the circular pitch of the gear, a “pull” effect is created. This occurs when the pinion tooth approaches the gear tooth and contacts the gear tooth at a point close to the tooth top as opposed to the ideal point of contact shown as “A” in FIG. 39A and is instead displaced as shown as “B” in FIG. 39B. To compensate, the pinion tooth slides over the gear tooth until final engagement. This creates friction, which produces undesirable heat, as well as an undesirable change in angular velocity. In short, the energy and force being transferred from the pinion to the gear is lost in the form of heat and inefficient, ineffective rotational travel of the gears.

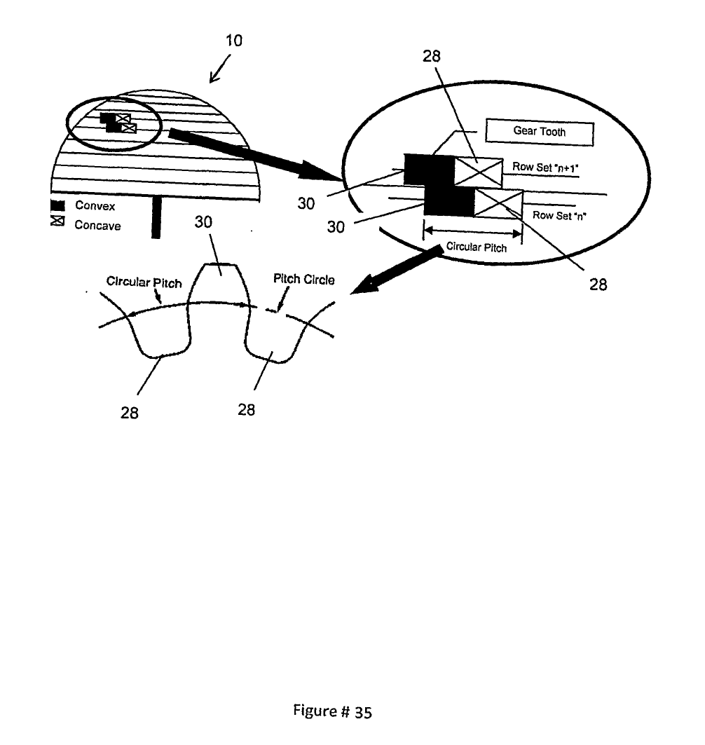

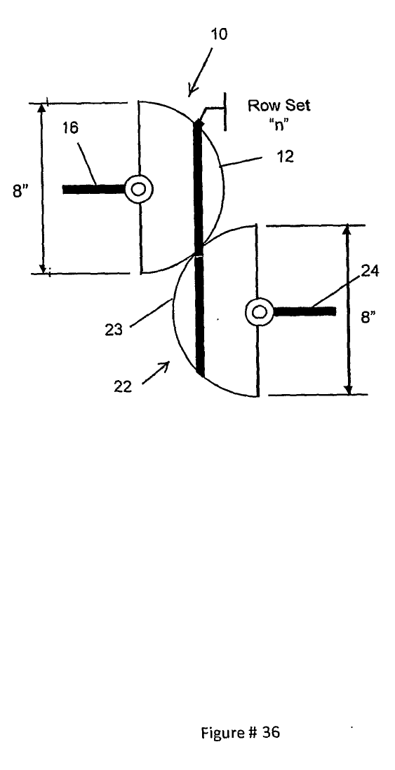

Referring to FIG. 40, when the pinion has a larger circular pitch than the circular pitch of the gear, a “push” effect is introduced. This occurs when the pinion tooth contacts the gear tooth before the ideal point of contact (FIG. 40A) as shown in FIG. 40B. Because the pinion circular pitch is too long relative to the gear circular pitch, after initial contact, the pinion tooth slides along the gear tooth until an adequate adjustment is made to compensate for the long pinion tooth. The gear interaction requires an impact load to be absorbed, heat is produced from the sliding action and a change in velocity occurs. This combination of undesirable effects makes the “push” condition less favorable than the “pull” condition. With this dynamic in mind, tooth design should be biased in favor of a pull condition.

The type of condition resulting from the creation of a pinion and complimentary gear can be controlled in the following manner. After establishing a circular pitch for the gear, the number of teeth and the tooth profile needed for a specific row can be computed. This information is then used to compute the number of teeth needed for a specific row on the pinion. The computed number of teeth will almost invariably result in something other than a whole number. By rounding up the number of teeth for the pinion gear, the circular pitch of the pinion will be decreased relative to the gear, which produces a “pull” effect.

The degree of the “pull” effect can also be controlled. If a certain amount of “pull” effect is produced by using 20 teeth, the amount can be reduced by 50% by using 40 teeth. There is a significant limitation to this approach of controlling the tolerances. An increase in teeth number reduces the strength of each individual tooth. The limitations to this approach, therefore, are most likely limited by the specific application to which the gears will be used. High torque applications will require stronger teeth, and therefore fewer teeth.

Another consideration involves again considering a curvilinear gear as a series of laminates. By setting the circular pitch of a set of laminates, the outer diameter of the laminate segments will affect the positioning of the involute curves. This will cause the gear to not be a substantially regular hemisphere and require adjustment of the involute curve.

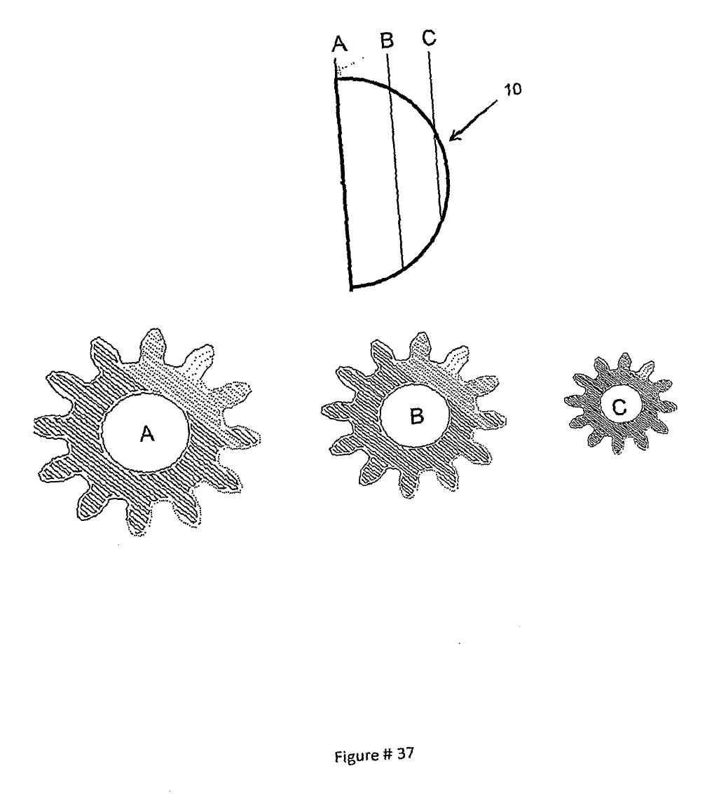

To illustrate the method for creating a tooth design, reference is made to FIG. 41 in which a pinion and a gear are selected with diameters of 8 inches, each with a plurality of rows having a thickness of approximately 0.2 inches. As used herein, row shall mean a set of teeth along a particular circumference on a gear head wherein the circumference is perpendicular to the axis of rotation. Also as used herein, a row set shall mean a pair of interacting rows of teeth, one row from the pinion and one from the gear. An illustrative target circular pitch of 0.5 inches is used. It should be understood that this example is used in an illustrative manner only and does not limit in any way the applicability of the disclosed method with respect to gears of varying diameters, circular pitches or applications.

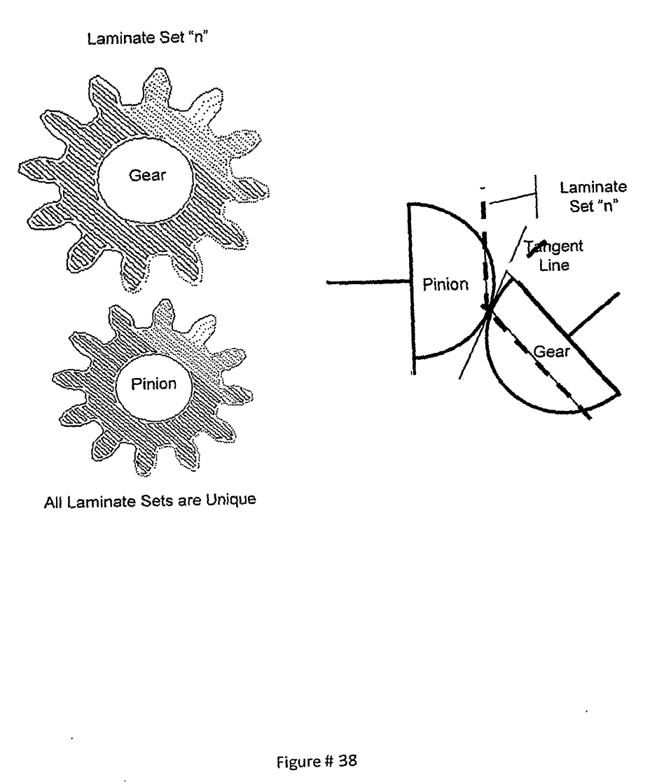

Before a tooth can be designed, the location of each row on the pinion and the gear must be established. For a gear head with an 8 inch outside diameter and a row thickness of 0.5 inches, the maximum circumference of each gear will be approximately 25.133 inches. A 1° arc length for this gear head is approximately 0.0698″. In turn, this means it will take approximately 3° of arc to provide the desired 0.2″ row width. For a row that occupies a 3° arc, the actual row width will be 0.2094″ (3×0.0698″). The method will be further described using the 3° arc. With a 3° arc per row, 30 rows of teeth can be placed on each gear as shown in FIG. 42. The row sets and the rows that comprise each row set are shown in Table I.

TABLE I

| Row Set | Gear Row | Pinion Row |
|---|---|---|
| 1 | 1 | 30 |
| 2 | 2 | 29 |
| 3 | 3 | 28 |
| 4 | 4 | 27 |
| 5 | 5 | 26 |
| 6 | 6 | 25 |
| 7 | 7 | 24 |
| 8 | 8 | 23 |
| 9 | 9 | 22 |
| 10 | 10 | 21 |
| 11 | 11 | 20 |
| 12 | 12 | 19 |
| 13 | 13 | 18 |
| 14 | 14 | 17 |
| 15 | 15 | 16 |
| 16 | 16 | 15 |
| 17 | 17 | 14 |
| 18 | 18 | 13 |
| 19 | 19 | 12 |
| 20 | 20 | 11 |
| 21 | 21 | 10 |
| 22 | 22 | 9 |
| 23 | 23 | 8 |
| 24 | 24 | 7 |
| 25 | 25 | 6 |
| 26 | 26 | 5 |
| 27 | 27 | 4 |
| 28 | 28 | 3 |
| 29 | 29 | 2 |
| 30 | 30 | 1 |

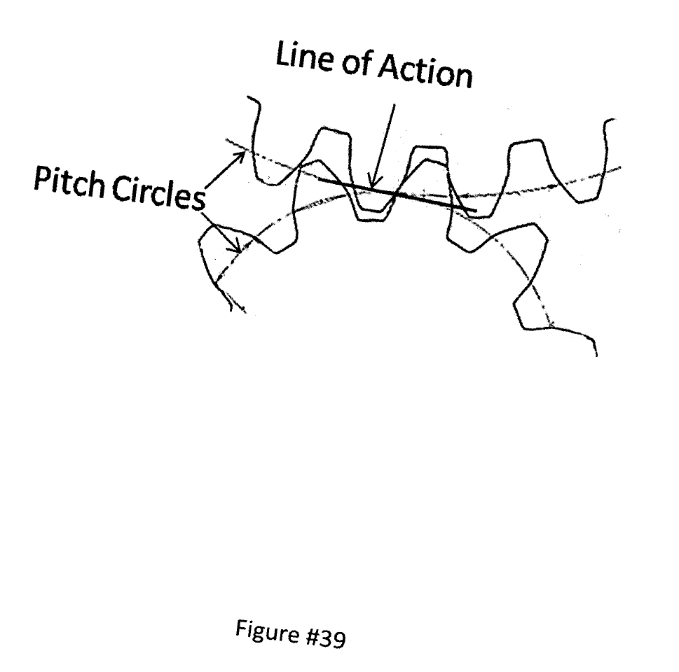

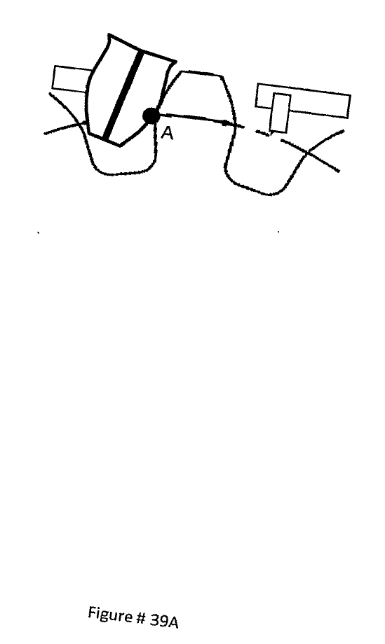

It is important to note that teeth are designed independently for each row. The teeth for any row set must be identical. Teeth for different row sets may be designed differently. One limiting parameter is that the load that each tooth must carry influences the tooth design. The tooth design method is further explained by focusing on the G_{AU} and G_{BL} sections of the pinion and gear as shown in FIGS. 43 and 44. The mirror results apply to sections G_{AL} and G_{BU}.

Beginning with row set 15, G_{AU} rotates from about 45° to about 47° to create a row width of 0.209 inches. G_{BL} rotates from about 45° to about 43° to create a row width of about 0.209 inches. This shows that the circumference at each degree is different and, therefore, the circular pitch for each degree is different. The data for row 15 is shown in Table II.

TABLE II

| | | Gear | | | Pinion | | | |
|---|---|---|---|---|---|---|---|---|
| Row | | (G_{AU}) | | | (G_{BL}) | | | |
| Set | theta | R(G) | O | C | theta | R(P) | O | C |
| | 43 | 2.925 | 5.851 | 18.381 | 47 | 2.728 | 5.456 | 17.141 |
| 15 | 44 | 2.877 | 5.755 | 18.079 | 46 | 2.779 | 5.557 | 17.459 |
| | 45 | 2.828 | 5.657 | 17.772 | 45 | 2.828 | 5.657 | 17.772 |

Theta—angle (in degrees)
R—Radius where r(1) = 4 × cos(theta)
O—Outside Diameter
C—Circumference

With the parameters of the row defined and taking into account that circumference changes when going from one row to another, a tooth can be designed for a particular row using the following procedure.

The first step is to compute the circular pitch for the gear 22 and the pinion 10. The difference in circular pitch is the “pull” error that must fall within some allowable tolerance. Laminate sections are taken at angles 43°, 44°, and 45° of the Gear, and 45°, 46°, and 47° of the Pinion.

The Circular Pitch is computed directly from the Diametral Pitch using the following formula.

Pc=3.1416/P

Where:

P-Diametral Pitch

The circular pitch is the circular distance from the point on one tooth to a like point on the next adjacent tooth, taken along the pitch circle. Two gears must have the same circular pitch to correctly mesh with each other. As they mesh, their pitch circles will be tangent to one another

The Diametral Pitch can be computed from the following equation

P=(N+2)/O

Where:

N-Number of Teeth

O-Outside Diameter

As used herein, diametral pitch shall mean a measure of a tooth size in the English system expressed as the number of teeth per inch of diametral diameter. As tooth size increases, the diametral pitch decreases. Diametral pitches typically range from about 25 to about 1.

The number of teeth is computed by dividing the outside diameter by the target circular pitch.

N=O/0.5

Where:

O-Outside Diameter

0.5-Target Circular Pitch

As previously explained, at the angle of 45°, the gear and pinion templates are identical. Thus, whatever is computed for the gear will be identical for the pinion, and the difference in Circular Pitch will be “0”. This only happens at 45°. Circular pitch for any other angle has to be determined independent of the result for 45°.

Because the number of teeth in a row set for both the pinion and the gear is now known, it is possible to compute the pitch diameter for the remaining laminate sections in this row set. It is also possible to compute the “Pull” error at different points along the width of a row which are due to the difference in the laminate set circumferences. The results for Row Set 15 are shown in Table III.

TABLE III

| | Gear | | | | Pinion | | | | |
|---|---|---|---|---|---|---|---|---|---|
| Row | (G_{AU}) | | | | (G_{BL}) | | | | “Pull” |
| Set | theta | D | P | Pc | theta | D | P | Pc | Error |
| | 43 | 5.543 | 6.495 | 0.484 | 47 | 5.169 | 6.965 | 0.451 | 0.016 |
| 15 | 44 | 5.452 | 6.603 | 0.476 | 46 | 5.265 | 6.838 | 0.459 | 0.008 |
| | 45 | 5.359 | 6.718 | 0.468 | 45 | 5.359 | 6.718 | 0.468 | 0.000 |

Theta—angle (in degrees)
P—Diametral Pitch
D—Pitch Diameter
Pc—Circular Pitch

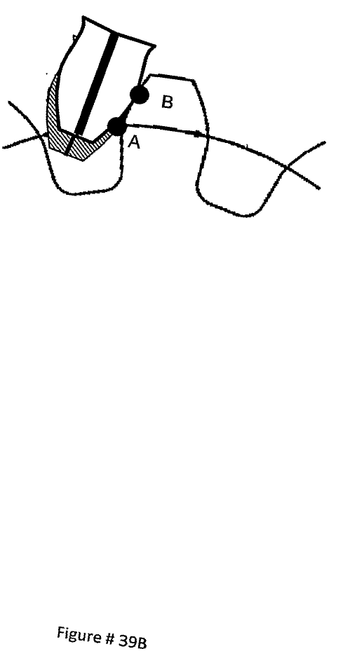

The foregoing method establishes the tooth “footprint,” for a Row Set as shown in FIG. 45, i.e., the length and width of the area of the pitch diameter occupied by a tooth. The same method is used to compute the same information for the remaining 14 rows. The results of the computation for the illustrative example are shown in FIG. 46.

The next step is to compute the 3-D geometry of each tooth. With the spur gear embodiment, the parameters include the addendum, the dedendum, the whole depth, and the thickness of the tooth. The addendum is the radial height of the tooth above the pitch circle shown in FIG. 39.

Addendum=1/P

Where:

P-Diametral Pitch

The Dedendum is the radial depth of the gear below the pitch circle

Addendum=1.157/P

Where:

P-Diametral Pitch

The whole depth is the radial height of the whole gear tooth.

Whole Depth=Addendum+Dedendum

The thickness of the tooth can be measured as the arc thickness. The arc thickness is the thickness of the tooth measured along the arc circle.

Arc Thickness=1.5708/P

Where:

P-Diametral Pitch

The results for Row Set 15 are shown in Table IV. All of the information for all of the Row Sets is included in FIG. 46.

TABLE IV

| | Gear | | | | | Pinion | | | | |
|---|---|---|---|---|---|---|---|---|---|---|
| Row | (G_{AU}) | | | | | (G_{BL}) | | | | |
| Set | theta | J | K | W | T | theta | J | K | W | T |
| | 43 | 0.154 | 0.178 | 0.332 | 0.242 | 47 | 0.144 | 0.166 | 0.310 | 0.226 |
| 15 | 44 | 0.151 | 0.175 | 0.327 | 0.238 | 46 | 0.146 | 0.169 | 0.315 | 0.230 |
| | 45 | 0.149 | 0.172 | 0.321 | 0.234 | 45 | 0.149 | 0.172 | 0.321 | 0.234 |

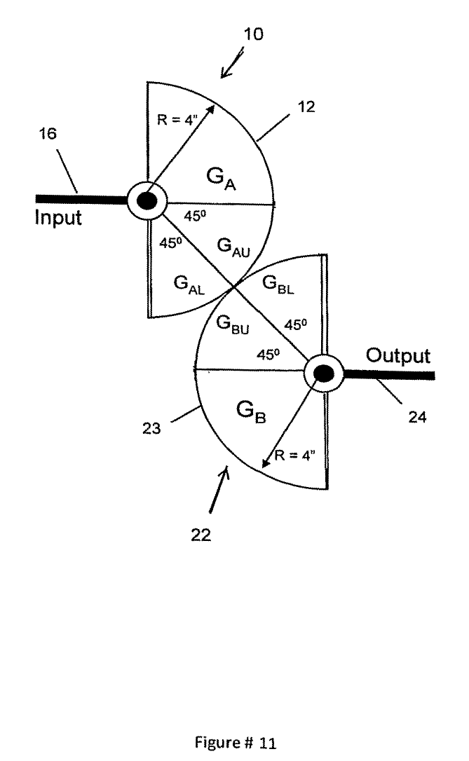

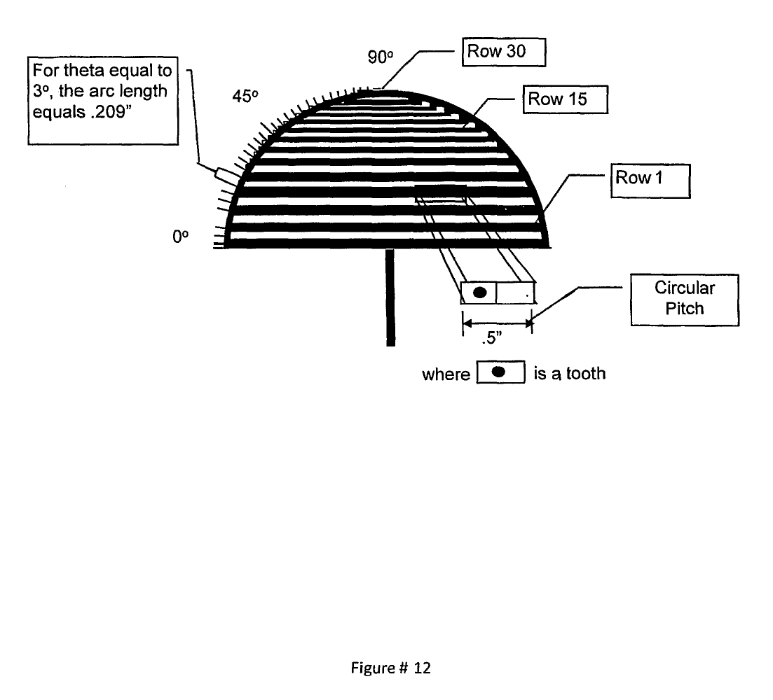

Having described the structural features of the hemispherical gear embodiment, the novel functioning aspects will now be described. When in use, the hemispherical gear configuration results in the shafts of each gear head being in a continuous angular motion as shown in FIGS. 13, 13A and 13B. For the hemispherical gear to be functional, the input/output axes of rotation have to be stabilized. There are several ways to accomplish this.

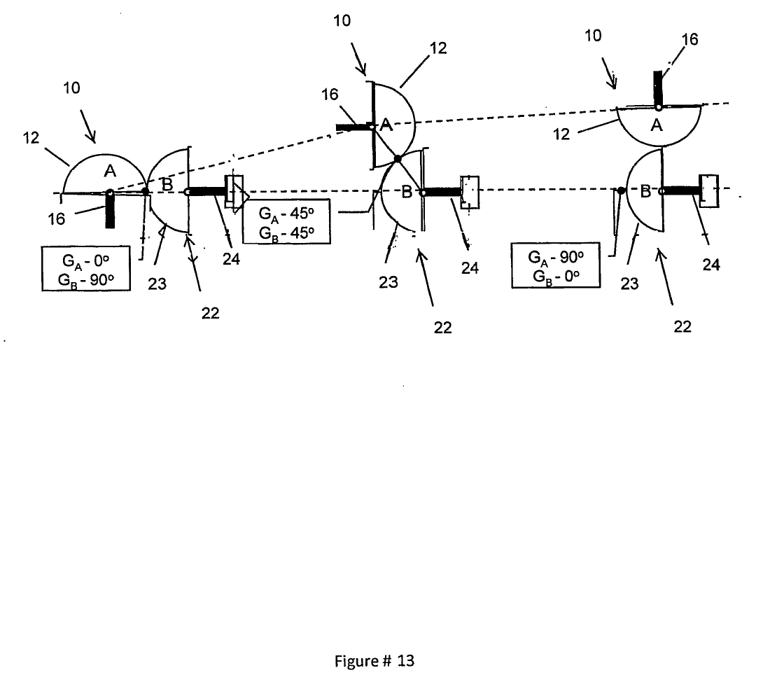

Referring to FIG. 14, in one aspect of the invention, the output shaft is fixed while the input shaft is stabilized. The output shaft is connected directly to the gear head. The input shaft is connected so as to allow the shaft to travel 90° following an arc of radius R where R=d (diameter of input gear head). To stabilize the input shaft a kinematic mechanism is used.

In an alternative method, the shaft stabilization method described is reversed for the two shafts as shown in FIG. 15. The input shaft is connected directly to the gear head and the output shaft is connected so as to allow travel along a90° arc.

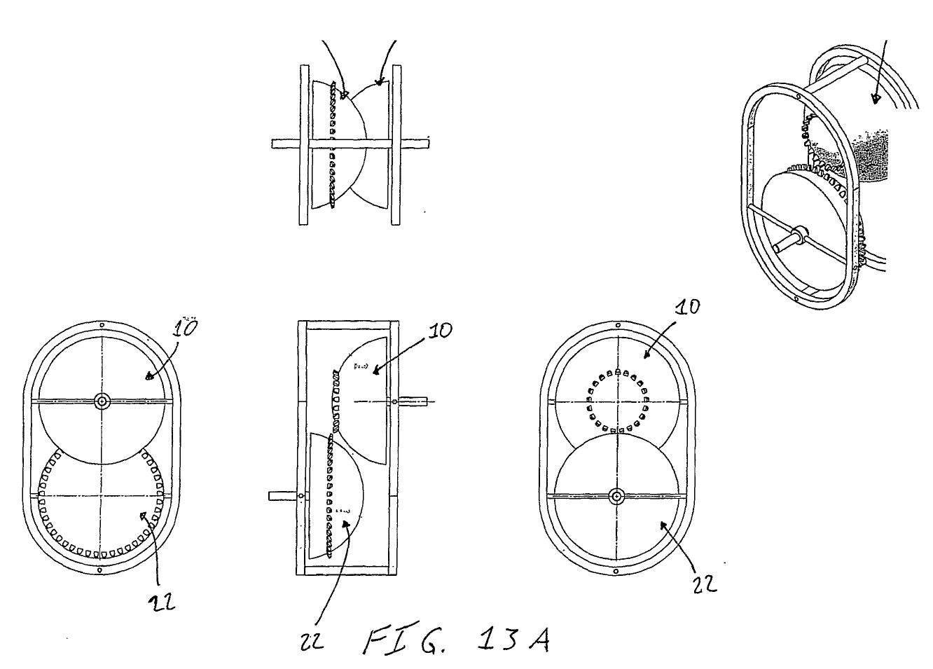

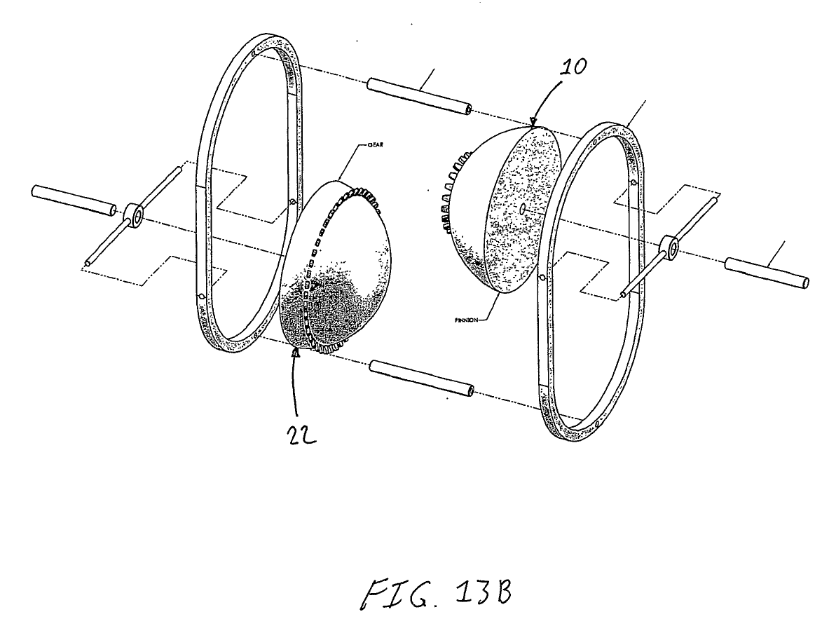

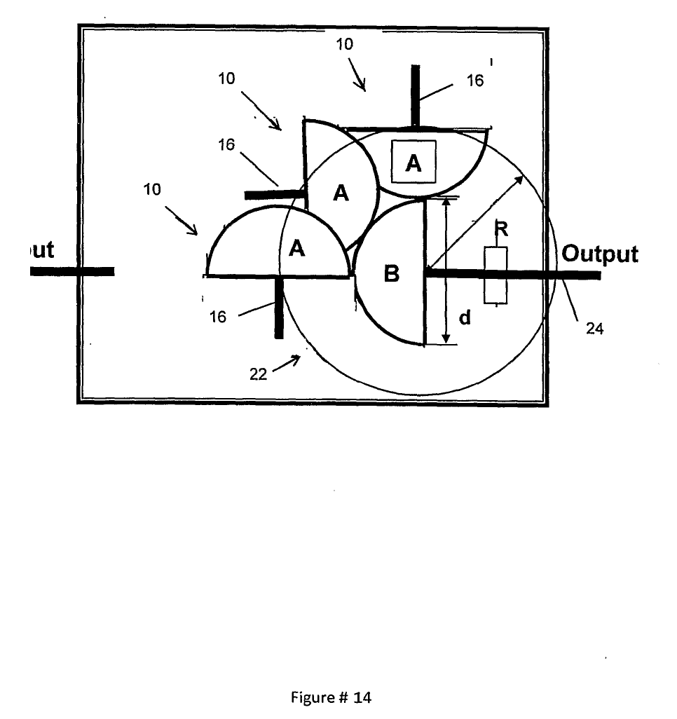

A yet further option is to configure the shafts for both the input and output gear head so that neither shaft is fixed directly to the gear heads as shown in FIGS. 16-18. In this configuration, neither shaft is stable. Each travels 45° following an arc of radius R where R=d (diameter of the gear head/2). This variable input/output concept reduces the variability of the shaft angular swings by 50%, i.e., from 90° to 45°. This is an unexpectedly surprising improvement since the efficient operational angle range of standard universal joints is somewhere between 15° and 30°.

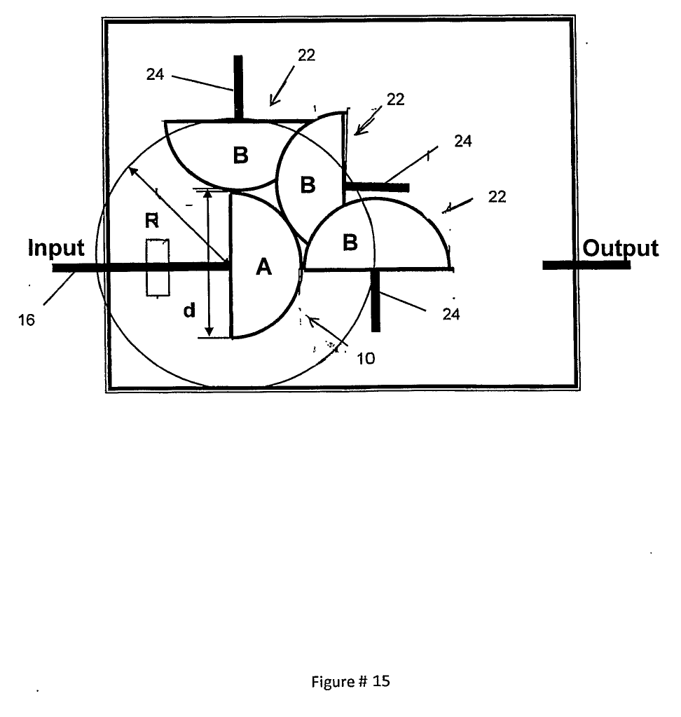

To connect the input and output shafts to the gear heads in the third embodiment, universal joints can be used as shown in FIG. 19. In this configuration, the input shaft 16 transmits its torque to the first gear head 10 through a connection to a first universal joint 32 and a second universal joint 34 connected to the first universal joint 32 at one end and to gear head 10 at the other end. The torque is then transferred to second gear head 22 which then transmits the result to a static output shaft 24 through its connection to a third universal joint 36 and a fourth universal joint 38 connected to the third universal joint 36 at one end and output shaft 24 at the other end. In this configuration, each U Joint works efficiently at a +/−45°angle. A consideration with this configuration is that the length of the shaft connecting the two U Joints changes as each gear head rotates. To address this, a telescoping shaft is positioned between the two U Joints.

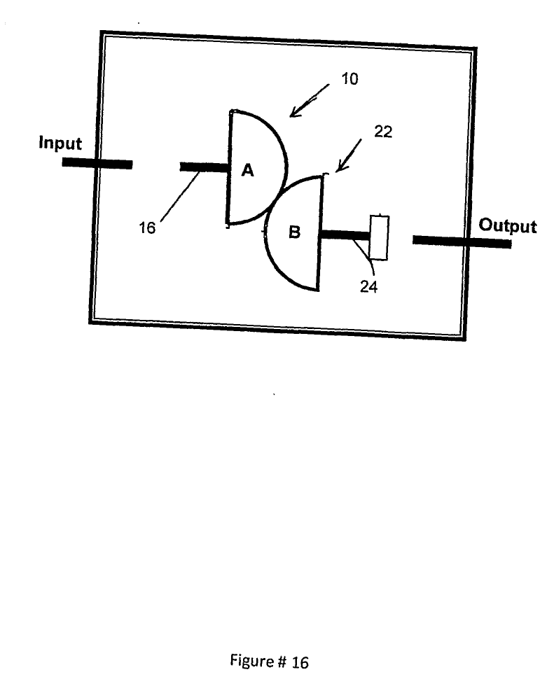

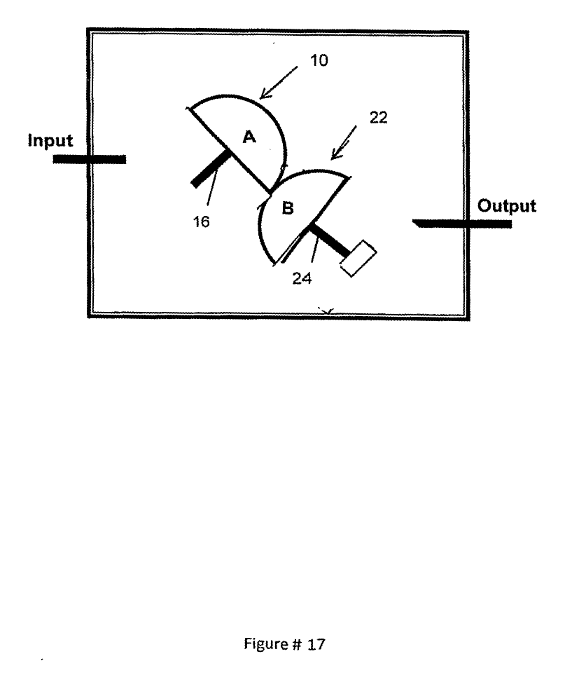

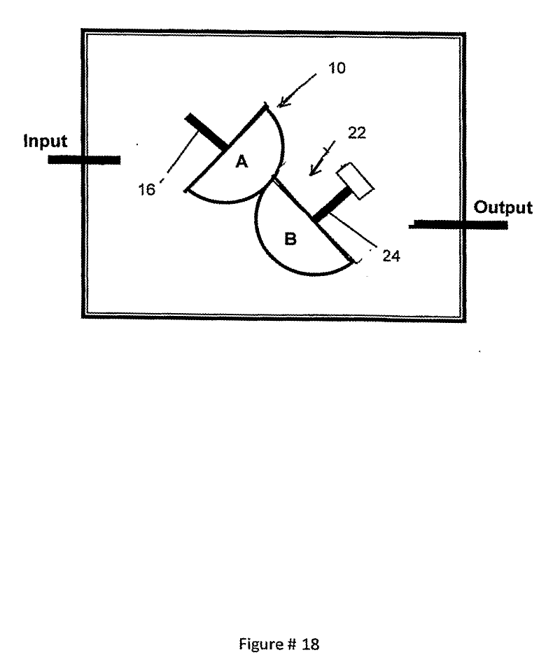

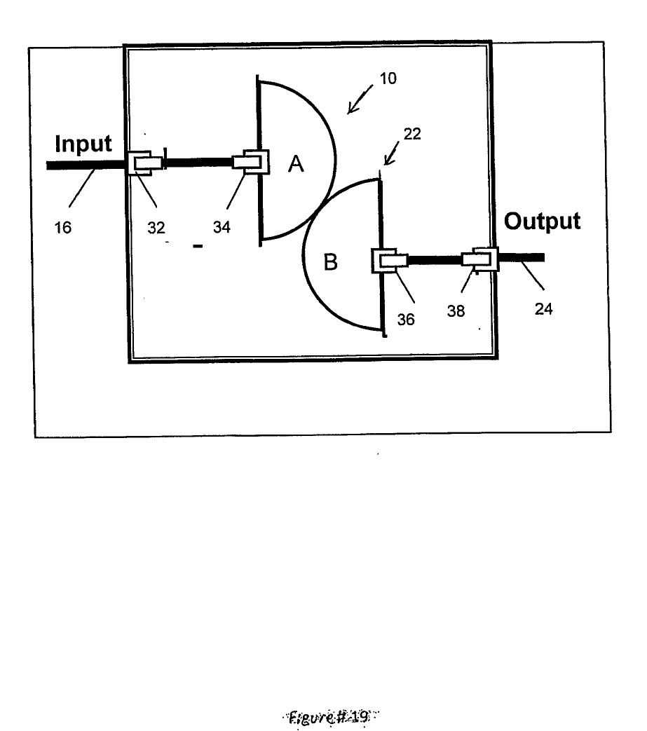

To increase the range of angles within which the U joints can operate efficiently, multiple U joints can be connected together as shown in FIG. 20. Full range of motion requires the gear heads to rotate +/−45 degrees. As shown in FIGS. 21 and 22, the angle of rotation is distributed over three U Joints by simply moving universal joints 33 and 37 up or down. With this configuration, the gear heads rotate about the drive shafts. As shown in FIG. 23, for any X dimension, a Y dimension can be computed to achieve a specific U joint so as to allow a gear set to be designed for a specific application. The working angle can be reduced by either increasing the value of X or decreasing the value of Y. Conversely, the working angle can be increased by decreasing the value of X and increasing the value of Y.

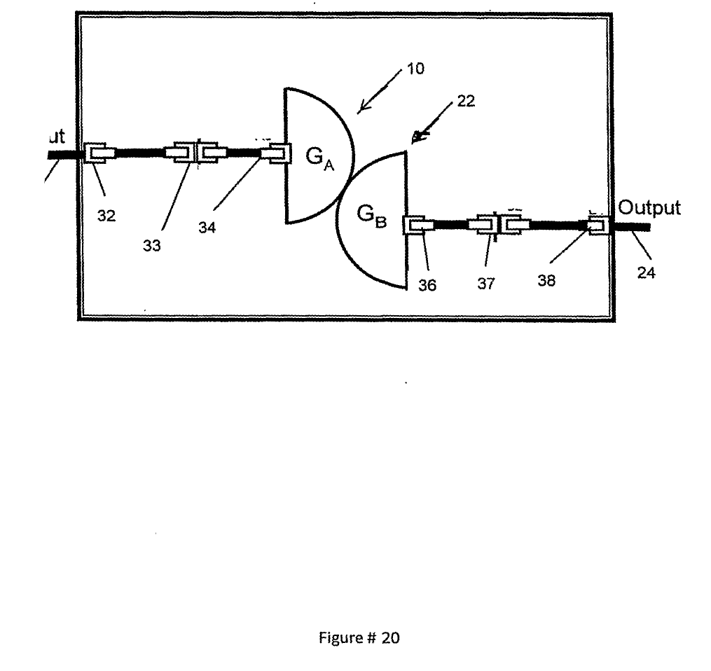

Another option to stabilize the input/output shafts is the use of a curvilinear U joint. A curvilinear U joint combined with a curvilinear gear creates a new type of drive train or transmission. As shown in FIG. 24, in one embodiment of the invention, the basic components of both a curvilinear U joint and a curvilinear gear are hemispherical gears. Each device includes at least two gear heads. The primary distinction between the devices is the placement of the gear heads relative to one another.

The placement of gear heads for a curvilinear gear is as previously described and as shown in FIG. 24 for comparison to a curvilinear U joint. With respect to a curvilinear U joint, the gear heads are positioned so that the gears align at the same angle for both gear heads. In contrast, a curvilinear gear head set can be aligned so that the lower quadrant of one gear head interacts with the upper quadrant of the second gear so as to from a 45° angle.

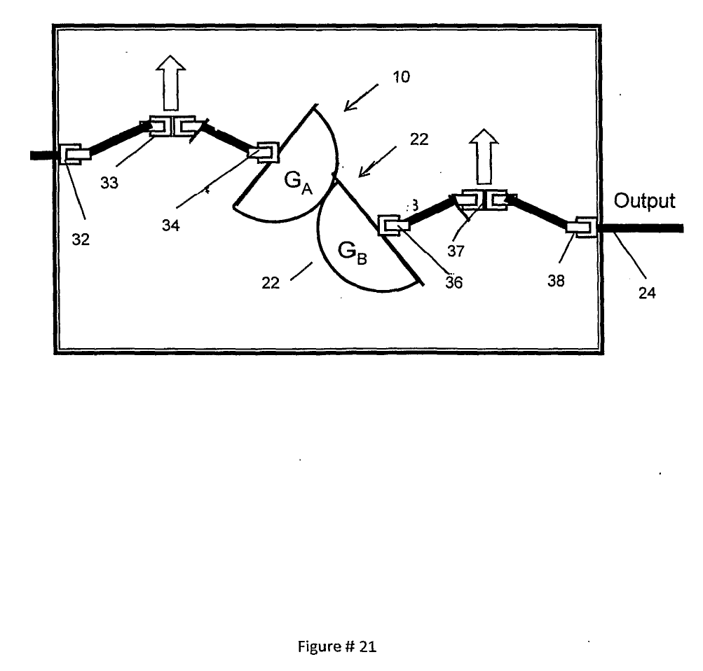

The range of motion of the Curvilinear U Joint is shown in FIG. 25. As shown, the range of motion for a curvilinear U joint is 180°. This is a significant improvement over the range of motion provided by current U Joint technology. As the gear heads are allowed to rotate +/−90°, the lever arm of each gear head remains the same. This allows the torque and velocity produced by the input gear to be passed to the output gear, which is the intended function of a universal joint.

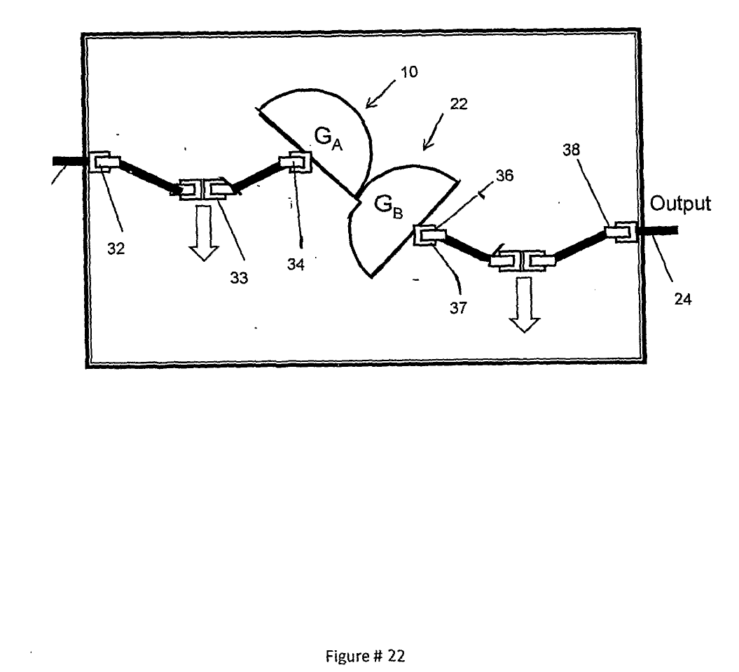

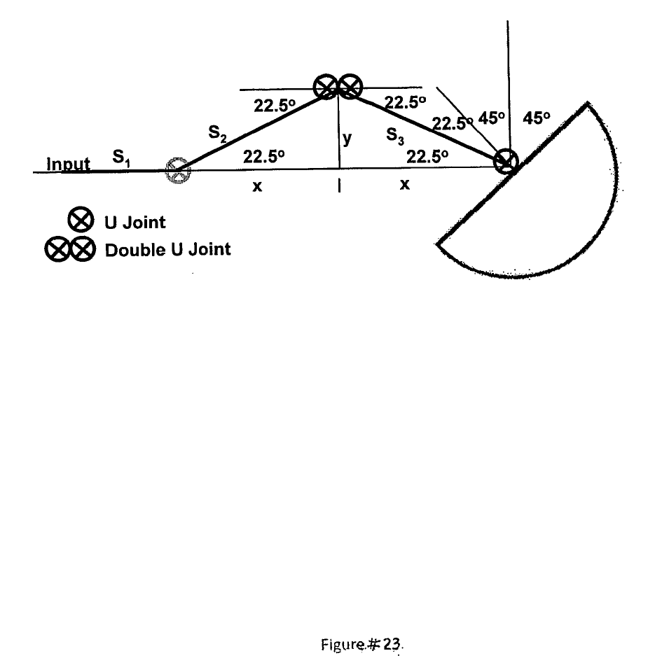

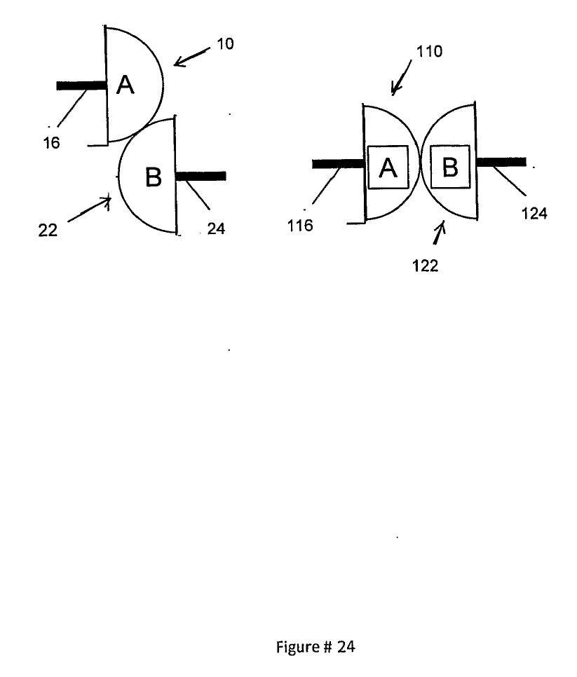

To further explain the combination of a curvilinear gear with a curvilinear joint, the following illustrative example will be used. As shown in FIG. 26, the input shaft is connected to a curvilinear U joint. This U joint is connected to a gear head that is positioned at 0° relative to another gear head that is positioned at 90°. This second gear head is connected to another Curvilinear U joint. This U joint is connected to the output shaft. When the input shaft is activated, the torque and angular speed are passed on the first gear head which is set for maximum speed and minimum torque. This speed is passed onto the second gear head which is set for minimum speed and maximum torque. This change is then passed onto the output shaft through the second U joint. FIG. 26, 27, and 28 show the entire range of change to speed and torque by showing the change in position of the first gear angle from 0°, 45° and 90°.

For the system to function, the gear head combinations pivot about their common pivot points. The torque and speed is first passed from U joint head 110 to U joint head 115 to gear head 10. Gear head 10 interacts through a pivot point 152 with gear head 115 and passes the output to gear head 22. Gear head 22 interacts though a pivot point 150 with U joint head 125 which, in turn, passes it to U joint head 122. For the system to work properly, the pivot points should not be fixed so that the input/output shafts can rotate freely.

To ensure the pivot points are not fixed, the pivot points are constructed to allow them to move as the gear heads rotate relative to one another. By moving both pivot points either up or down the same distance, it is possible to permit the gear and the U Joints to operate properly and to have the input/output axes remain fixed. For the U joint gear heads to remain in contact as the gear heads rotate about one another, the length of the input/output shafts has to be variable such as with the use of telescoping shafts or springs 140, 145, respectively.

The curvilinear gear system described herein can replace conventional gear systems and provide previously unknown improvements in performance. Use of a curvilinear gear system allows a non-linear interacting surface that enables one to continuously change the gear ratio between set values. Such a gear system reduces the number of gears needed in a system, which thereby reduces the weight of a given system so that more robust gear systems can be formed for specific applications. Reduced parts will also impart greater reliability.

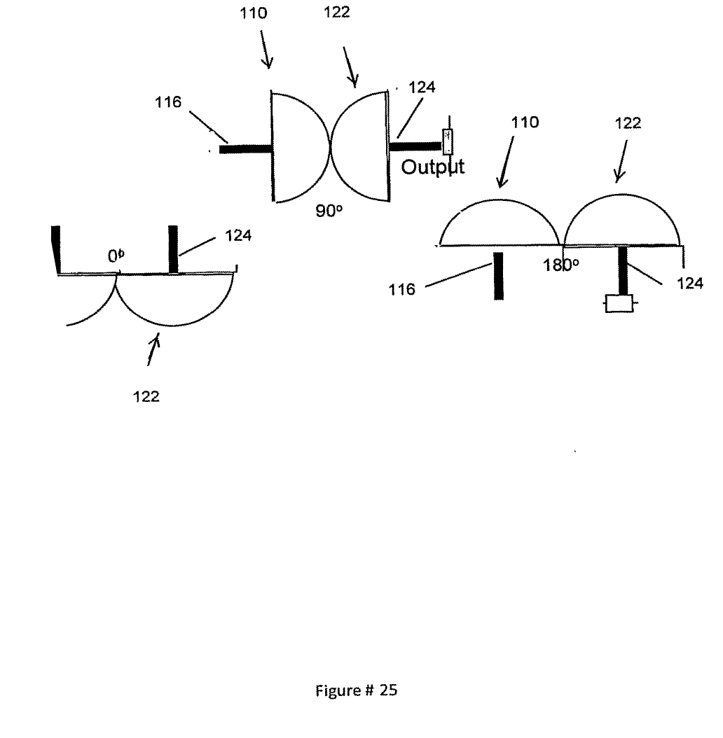

In another aspect of the invention, a flat gear is provided that interacts with one or more other curvilinear gears. FIG. 29 illustrates the basic geometry of a flat gear. Its geometry is very similar to that of a conventional spur gear, but there is a difference. The interacting surface of a spur gear is on the outer (or inner) diameter of the gear head, whereas the interacting surface of a flat gear is on the face of the gear head.

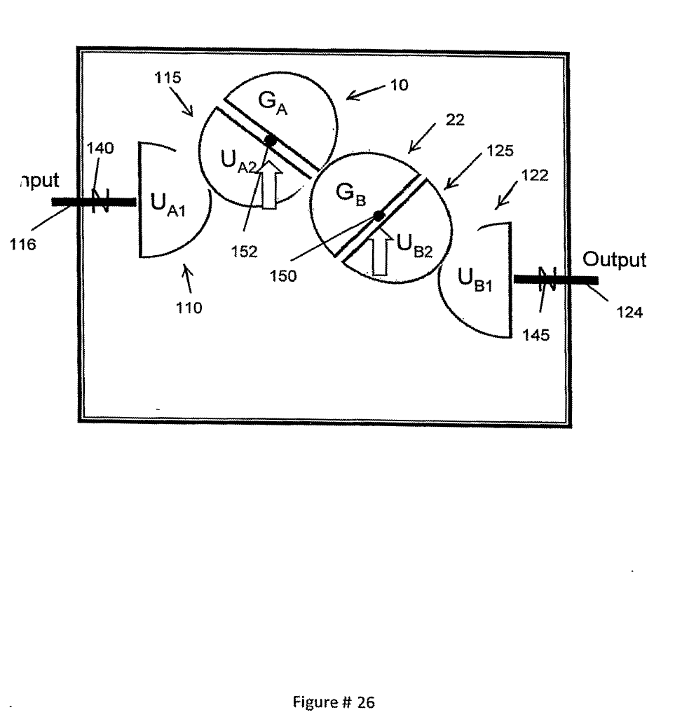

A more accurate representation of a flat gear is shown in FIG. 30. A key feature is that the interacting surface is not on the outer circumference of the gear, but rather on the face of the gear. To operate like a conventional gear requires some physical means of turning the head about an axis of rotation. This is accomplished by attaching a shaft to the flat side horizontal center of each gear head in a manner similar to the way shafts are used with conventional gears.

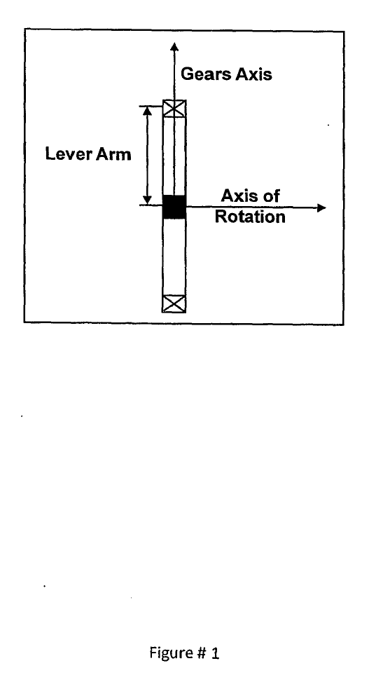

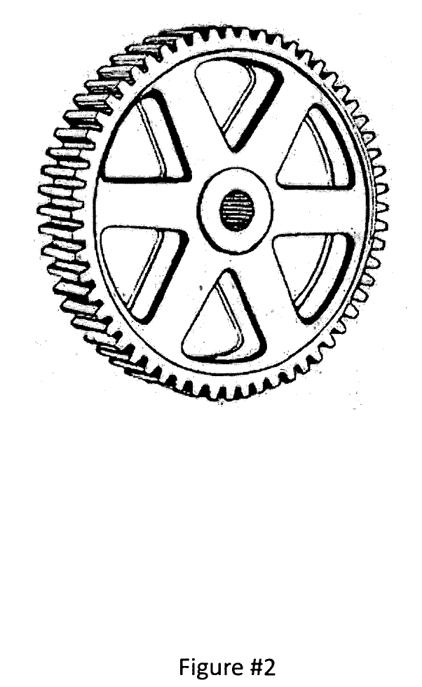

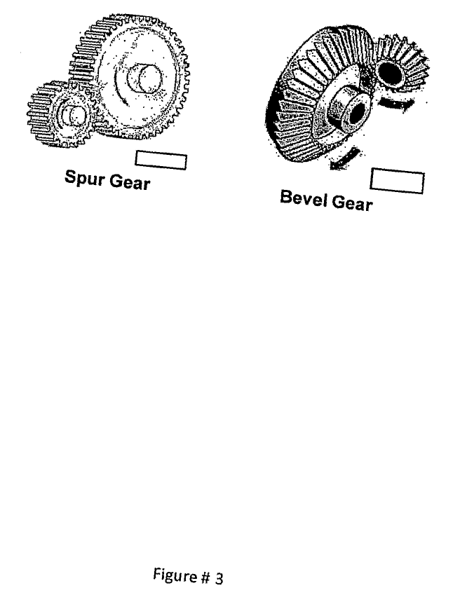

FIG. 1 sets the local coordinate system that will be used to further discuss these gears. Again, the axis shown running horizontally through the shaft will be referred to as the axis of rotation. The axis running perpendicular to axis of rotation along the flat side of the gear will be referred to as the gear head axis. The point of interaction is measured from the Gear Head Axis counterclockwise, so the axis shown in FIG. 1 is at the 0° position.

The flat gear is intended to be used with a curvilinear gear. FIG. 31 illustrates how a flat gear interacts with a hemispherical gear. Note that the initial positioning is similar to the placement of any other set of curvilinear gears other than those used in the U Joint application.

It should also be noted that the angle of the flat gear remains fixed as the other gear, the hemispherical gear in this case, rotates from 0° to 90°. As the hemispherical gear rotates up and down the radius of the flat gear, the length of the lever arm changes. This characteristic has some positive implications as described below.

As stated, the purpose of the gear head interaction is to have the input gear transfer its force and speed to the output gear at the point of interaction. The gear heads can interact with each other using friction, or some sort of interlocking mechanism.

Friction surfaces are ideal from a geometric point of view, because there is no need to worry about the geometric shape of the particles that are actually interacting. Friction surfaces are limited, however, to the amount of torque they can support, and the choices of a friction surface for a particular application are well known in the art.

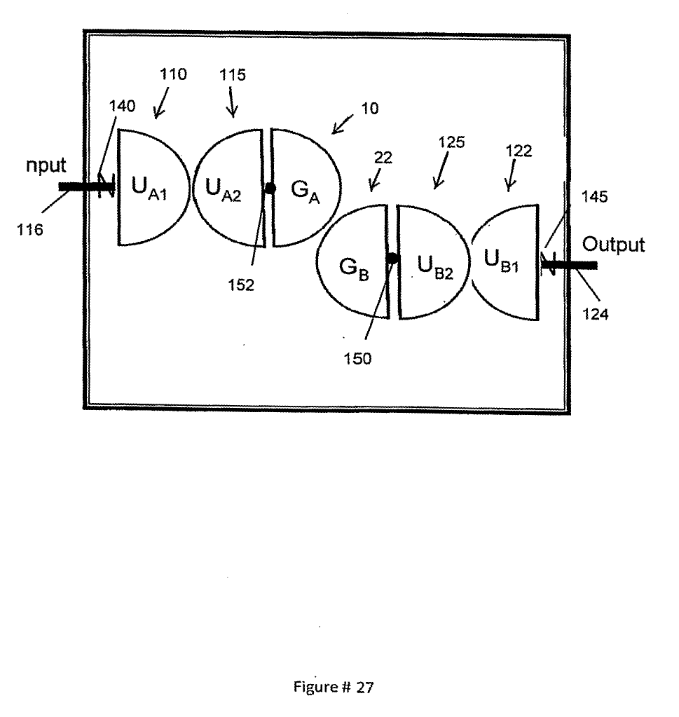

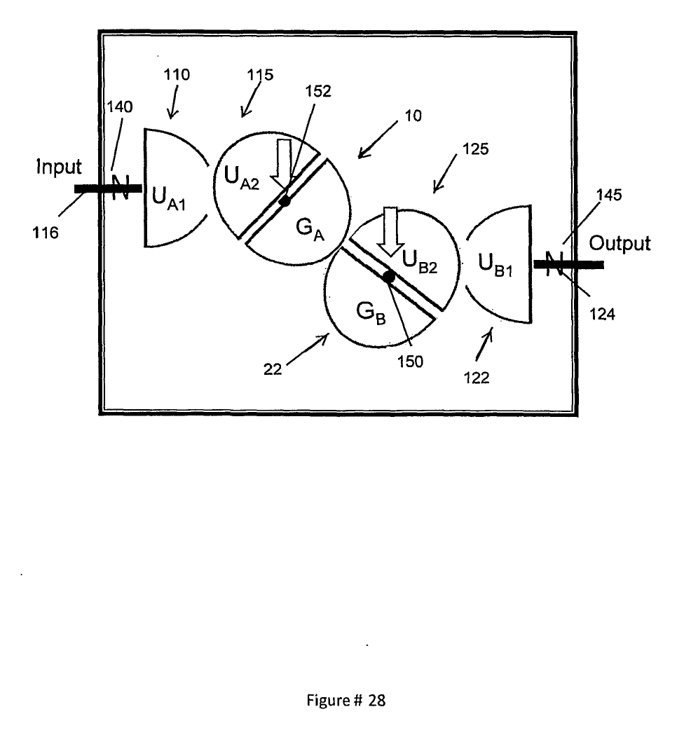

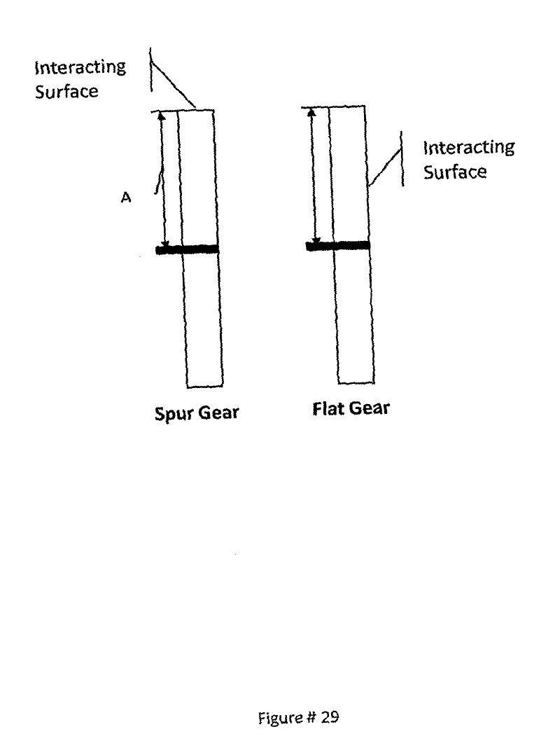

For higher torque values, something like splines or gear teeth can be used. The following application of the flat gear illustrates its value. As shown in FIGS. 32-34 show a drive train that uses one curvilinear universal joint, two gear heads, and two flat gears. As can be seen, the result is a drive train with very few moving parts. By simply moving the axes of rotation for each gear head/U Joint head up (FIG. 32) and down (FIG. 34), one can continuously vary the gear ratio of the transmission between two set limits.

In a yet further aspect of the invention, a curvilinear U joint is provided that is geometrically different than conventional U Joints, and offers new characteristics; one being that the allowable angular range of motion is 180°. The Curvilinear U Joint is completely compatible with the Curvilinear Universal Gear.

The American Heritage Dictionary states that a universal joint is:
“A joint, or coupling, that allows parts of a machine not in line with each other limited freedom of movement in any direction while transmitting rotary motion.”

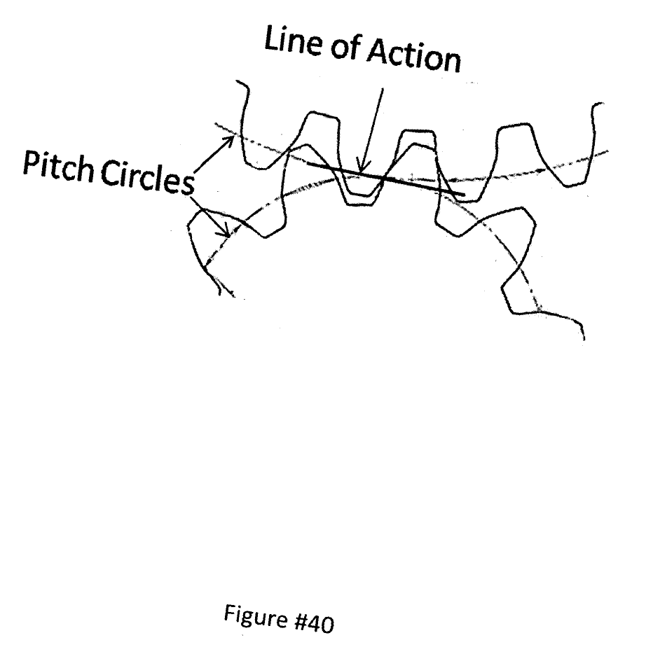

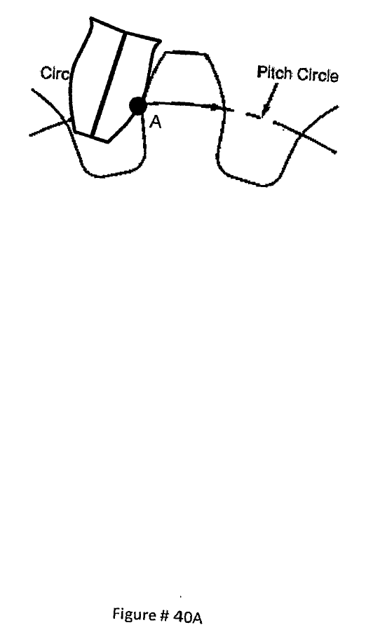

Although there is debate over the actual origin of the universal joint, some claim that the standard Cardan-style Universal Joint was invented in 1676 by Robert Hook, and that the basic design concept has not changed over the years. Hook's concept is illustrated in FIG. 47. FIG. 48 shows a standard U Joint available in today's market. It should be noted that most standard U Joints have an angular range of operation of somewhere between 20° to 45°.

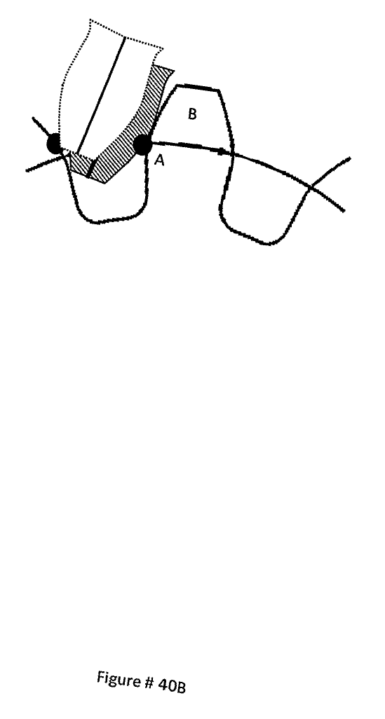

Other types of U Joints have evolved over time to address specific applications. Some of these are illustrated in FIG. 49. For example, the double U Joint is used to increase the angular range of operation if needed. The Telescopic/ Quick Change U Joints support needs where ease of maintenance is important. Other types exist that have not been cited for purposes of brevity, but all remain extensions of, and share features, with the basic Cardan-style U Joint.

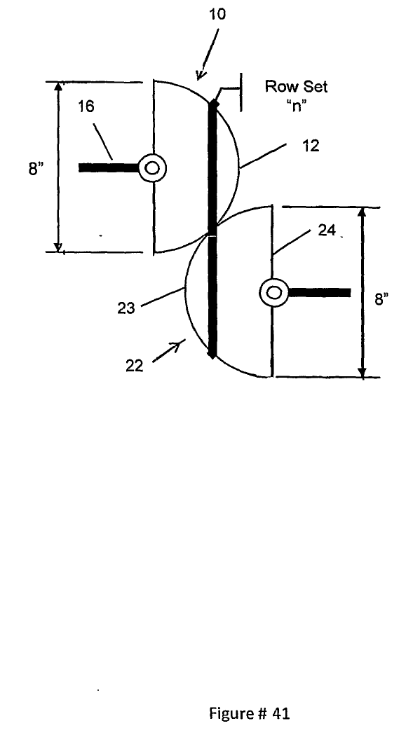

Others appear to be searching for alternative designs to increase the operational angle of a Cardan-style U Joint. For example, a U Joint developed by the Apex Operation of Cooper Tools claims to have an angular range of motion of 90° as shown in FIG. 50. This concept supposedly provides improvements that address the velocity and vibration issues currently encountered by contemporary U Joints that result from the basic design concept that produces a sinusoidal output at all angles. Ultimately, however, even this relatively new U Joint concept remains an extension of the Cardan-style concept introduced by Hooker.

To address the problems of velocity, vibration and range of motion experienced by Cardan-style U Joints, a Curvilinear U Joint solves these problems. The definition of a U Joint offered by the American Heritage Dictionary also applies to the Curvilinear U Joint. What is different between the Curvilinear U Joint and a more traditional U Joint is geometry and operating characteristics. Geometrically, the Curvilinear U Joint is not an extension of the Cardan-style concept; rather it has a completely different geometric shape. This new geometry results in a simpler U Joint with fewer moving parts that possesses greater strength.

A key component of the Curvilinear U Joint is a Curvilinear gear head as described above. As explained, the curvilinear geometry of the gear head permits the point of interaction on a pair of gears to change continuously. This unique geometry and the unique functional characteristics associated with this geometry enables a Curvilinear U Joint to be constructed at any size so as to support a wider range of loads than conventional U Joints, and enables the Curvilinear U Joint to operate at about +/−180°. Such an expansive operational range of motion is currently unattainable using conventional technology.

In one aspect of the disclosure, a Curvilinear U Joint is constructed with Curvilinear gear heads that have hemispherical shapes as shown in FIG. 7. The local coordinate system shown in FIG. 6 will be used to further describe the gear heads. As shown in FIGS. 69 and 70, the basic components of the gears include a gear head as the interaction mechanism, a shaft to impart angular motion, and a bearing as an interface between a gear assembly harness (described below) and the shaft to support the shaft. As will be explained, using the curvilinear surface of the gear head is an important feature used to create a Curvilinear U Joint.

The ability to maintain contact between the heads of two hemispherical gears at any point on the hemispherical surfaces is important to creating an efficient U Joint that can be operated at any angle. The purpose of the gear head interaction is to have an input gear or pinion transfer its force and speed to an output gear at the point of interaction. The gear head interaction options e.g., friction, splines, gear teeth, etc., as described herein apply equally to gear heads employed in a Curvilinear U Joint application.

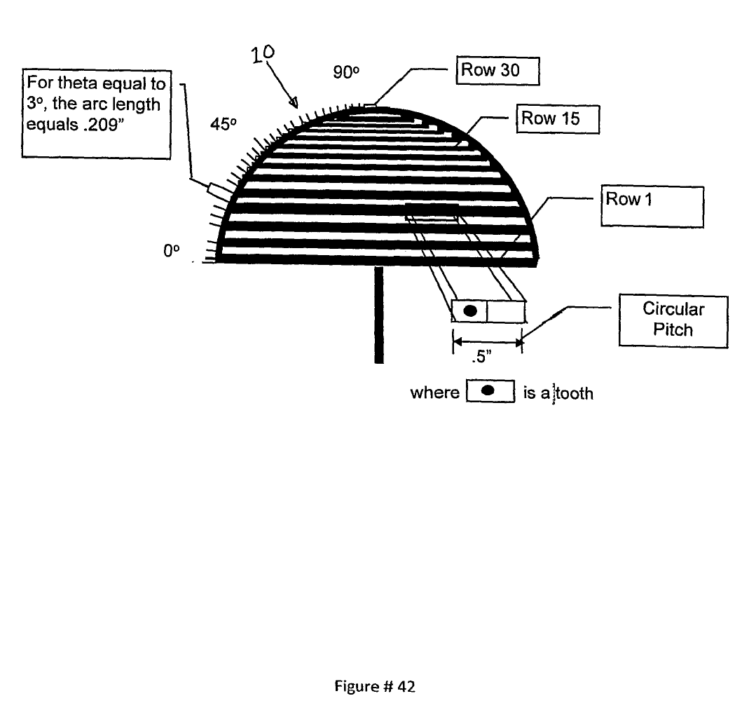

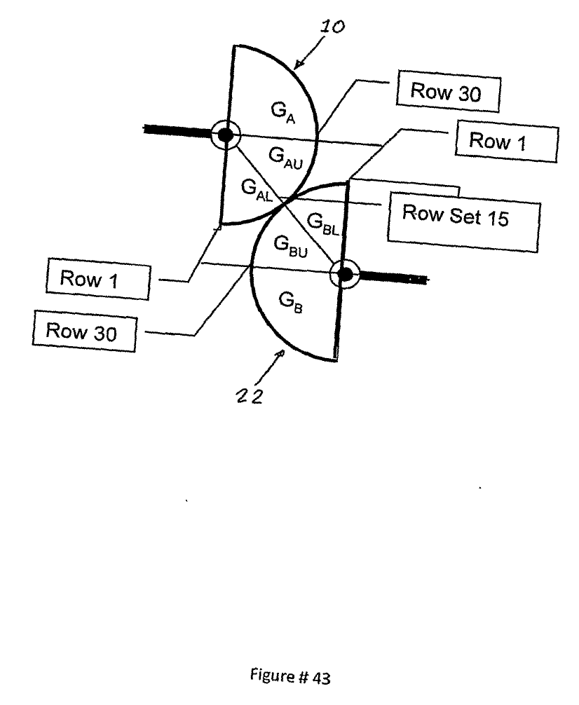

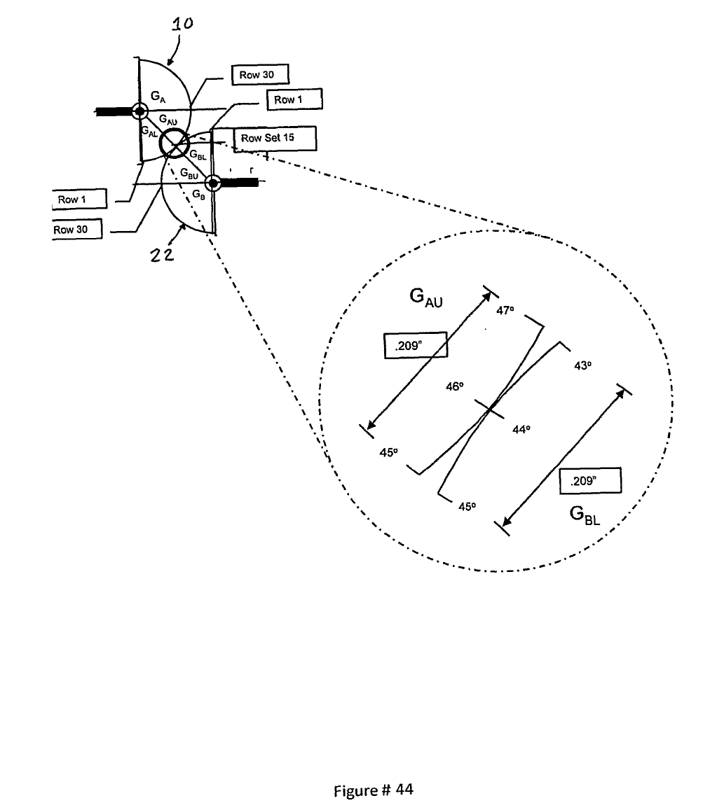

When gear heads in a Curvilinear U Joint are positioned as shown in FIG. 51, a problem arises when taking into account the formula Torque (T)=Force (F)×Radius (R). When R=0 for any value of T, F goes to infinity. To prevent this, R cannot go to 0. One solution is to remove part of the hemispherical surface of the gear heads such as that shown in FIG. 52. For lower torque applications, the relatively small planar surface shown as (a) may be used. For higher torque applications, the larger planar surface of (c) may be used. The resulting planar surface has a radius, but creates a further problem when rotating the gear heads through their range of motion as shown in FIG. 53. A gap is created when rotating from step 2 to step 3 and from step 3 to step 4. These movements require the gear heads to physically move closer together whereas rotation from step 1 to step 2 and from step 4 to step 5 only requires the gear heads to move about their pivot points to maintain contact with each other.

One solution is to provide one or two gear head shafts that can move laterally about their axes. A telescopic shaft can be used for this purpose. The telescopic shaft can be lengthened and shortened with the use of an internal axial loaded spring to bias the gear heads against one another to maintain contact throughout their range of motion. Another option is to use a cam. The cam concept eliminates the need for a telescopic shaft. The cam concept allows the harness to expand or contract in order to maintain contact between the two gear heads. A further option is to use a combination of a biasing spring and a cam.

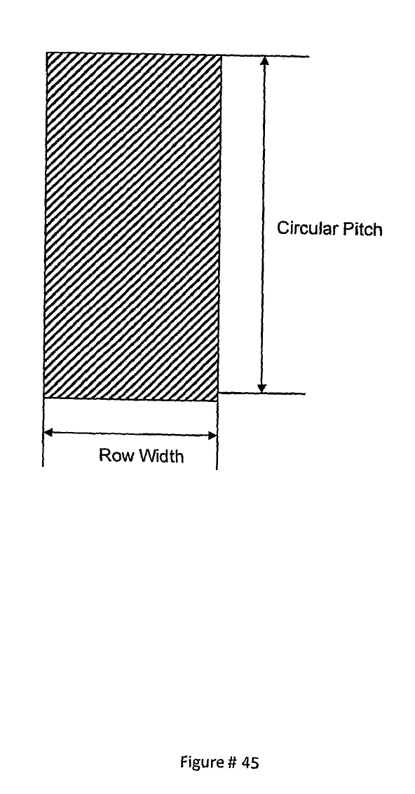

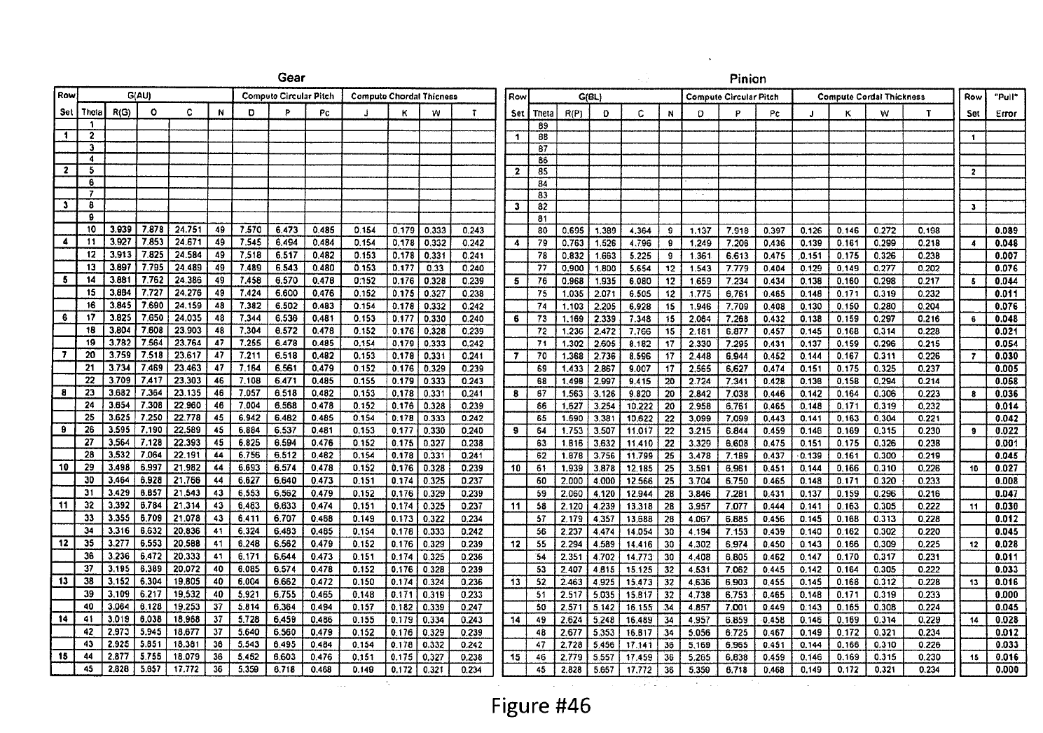

In a yet further aspect of the invention, a modified hemispherical gear head, shown in FIG. 54, is used to allow the pivot points of the gear heads of a Curvilinear U Joint to remain fixed As shown in FIG. 54, points 14 correspond to the same points shown in FIG. 53. At point 2 where the curvature of the curvilinear gear head surface meets the planar surface, a sharp change in tangent angle results. A sharp edge formed from the transition between the curvilinear surface and the planar surface is undesirable to allow the gear heads to transition smoothly from one point interaction on the curvilinear surface to the planar surface. To address this, a radius “r” of the planar surface can be created that starts at the same tangent angle as radius “R” of the curvilinear surface.

The application of a radiused edge forms an indented planar surface having a diameter d1. The distance between the point where the curvilinear surface transitions to the radiused surface has a diameter d2. D1 can equal d2, but should not when the gear head is used to support a spline. D3 represents the diameter that must precede the point of tooth (or spline) shear failure and coincides with the tangent angle shared by “R” and “r”. D4 represents one of multiple diameters that may be used to provide additional strength to the gear head.

With this high load hemispherical U Joint gear head design, two interacting gears should be geometrically identical as shown in FIG. 54B. To determine the amount of gap between hemispherical gear heads, the following illustrative formula can be applied to the gear head shown in FIG. 54A. To make the calculation, R=4″, r=1″, theta 1=theta 2=60°, and theta 3=theta 4=30°.

L1=(R−r) cos 30°=2.6″

L2=R cos 30°=4 ×0.866=3.46″

L3=(R−r) cos 30°+r=3(0.866)=3.6″

and

d1=((R−r) sin 30°−r)*2=(3(0.5)−1)*2=1″

d2=((R−r) sin 30°)*2=3″

d3=R sin 30°*2=2*2=4″

and

GAP (PER GEAR HEAD)=R−L3=4″−3.6″=0.4″

TOTAL GAP=2* 0.4″=0.8″

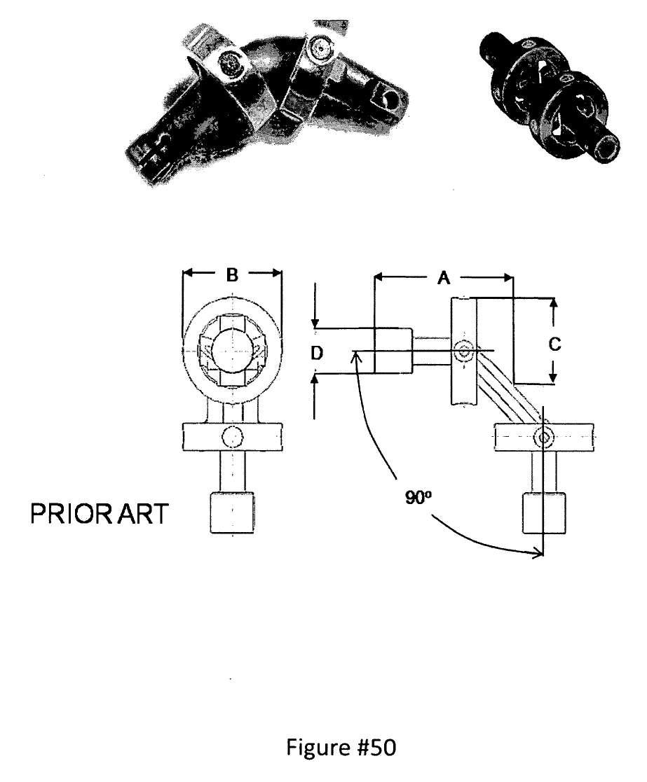

In a high load application, some form of physical interaction is likely to be preferred. FIG. 58 illustrates one of several potential concepts; specifically, the spline concept described more fully below. There are other physical interaction concepts for dealing with high loads, for example tooth concepts as described herein.

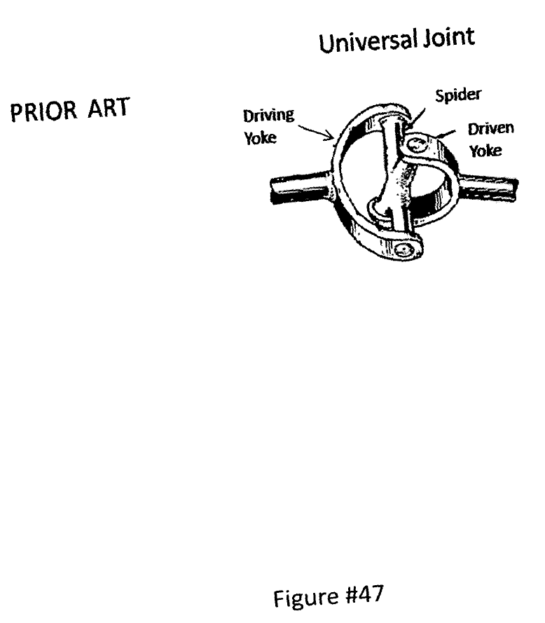

The basic design can be modified to accommodate high and low torque applications, and to support differences in friction and physically driven gear heads. Illustrative embodiments are shown in FIG. 55. For moderate to high torque applications the embodiment shown in FIG. 55(a) having a radiused transition between the curvilinear surface and the planar surface may be used particularly with gears that physically interact with features such as gear teeth. For friction driven applications, the embodiment shown in FIG. 55(b) may be used. It should be noted that this embodiment may also support physically driven gear head configurations.

The embodiment shown in FIG. 55(c) includes one gear head having a radially-extended curvilinear projection and a second gear head having a cavity that physically corresponds to the radial projection. This embodiment eliminates the gap that occurs when using two unaltered hemispherical curvilinear gear heads. This enables the gear head pivot points to remain fixed without compromising the ability for the two gear heads to remain in contact throughout their operational range of motion.

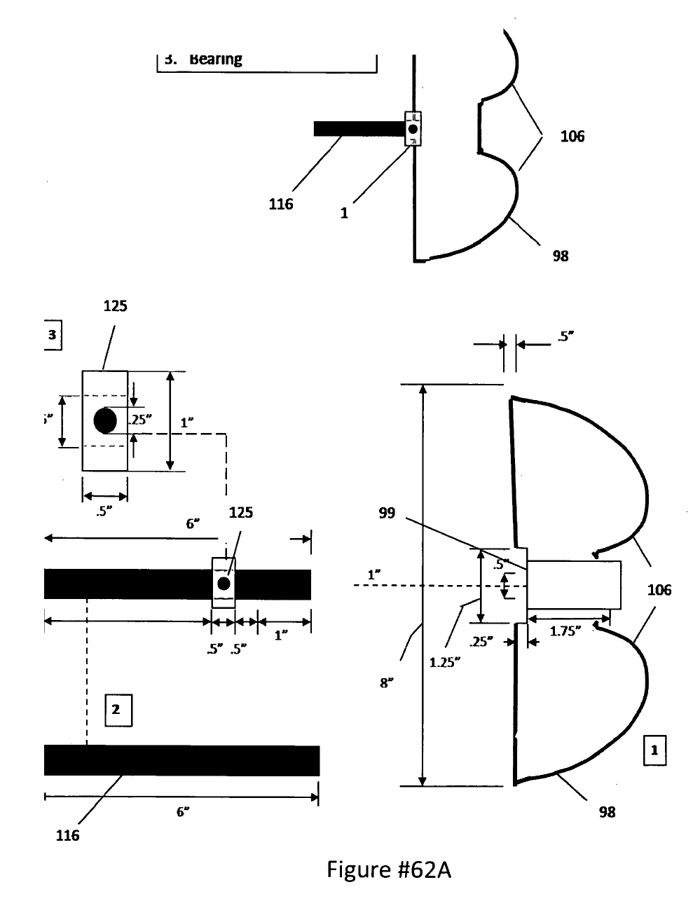

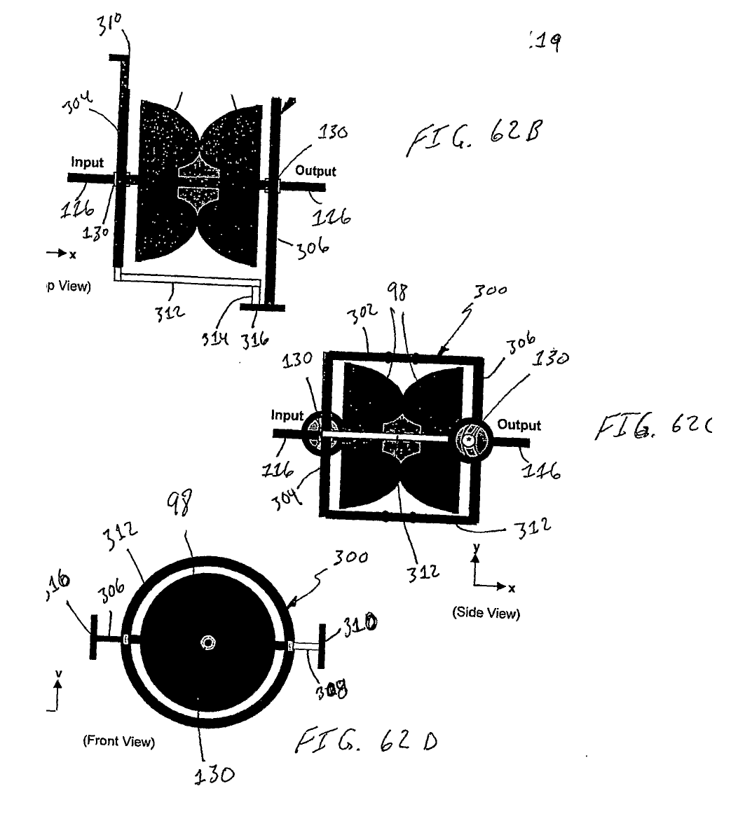

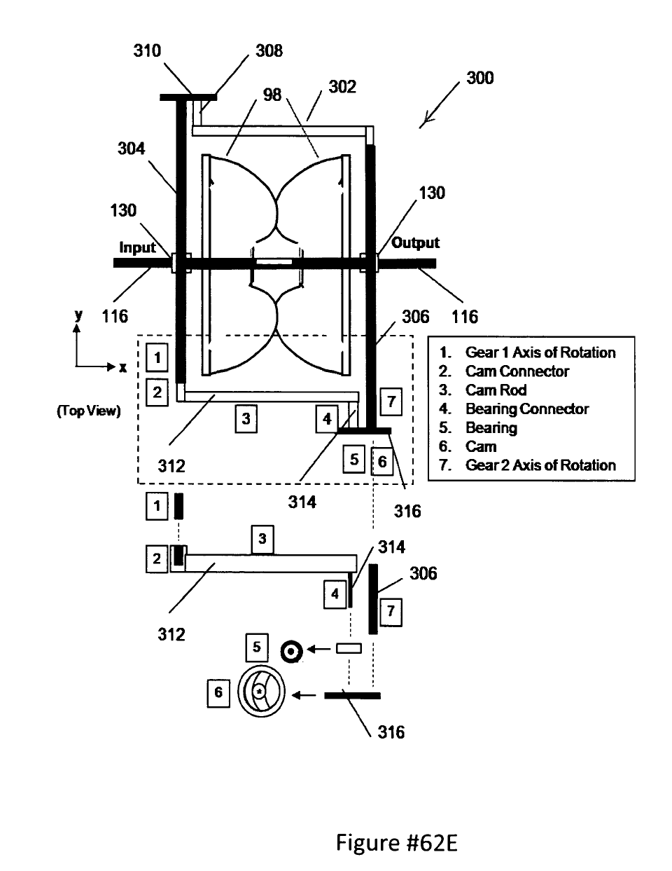

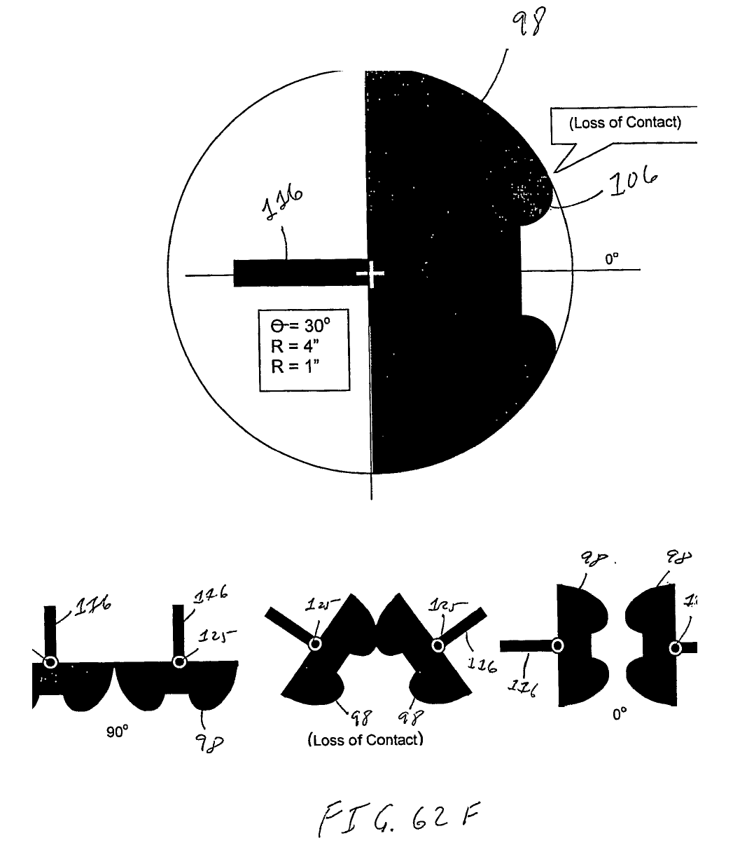

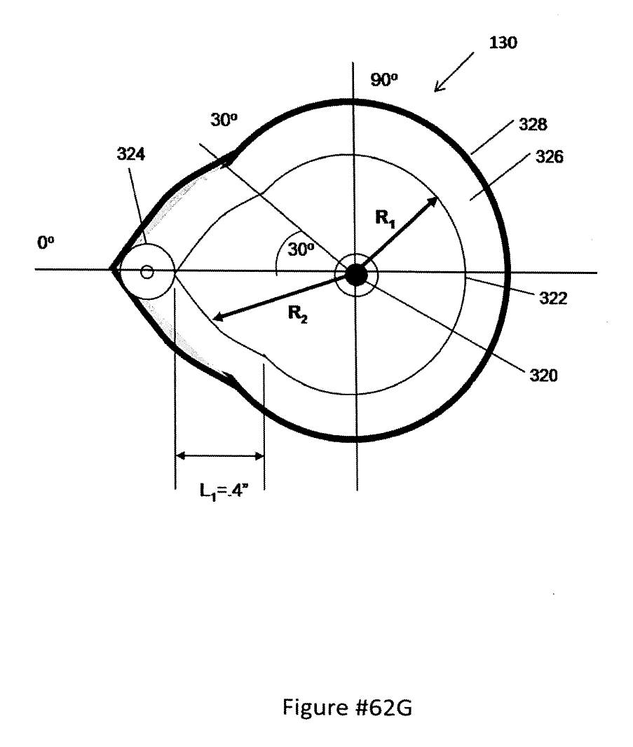

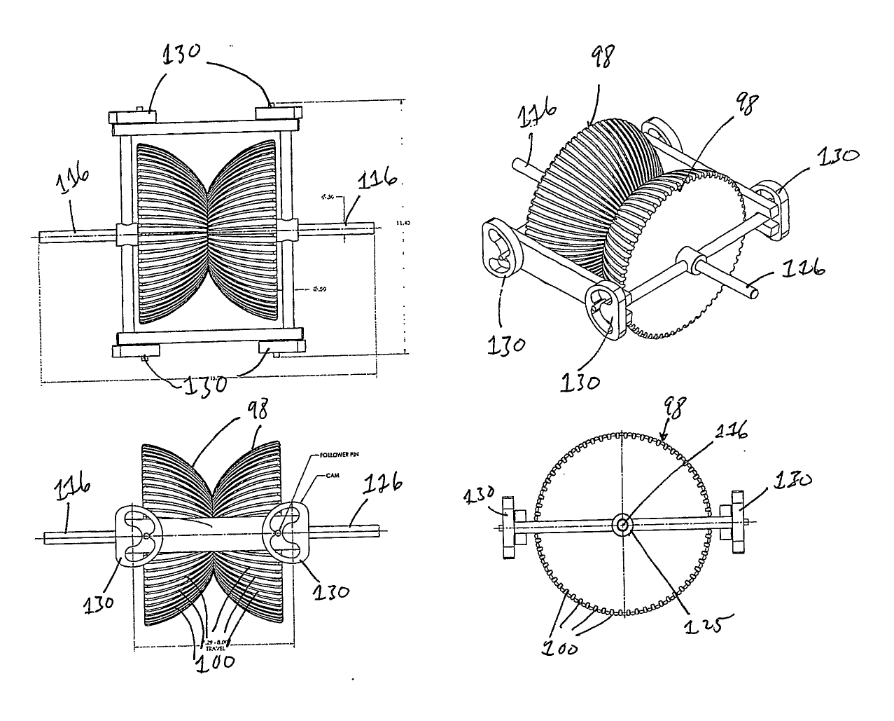

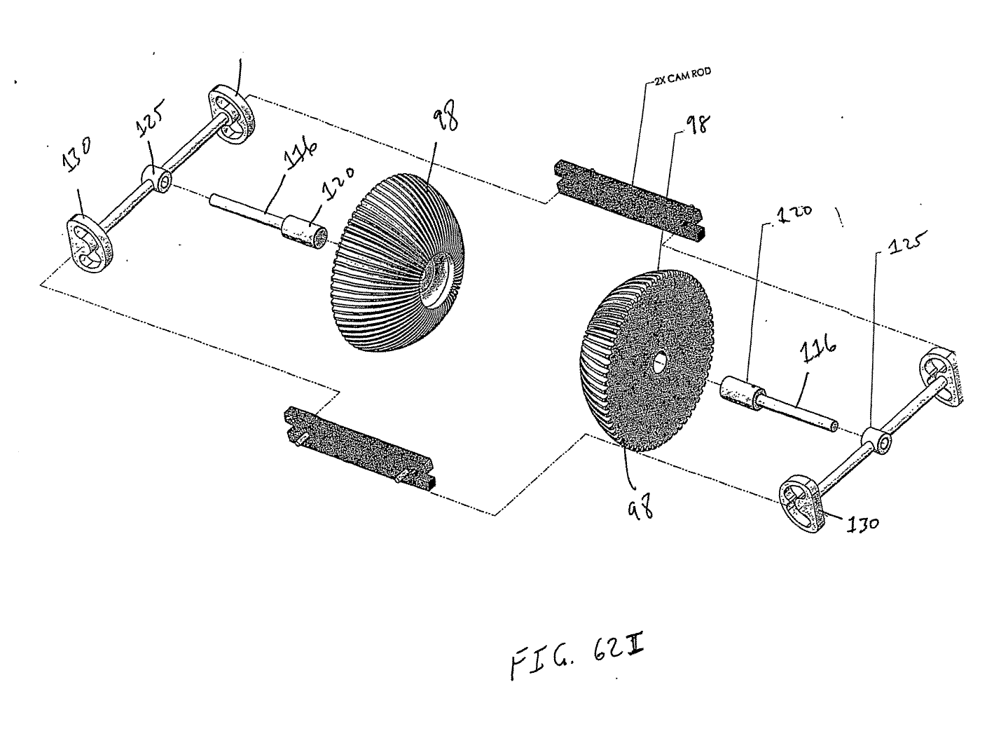

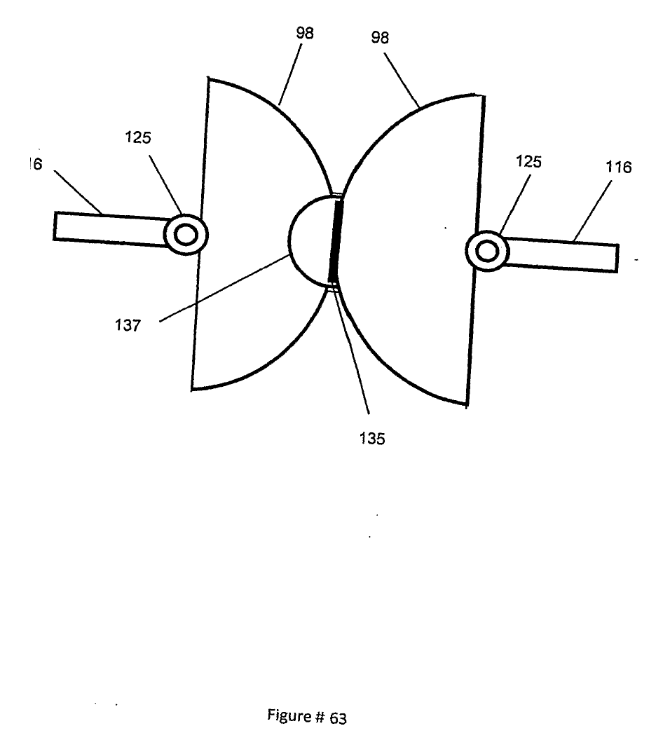

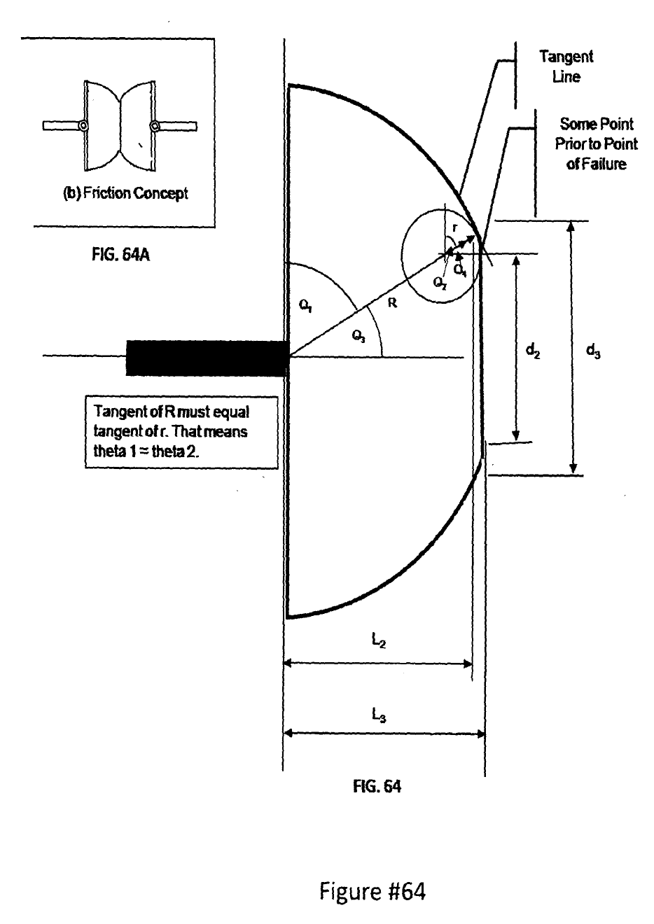

With respect to the low or friction load gear head, the only significant difference from the high load gear head is that L1 and d1 do not exist, and a friction surface replaces the physical interaction mechanism, such as splines. As shown in FIG. 64, a planar surface is formed without the radiused transition surface of the high load gear head. Like the high load gear head, interacting low load gear heads should be geometrically identical as shown in FIG. 64A. The same formula used to calculate the gap for the high load gear head is used to calculate the gap for the low load gear head. Again, to make the calculation, it is assumed that R=4″, r=1″, theta 1=theta 2=60°, and theta 3=theta 4=30°.

L2=R cos 30°=4×0.866=3.46″

L3=(R−r) cos 30°+r=3(0.866)=3.6″

and

d2=((R−r) sin 30°)*2=3″

d3=R sin 30°*2 =2*2=4″

and

GAP (PER GEAR HEAD)=R−L3=4″−3.6″=0.4″

TOTAL GAP=2*0.4″=0.8″

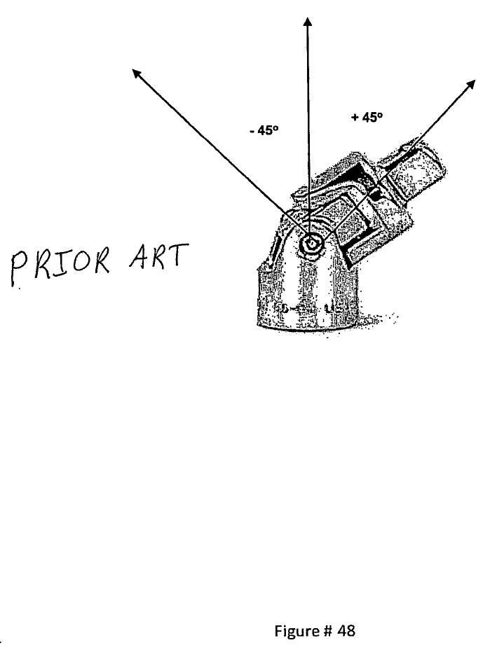

In another aspect of the invention, splines may be used as the physical interaction mechanism on hemispherical gear heads used in a Curvilinear U Joint. As shown in FIG. 56, splines 100 are formed as radial arrays that extend from an outer diameter of gear head 98 to an apex 102. Illustratively, the cross-sectional shape of the spline can be configured in the form of conventional gear teeth, such as those formed on a spur gear and even helical and double helical gears.

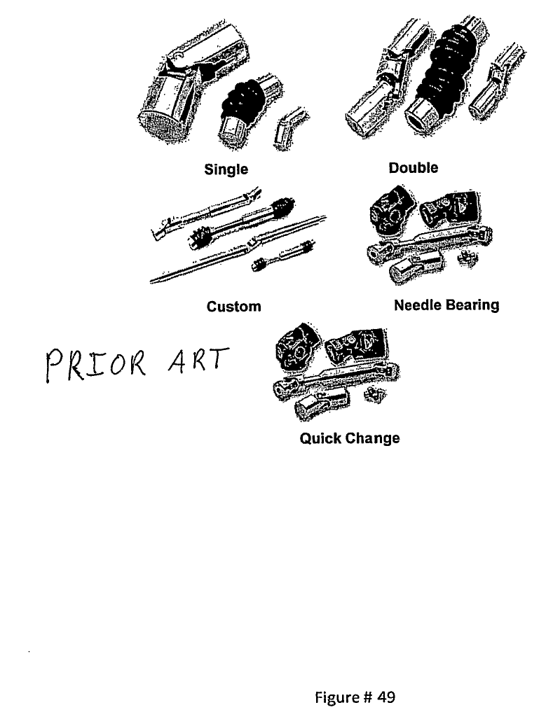

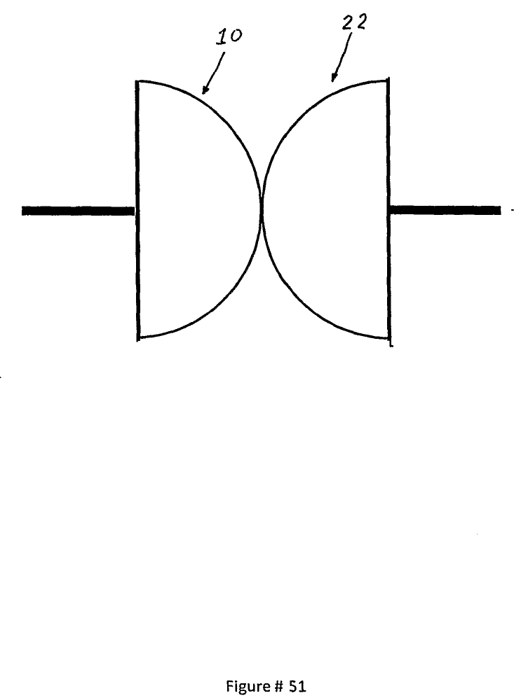

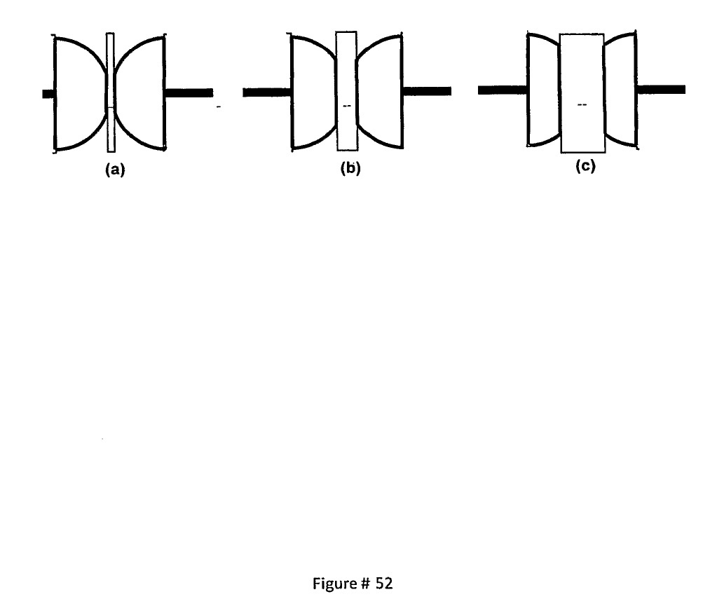

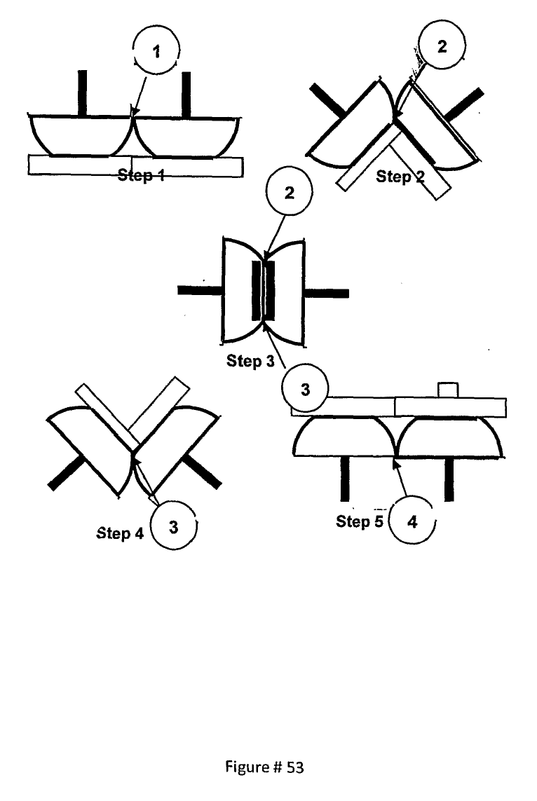

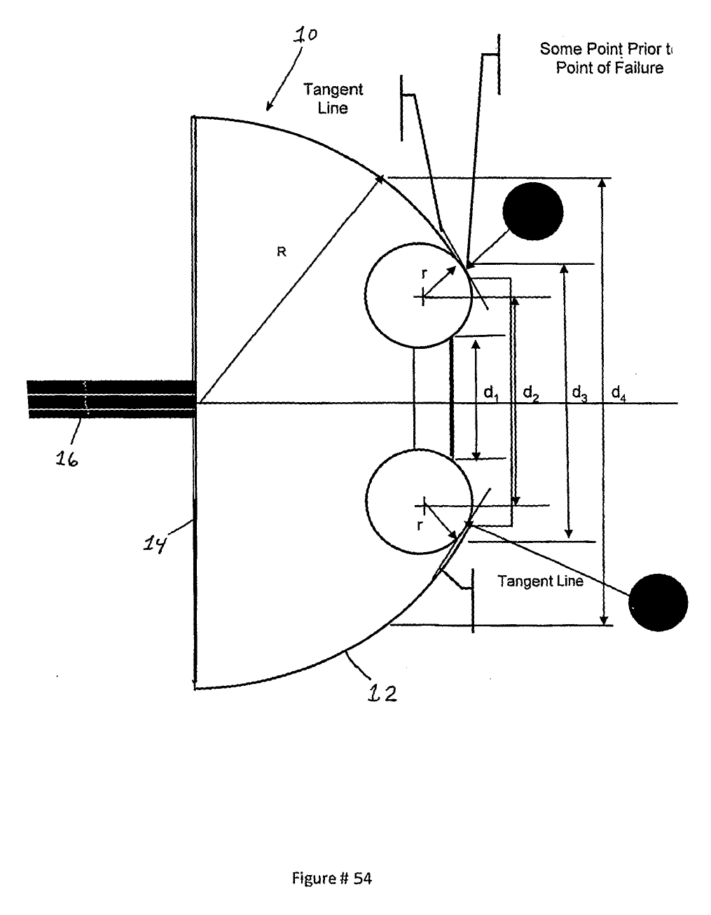

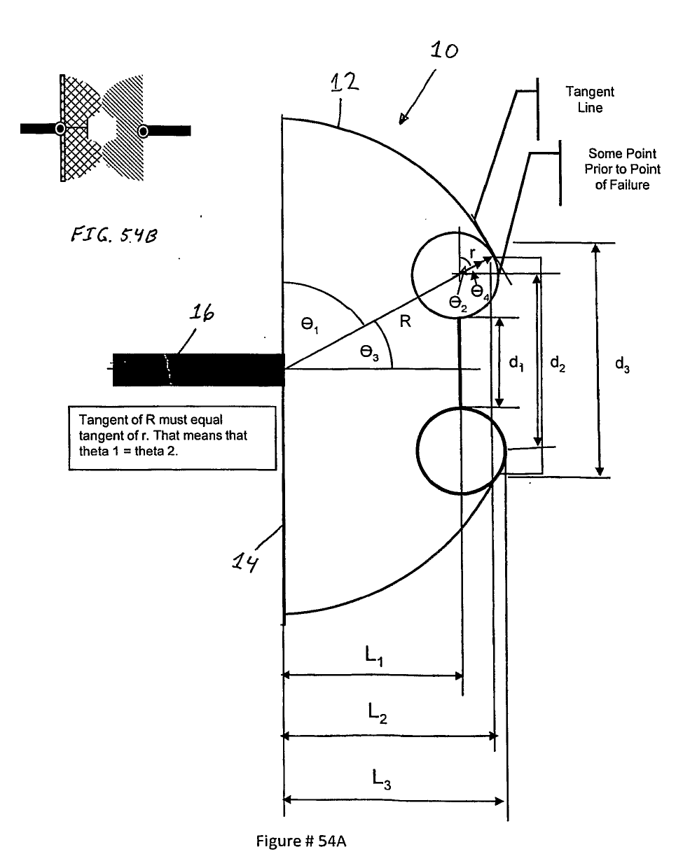

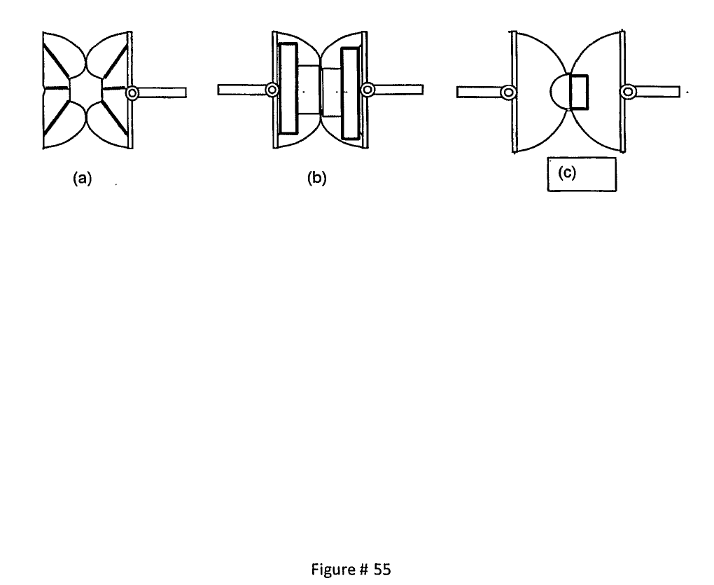

With respect to the use of splines as the physical interaction mechanism, as shown in FIG. 57, the interactive mechanism fails at 0°, and in many embodiments, fails well before 0°. Modification of gear head 98 with a planar surface and radiused curvilinear/planar junction as shown in FIGS. 58 and 59 solves the problem at 0° with an unaltered hemispherical curvilinear gear head that includes splines. The problem is further resolved by introducing at least one involute surface on a gear head that interacts with gear head 98 such as curvilinear gear head 97 shown in FIG. 61D. The involute surface provides a smooth transition and consistent contact as the gear heads rotate through their angular ranges of rotation.

An important feature of the embodiment shown in FIG. 58 is the size of the teeth at d2. The size of teeth at d2 will be substantially smaller than the size of a tooth at the outer diameter “R”. It is important to dimension the size of teeth at d2 to have the shear strength necessary for the particular application. The use of splines as the physical interaction mechanism can be used with just about any gear head design. Reducing tooth size at different diametral ranges provides a means to ensure proper tooth shear strength. To illustrate, the number teeth in the d3 range can be maximized. The number used between d2 and d3 can be reduced to provide larger and stronger teeth. The number of teeth in the range between d2 and d1 can be further reduced to allow for larger stronger teeth that can withstand the expected shear forces.

Having described a curvilinear gear head with a planar surface having a radiused junction, attention is drawn to the gap that forms when two such gear heads interact and rotate about their pivot points as shown in FIG. 60. To close the gap and maintain gear head interaction, one of two illustrative solutions may be used, an extendible shaft or a cam.

Referring to FIGS. 61, 61A, 61B and 61C, a Curvilinear U Joint is shown having two gear heads 98 having planar surfaces 104 that have radiuses 106 that transition planar surfaces 104 to the curvilinear surfaces of gear heads 98. Shafts 116 are attached to gear heads 98 via pivot bearings 125. Proximal ends of shafts 116 extend within gear heads 98 in bores dimensioned to allow shafts 116 to move freely laterally within gear heads 98. Axial force springs 118 are positioned against proximal tips of shafts 116 at one end and register against spring retaining caps 120 secured within bores formed in planar surfaces 104. Springs 118 bias gear heads 98 against each other by urging gear heads 98 away from the proximal ends of shafts 116. Springs 118 allow gear heads 98 to maintain constant interaction throughout their operational ranges of rotation.

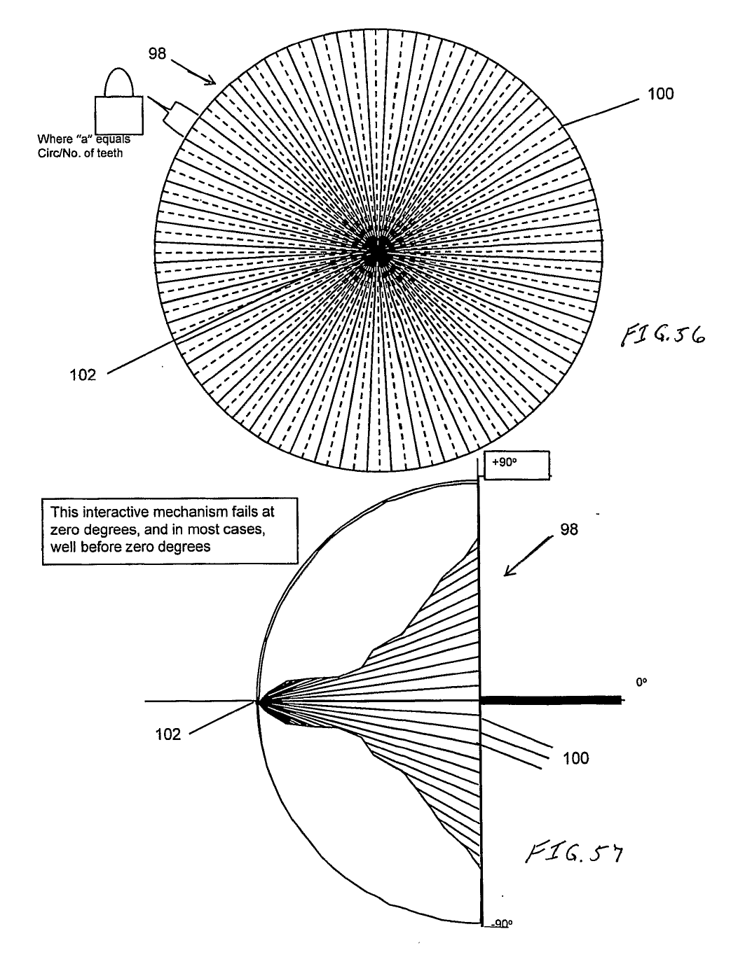

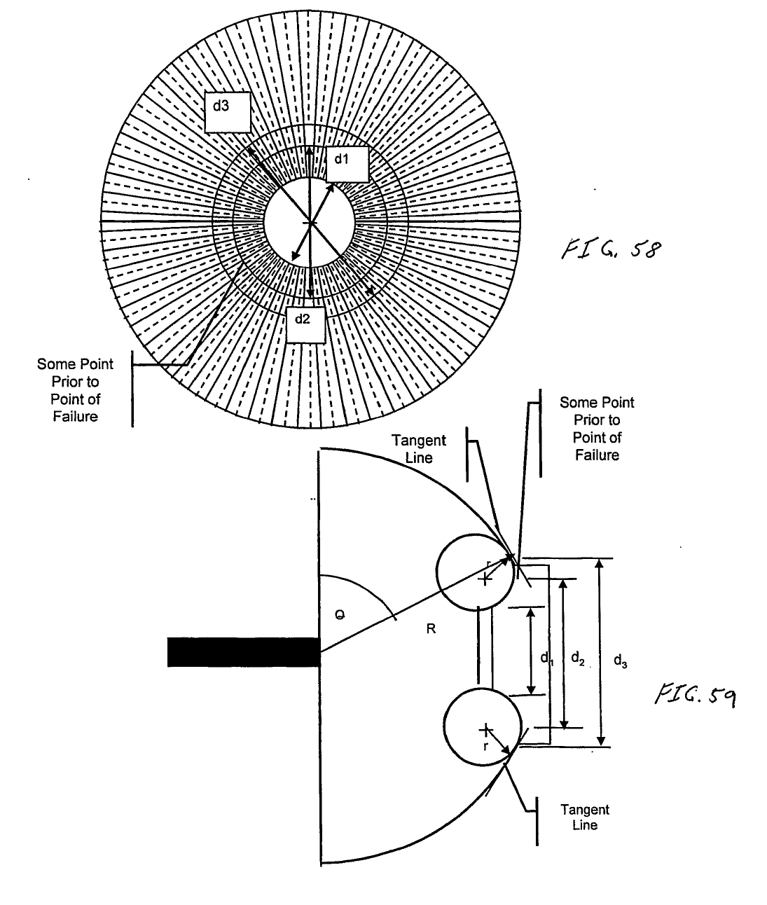

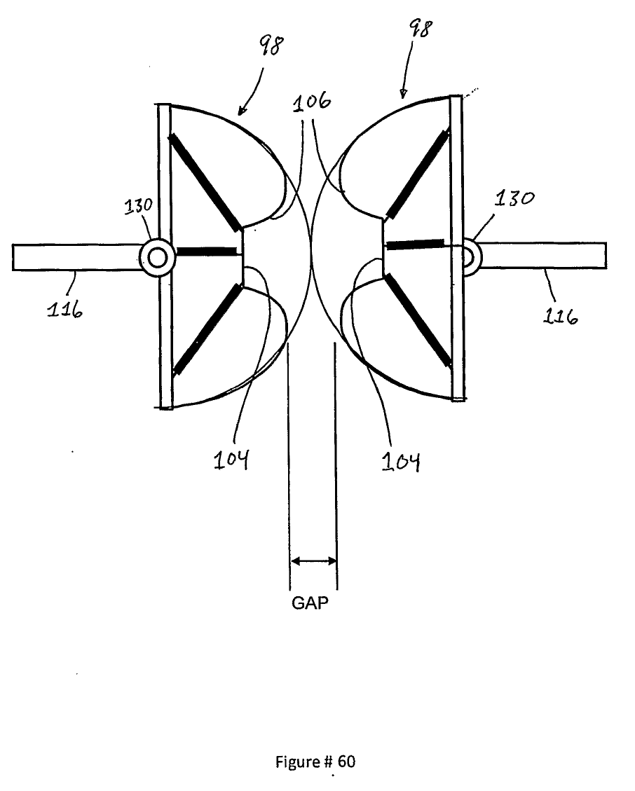

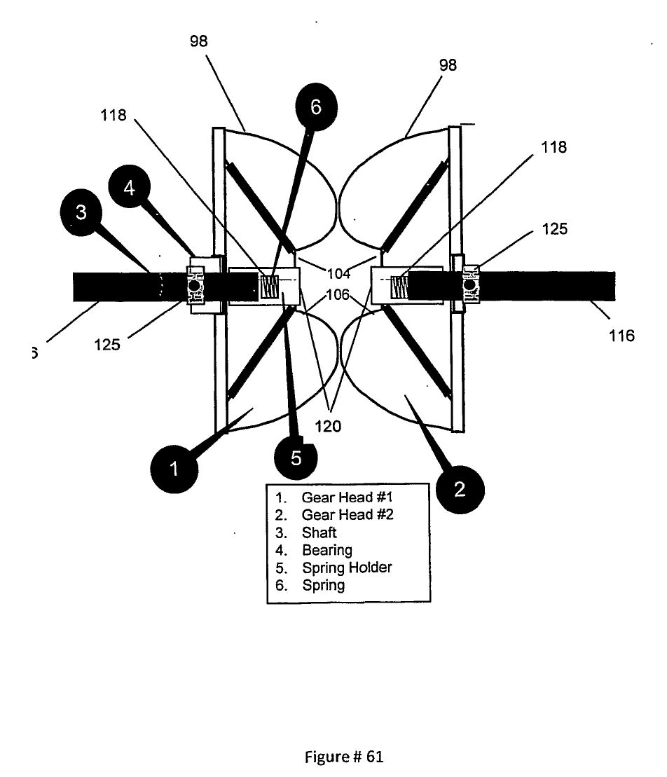

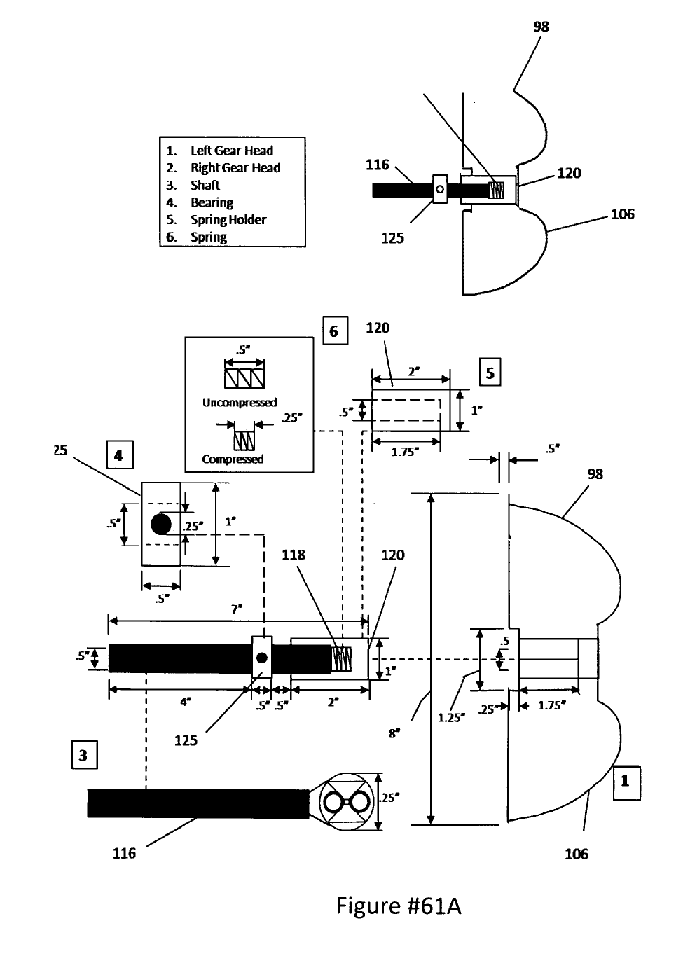

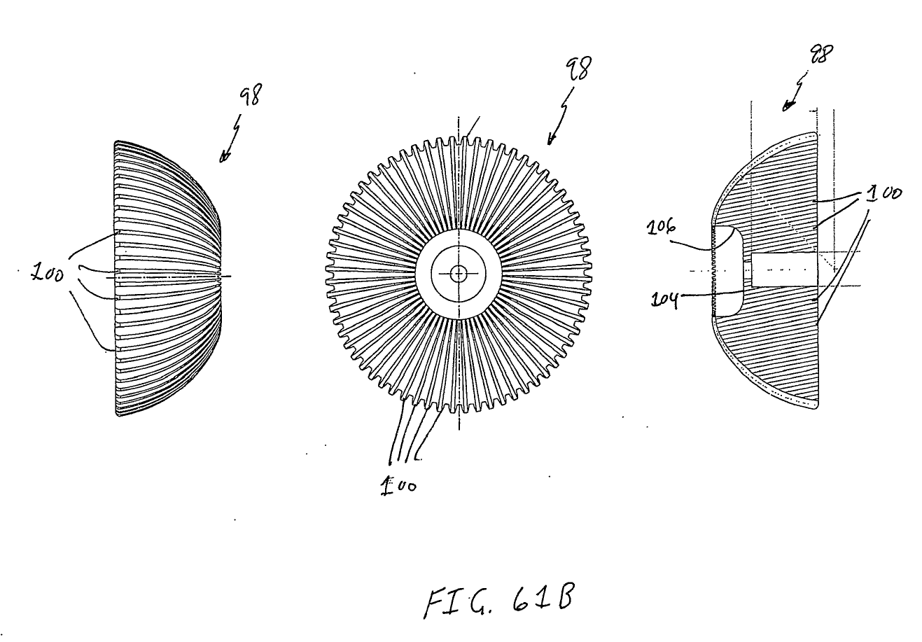

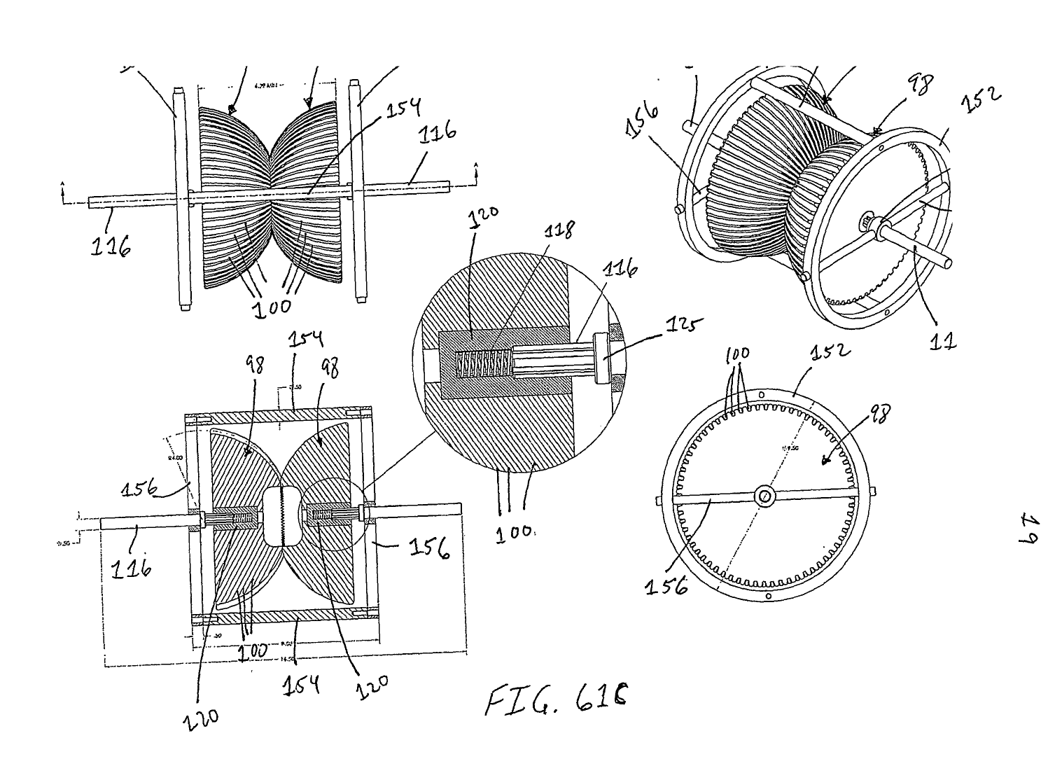

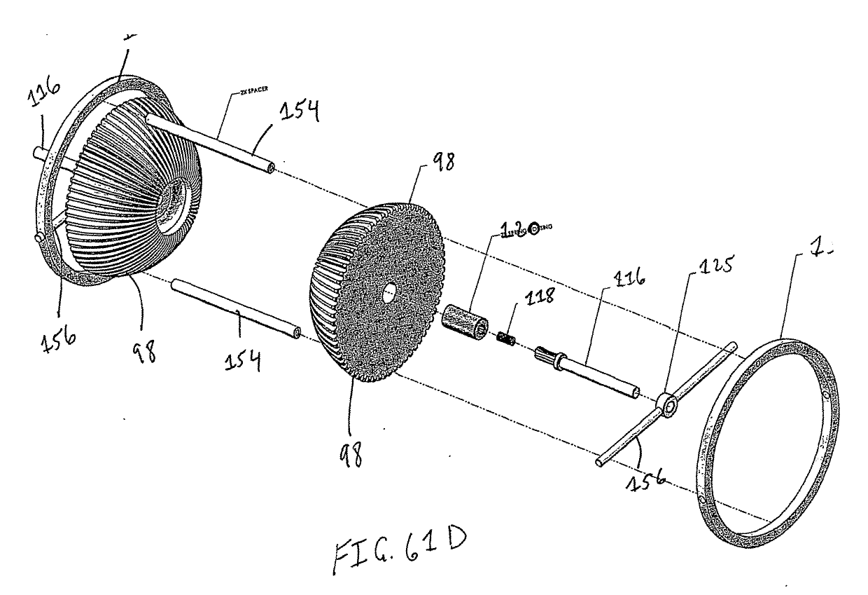

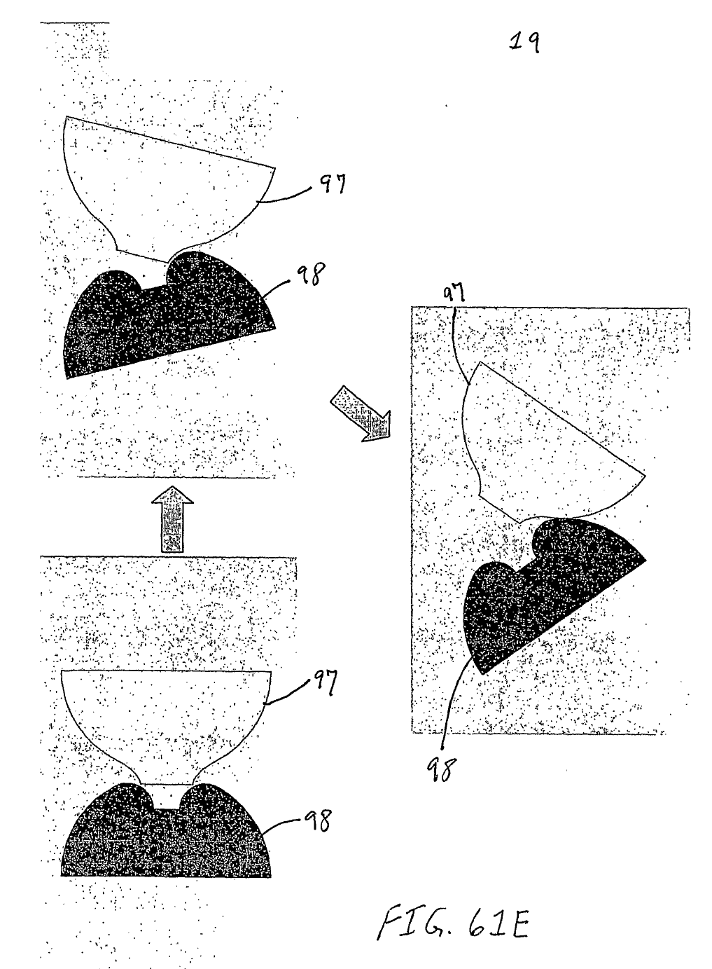

In another aspect of the invention, a cam system shown in FIG. 62 urges gear heads 98 against each other in a controlled manner dictated by the cam's surface configuration to maintain constant interaction between the gear heads throughout their operational ranges of rotation. A shaft or gap rod 118 is connected to a cam 130 via a small gear positioned at one of the pivot points of one of the gear heads 98. The cam has cam surfaces dimensioned to correspond with the outer surfaces of the gear heads so when the gear heads rotate the cam rotates and urges one of the pivot points to move toward or away from the other so as to maintain contact and interaction between the gear heads.

The cam system in its simplest form involves a curvilinear U Joint that includes two gear heads, each with a shaft and a bearing that connects the shaft to the gear head and supports rotation about the axis of rotation and the rotation of one gear head relative to the other. Referring to FIG. 62A, gear head 98 has a portion defining a gear head bore 99 for receiving bearing 125.

To implement a cam system to the curvilinear U Joint, a variable width harness, shown generally as 300 in FIG. 62B, is required to allow movement of the gear head pivot points to eliminate the creation of a gap during gear head rotation. Referring to FIGS. 62B-62E, harness 300 includes a top brace 302 connected to an input brace 304 and an output brace 306. Top brace 302 has a brace extension 308 that slides within a slot in a brace connector 310 that connects to an end of input brace 304.

Harness 300 also has a bottom brace 312 also connected to input brace 304 and output brace 306. Bottom brace 312 has a bottom brace extension 314 that slides within a slot in a bottom brace connector 316 that connects to an end of output brace 304. Referring to FIG. 62E, in one embodiment, input brace 304 slides into a bore formed in bottom brace 312, which performs as a cam rod that pulls or pushes one gear head relative to the other. Bottom brace extension 314 acts as a bearing connector that connects to brace connector 316 that performs as a bearing. The bearing interacts with the cam 130 to move bottom brace or cam rod 312 to move the gear heads so as to maintain physical contact between the gear heads as they rotate through their entire angular range of motion. The top sliding brace and its related components perform the same function as the bottom brace. The combination of the top sliding brace and bottom sliding brace accommodate lateral movement of the gear head pivot points. A further embodiment of the cam system with modified gear heads is shown in FIGS. 62H and 62I in which

The cam 130 is connected to the output axis of rotation to provide a spring-less system for connecting curvilinear gears. To illustrate what the cam accomplishes, a gap forms when two curvilinear gear heads move through their angular ranges of rotation as shown in FIG. 62F. The loss of contact occurs when the curvilinear surface transitions to the planar surface and reaches a maximum at 0°.

Referring to FIG. 62G, cam 130 includes a pivot point 320 about which cam surface 322 rotates. A bearing 324 moves within a bearing channel 326 formed within a cam housing 328. Radius designated R₁ in FIG. 62G may have any value between 30° and 90°, but must remain a constant value throughout the angular range. The distance L₁ should always equal half the length of the full gap between gear heads. In the illustrative example, the amount is 0.4″. The second radius designated as R₂ represents the required increase in R₁ when moving from 30° to 0°, the approximate range in which a gap condition occurs. The increase in R₁ is determined by the following equation: R2=R=((R−r)cos(theta)+r. It should be noted and understood that the cam concept can be combined with the extendable shaft concept to eliminate or substantially reduce the formation of a gap between rotating curvilinear gear heads.

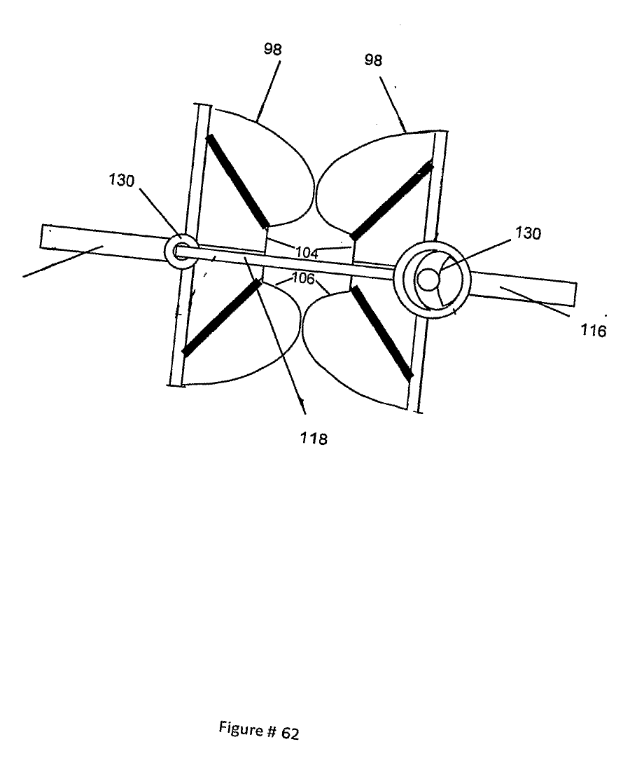

In a yet further aspect of the invention, a curvilinear U Joint system includes gear heads 98 having interlocking surfaces as shown in FIG. 63. In this embodiment, one gear head has a radial projection 135 that fits within a cavity 137 formed on the surface of the other gear head 98 that is dimensioned so that a substantial portion of the surface area of cavity 137 interacts with a substantial portion of projection 135 when the gear heads are aligned at their 0° points. This configuration eliminates the creation of a gap at any point when the gear heads are rotated through their entire range of rotation.

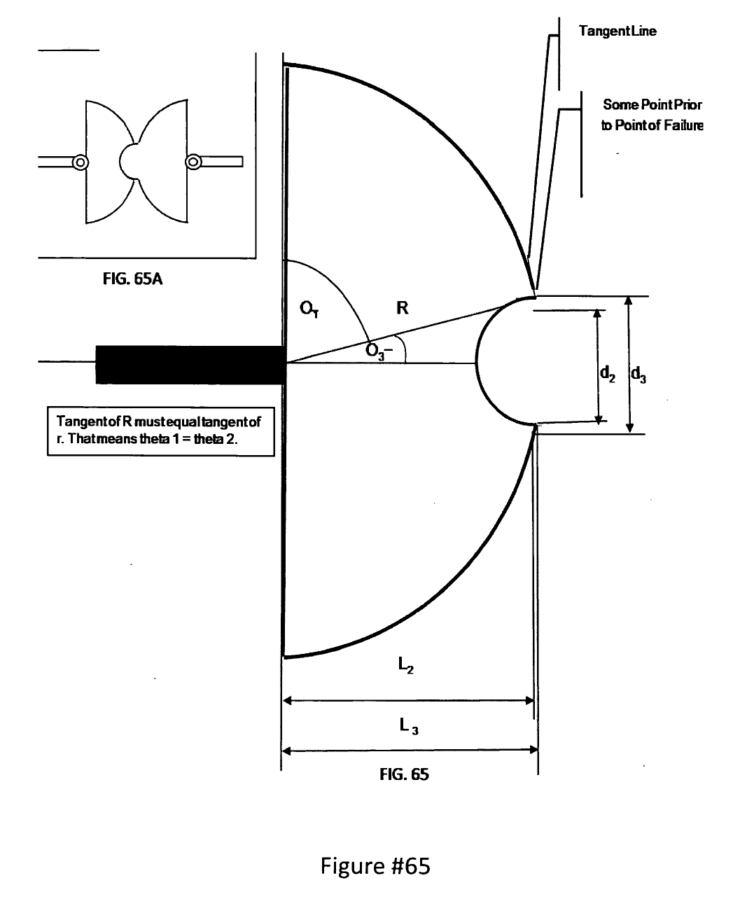

Referring to FIGS. 65, 65A, and 66, the interacting gear heads do not have identical geometries. The design enables the gear heads to rotate about their respective pivot points without the gear heads losing contact when using the friction or high load surface structure designs. It is important to start the cavity edge at a point within the diameter of the failure point. Likewise, the corresponding projecting curvilinear section of the complimentary gear head should begin at a point within the diameter of the failure point.

Referring to FIGS. 65 and 66, to calculate the gap with respect to the “no gap” concept, the following formula is used:

### If R=4″

and r=1″

theta 1=theta 2=76°

theta 3=theta 4=14°

then

L2=R cos 14°4×0.97=3.88″

L3=R cos 14°+(r−r cos 14°)=3.88″+(1−0.97)=3.91″

and

d2=2*r=2*1″=2″

d3=(R+r) sin 14°*2=(4+1)*0.24*2=2.4

The “no gap” configuration can be implemented with either a friction or physical interface. If a physical interface is used, tooth strength is an important issue, particularly with respect to the teeth in close proximity to 0°. One alternative to improve tooth strength for those teeth close to 0° is to reduce the number of teeth as shown in FIG. 67. By reducing the number of teeth, the tooth size can enlarged which invariably leads to an increase in tooth strength. As shown in FIG. 68, the gear heads maintain contact throughout their rotation ranges thereby eliminating the need to shift the gear head pivot points to address gap issues.

To keep interacting gears in contact, in one embodiment, a harness is used as shown in FIGS. 71-74. The harness, shown generally as 150, includes two circular supports 152 dimensioned to exceed the outer circumference of the gear heads. Circular supports 152 are attached to one another with lateral struts 154 and bearing support struts 156. Bearing support struts 156 have portions defining bearing apertures for receiving bearings 125 so as to support shafts 116. The design is particularly advantageous due to its simplicity and ability to accommodate a wide variety of gear head embodiments that employ fixed shafts. All of the gear head embodiments disclosed herein and any equivalents thereof can be incorporated into harness 150.

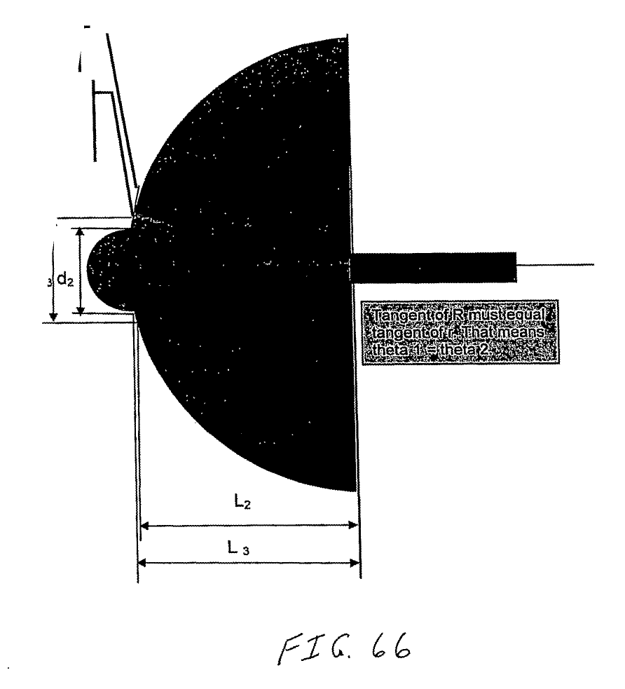

Having described the curvilinear gear and curvilinear U Joint, attention will be drawn to incorporating these concepts into a practical application, a transmission. A transmission is defined as a device that transfers power from an engine with a series of gears to change torque and angular velocity in a drive train. FIG. 75 illustrates a prior art transmission in which a series of gears interact to impart changes in torque and angular velocity as is well known in the art.

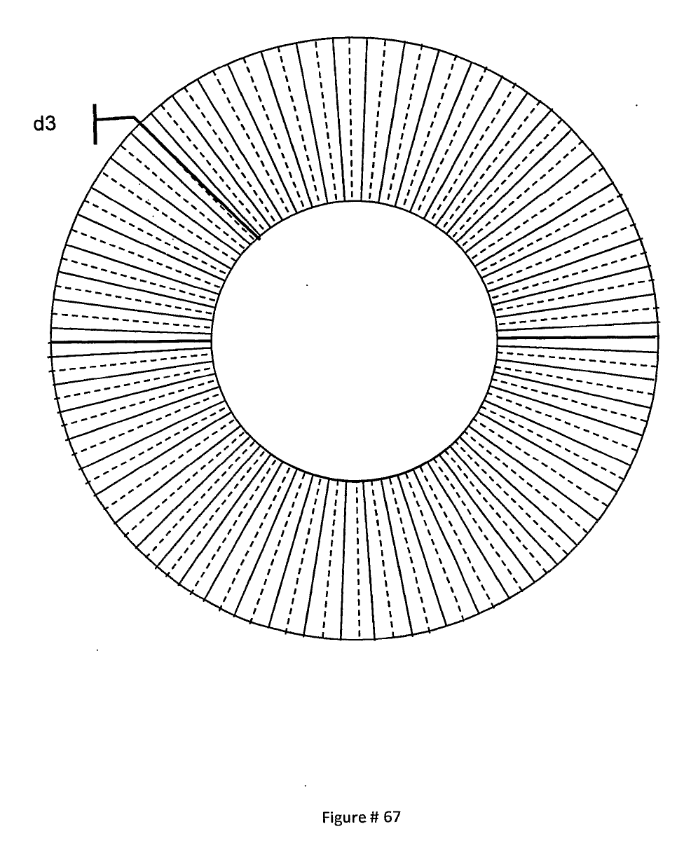

Referring to FIG. 76, when curvilinear gear heads 12 and 23 interact, the shafts 16 and 24 of the gear heads are in continuous angular motion. To provide practical application, the axes of rotation for the input and output shafts have to be stabilized. This disclosure provides three alternatives to stabilize the shafts. It should be understood that the alternatives and embodiments thereof are illustrative and do not limit the scope of the appended claims as other alternatives and equivalents thereof are within the contemplation and scope of the claims.

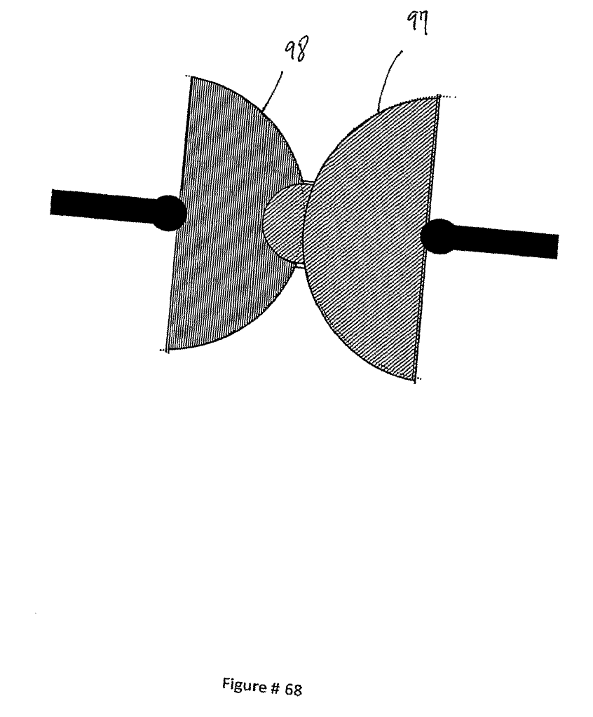

Referring to FIG. 77, in accordance with one aspect of the invention, a fixed output shaft embodiment is shown in which a fixed output shaft 24a is connected directly to the output gear head 23. Input shaft 16a is not directly connected to input gear head 12 so that the pivot point of gear head 12 is not stable. The pivot point travels 90° along an arc having radius R, where R=d (the diameter of output gear head 23. For this embodiment, a kinematic mechanism is needed to connect input shaft 16 to fixed input shaft 16a. A means to connect the shafts is described below.

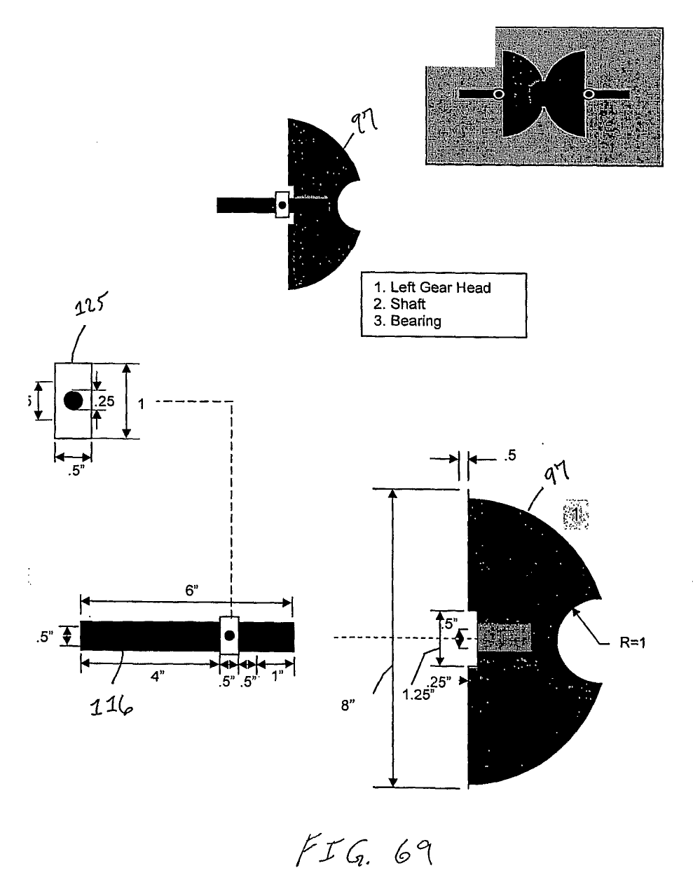

Referring to FIG. 78, in accordance with another aspect of the invention, a fixed input shaft embodiment is shown in which a fixed input shaft 16a is connected directly to the input gear head 12. In this embodiment, output shaft 24a is not directly connected to output gear head 23 so that the pivot point of gear head 23 is not stable. The pivot point travels 90° along an arc having radius R, where R=d (the diameter of input gear head 12. For this embodiment, a kinematic mechanism is needed to connect output shaft 24 to fixed output shaft 24a. A means to connect the shafts is described below.

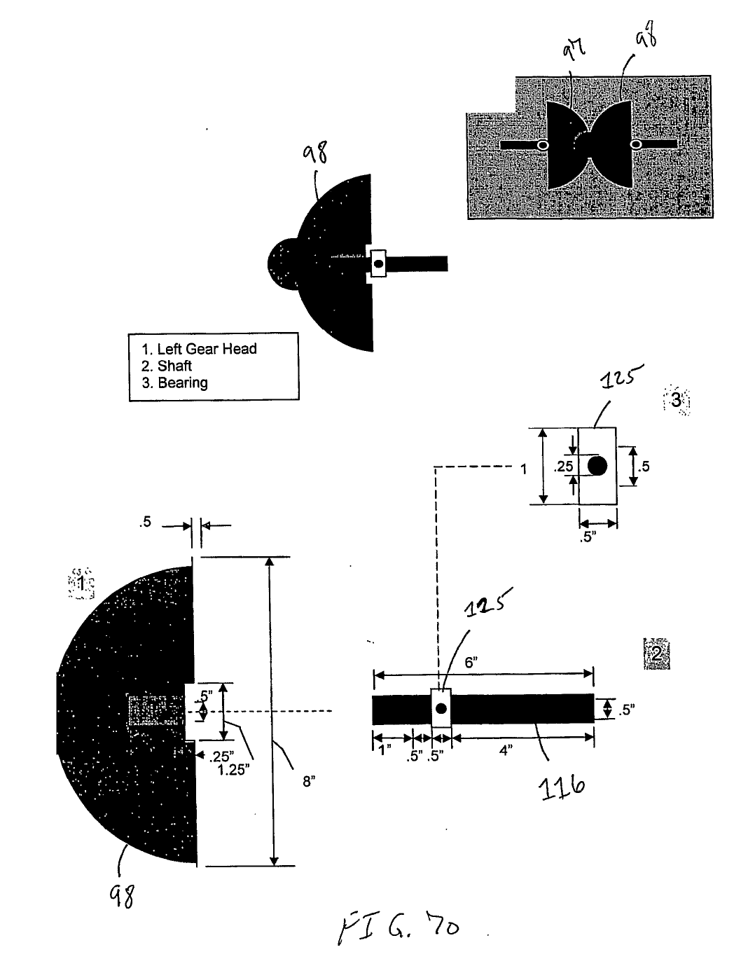

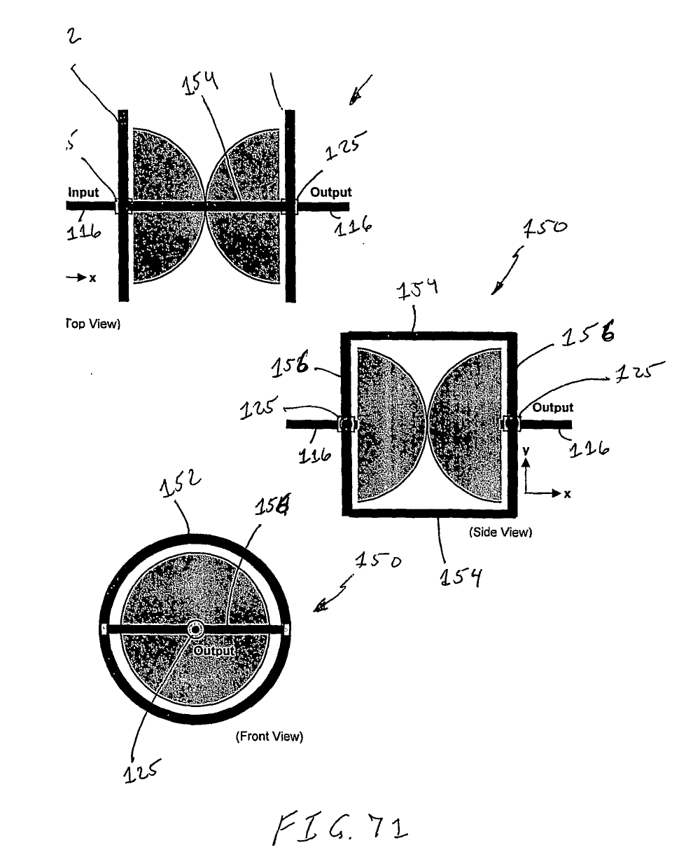

Referring to FIGS. 79, 80 and 81, in accordance with a further aspect of the invention, an embodiment is shown in which neither fixed shaft is directly attached to a gear head thus providing a variable input/output configuration. FIG. 79 shows gear heads 12 and 23 interacting each at 45°. FIG. 80 shows gear heads 12 and 23 interacting with the gears shifted plus 45°. And FIG. 81 shows gear heads 12 and 23 interacting with the gears shifted minus 45°. In this embodiment, both the fixed input and output shafts require a means for connection to the corresponding gear heads. It is noteworthy that the pivot point for each gear head is not stable. Each gear head travels 45° along an arc having a radius R, where R=d (the diameter of the output gear)/2. This embodiment reduces the variability of the angular travel of the shafts by approximately 50%, from about 90° to about 45°.

The 45° travel of the variable input/output configuration is a substantial increase over the efficient operational angles of standard universal joints that run between 15° to 30°. To connect the fixed shafts to the unstable shafts, two alternative solutions are presented. The first incorporates conventional universal joints as a connecting means. The second incorporates a hemispherical universal joint as a connecting means. It should be understood that either of these illustrative alternatives can be used with any of the three shaft stabilization embodiments.

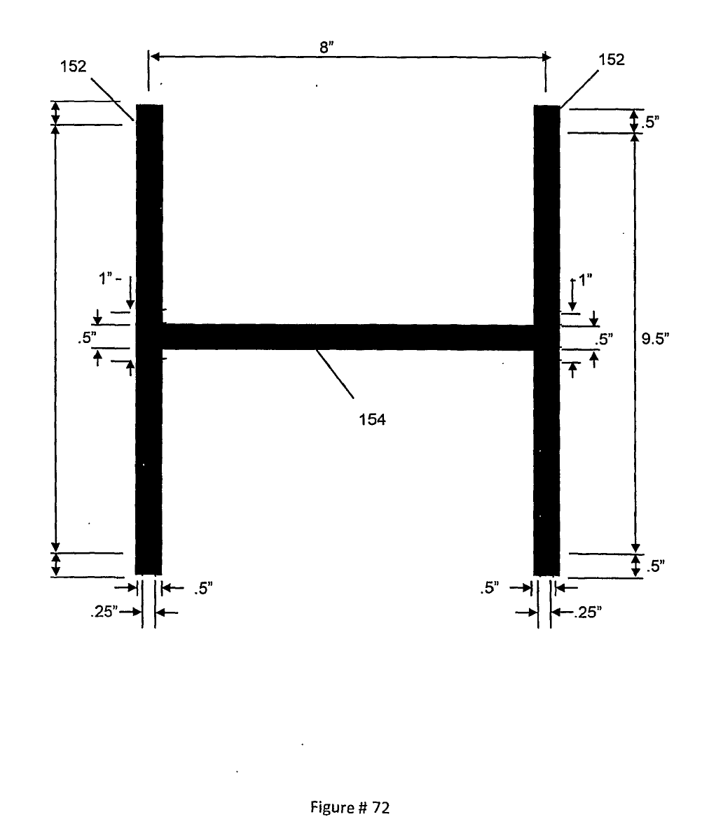

Referring to FIG. 82, conventional universal joint/shaft assemblies are used to connect the fixed shafts to the unstable shafts of the gear heads. In this embodiment, input shaft 16a is attached to a first input universal joint 170, which is attached to an input central shaft 172, which is connected to a first end of a second input universal joint 174. A second end of a second universal joint 174 is attached to input gear head 12 at its pivot point. Output shaft 24a is connected to a first output universal joint 176, which is attached to an output central shaft 178, which is connected to a first end of a second output universal joint 180. A second end of second output universal joint 180 is connected to output gear head 23 at its pivot point.

The universal joint embodiment has two known limitations. Due to the motion of the gear heads as they rotate through their ranges of angular motion, the two central shafts have to change in length to accommodate the lateral displacement of the shafts between the gear heads and the fixed static shafts 16a and 24a. One solution is to use telescopic shafts for the central shafts.

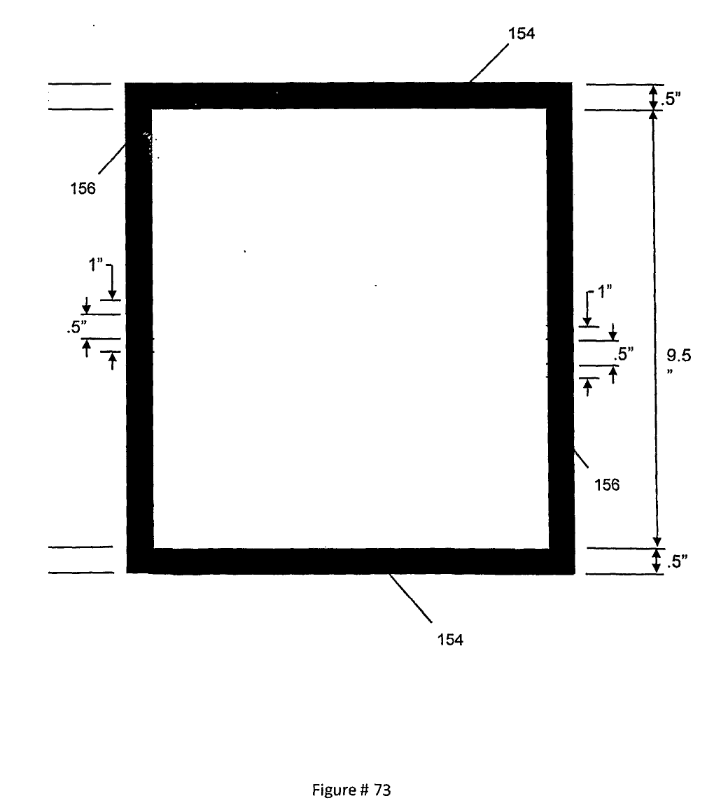

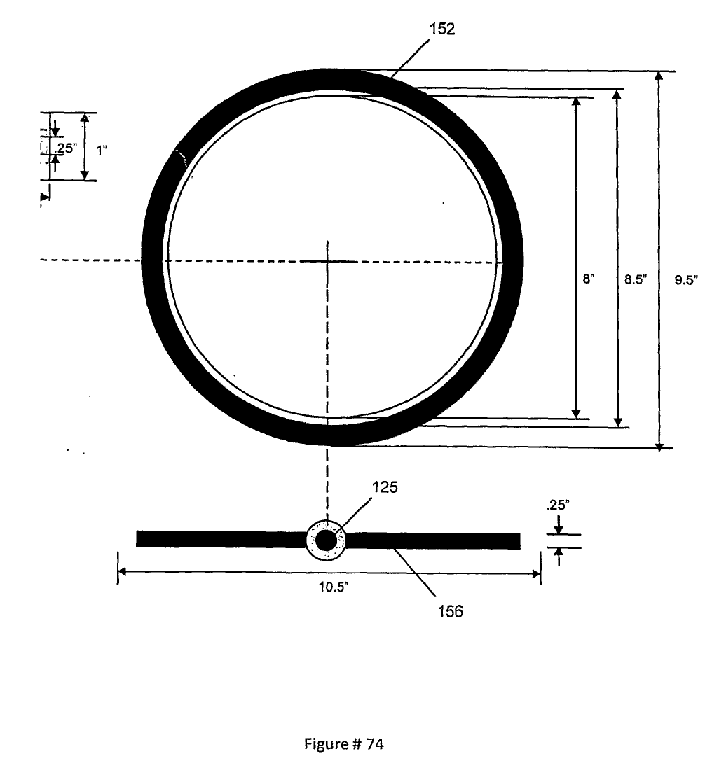

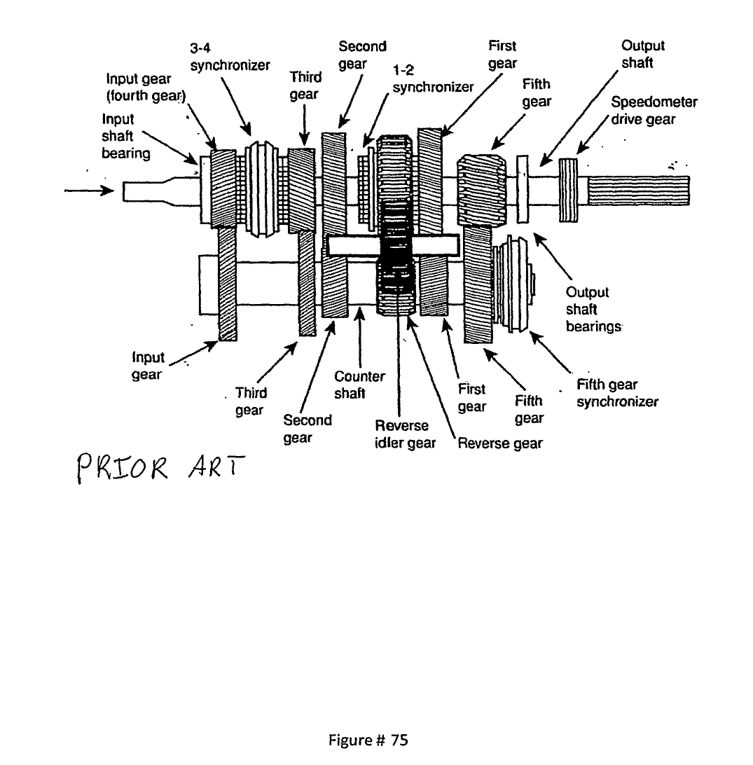

The other limitation is that for the gear heads to move through their entire range of motion, 45°, the universal joints also have to move up to a 45° range. Because universal joints do not operate efficiently beyond about 30°, additional universal joint segments have to be incorporated into the gear system as shown in FIGS. 83-85. FIG. 83 shows input gear head 12 at 45° and output gear head 23 at 45°. FIG. 84 shows input gear head 12 at 90°output gear head 23 at 0°. FIG. 85 shows input gear head 12 at 0° and output gear head 23 at 90°.

Referring to FIGS. 83-85, the embodiment shown in FIG. 82 is further enhanced with the addition of a third input double universal joint 184 connected at a first end to first input central shaft 182, which is connected to first input universal joint 170. Universal joint 180 is connected at a second end to second input central shaft 186, which is connected to second input universal joint 174.

A third output double universal joint 190 is connected at a first end to a first output central shaft 192, which is connected to first output universal joint 176. Third output universal joint 190 is connected at a second end to a second output central shaft 188, which is connected to second output universal joint 180.

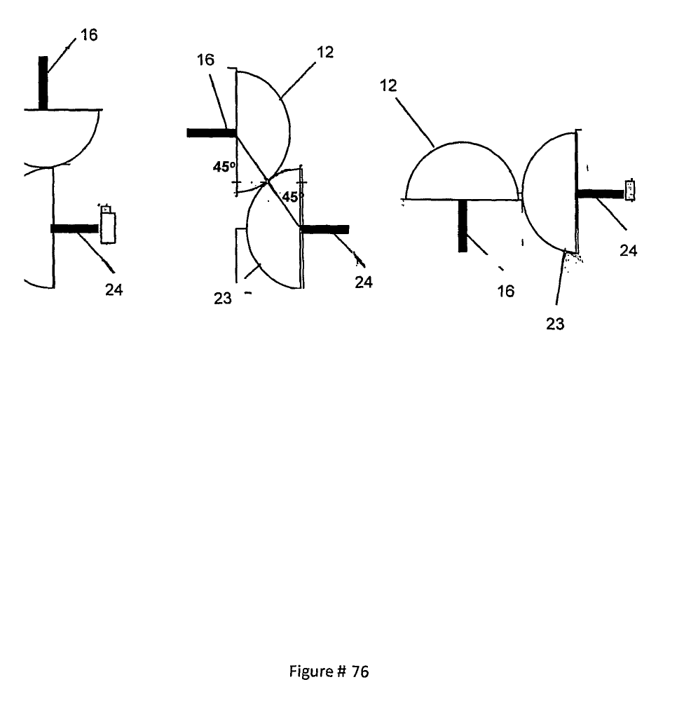

The addition of universal joints 184 and 190 reduces the working angle of all the universal joints as illustrated in FIG. 86. Rather than requiring a working angle of 45°for each universal joint when two universal joints are used per gear head, the addition of a third double universal joint reduces the operational angle range of each universal joint down to about 22.5°. As shown in FIG. 86, for any x-dimension, a y-dimension can be computed to achieve a desired universal joint working angle. This provides considerable flexibility to achieve a desired angle for any application of the gear system.

The working angle can be reduced by either increasing the value of “x” or decreasing the value of “y”. Conversely, to increase the working angle of the universal joints, the value of “x” can be decreased or the value of “y” can be increased. The result is that the input and output shafts can be stabilized and connected the gear heads without requiring any connection shafts to be telescopic or have the property of variable length.

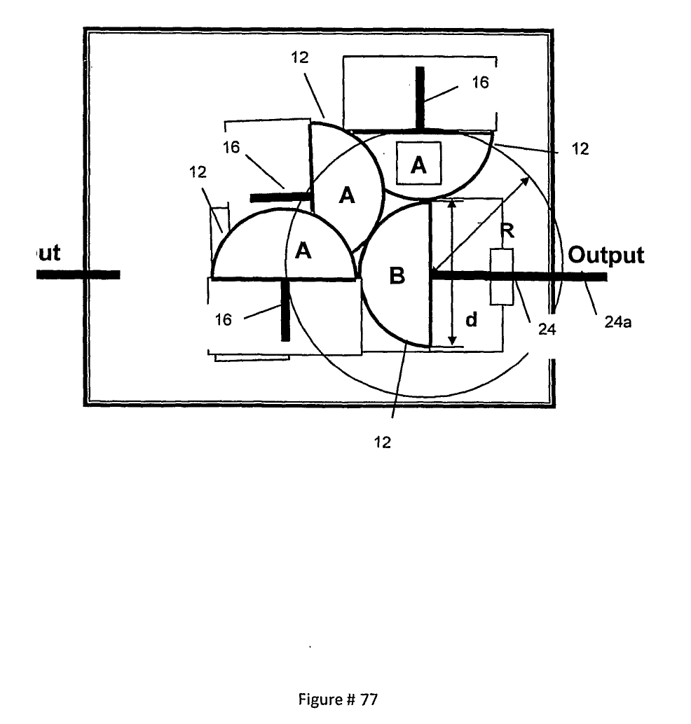

A second alternative to stabilize the input and output shafts is to implement a hemispherical or curvilinear universal joint to stabilize the shafts and allow for the input and output gear heads to rotate through their entire ranges of angular travel. To understand the application of a curvilinear universal joint to stabilize the shafts, a distinction has to be made between a curvilinear gear and a curvilinear universal joint. As shown in FIG. 87, a curvilinear gear includes two interacting gear heads with the gear heads initially displaced and interacting at 45° so that their respective shafts have parallel, but different axes of rotation. In contrast, a curvilinear universal joint includes two interacting gear heads (hemispherical like the curvilinear joint gear heads) with the gear heads each aligned at 90° so that their respective shafts share the same axis of rotation.

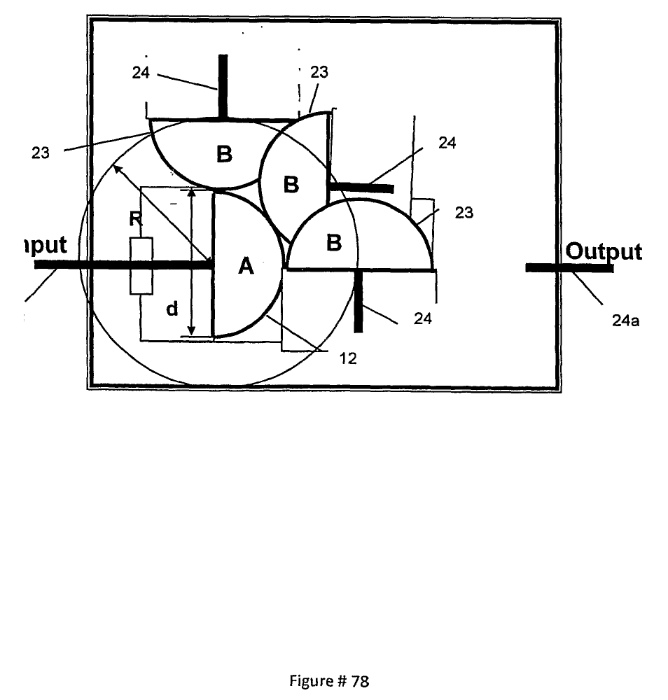

Referring to FIG. 88, the range of motion for a curvilinear universal joint is 180°. Each gear head can rotate =/−90° with the lever arm of each universal joint gear head remaining the same throughout the gear heads range of angular motion. This results in the torque and angular velocity produced by the input gear being passed to the output gear, which is the desired effect of a universal joint.

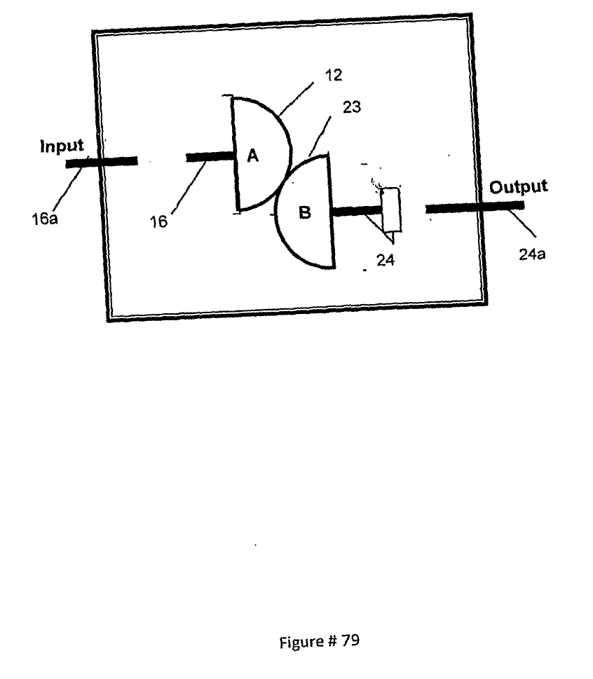

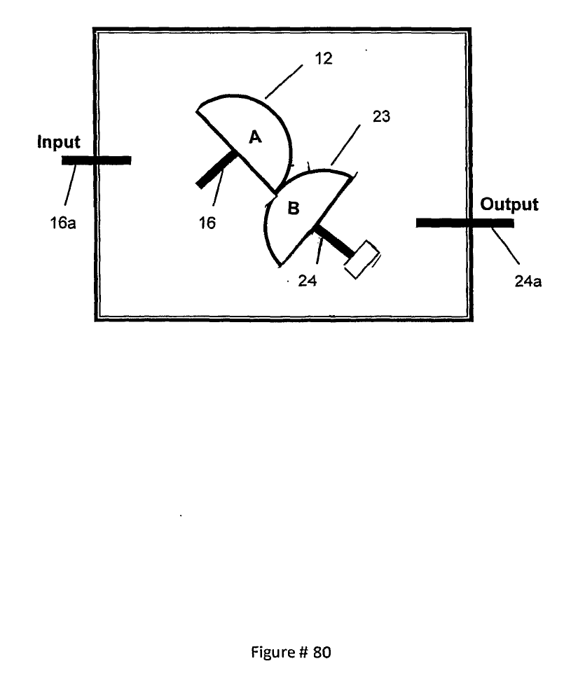

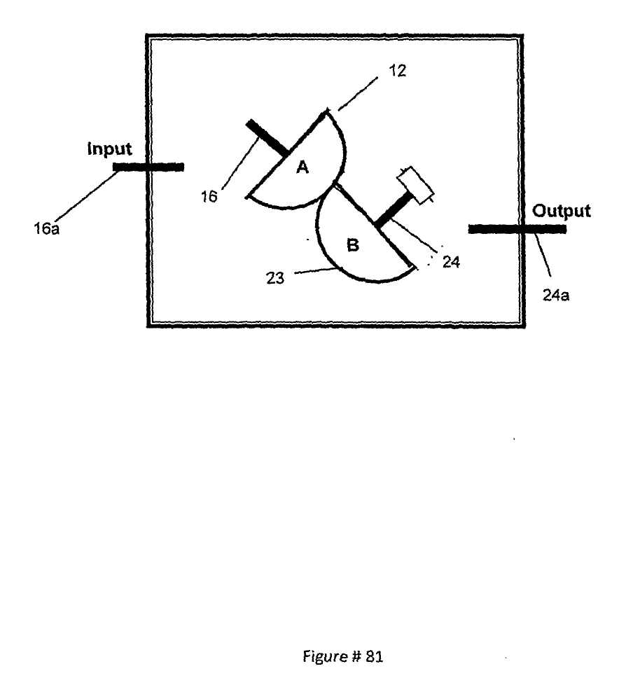

The properties of a curvilinear gear provide an advantageous solution to stabilize the shafts of the gear heads due to the large range of angular rotation. Referring to FIGS. 89-91, a gear system is shown including two curvilinear universal joints integrated with a curvilinear gear. FIG. 89 shows the gear system with gear head 12 at 0°. FIG. 90 shows the gear system with gear head 12 at 45°. FIG. 91 shows the gear system with gear head 12 at 90°.

With this configuration, gear head 12 shares a common pivot point 194 with universal gear head 123, and gear head 23 shares a common pivot point 196 with universal gear head 198. Each common pivot point can shift in tandem as shown by the direction arrows in FIGS. 89 and 91 to accommodate gear head rotation.

Another important consideration is the need for the fixed input/output shafts 16a and 24a to change length to accommodate rotation of the curvilinear universal joints. One solution is to incorporate an input spring 202 in input shaft 16a and an output spring 204 in output shaft 24a. Other alternatives include the gear head configurations described above with respect to curvilinear universal joints.

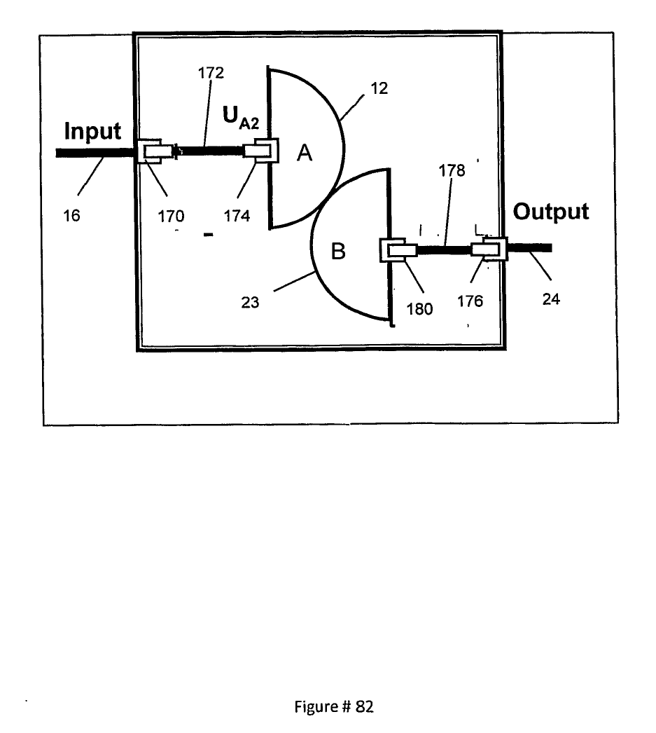

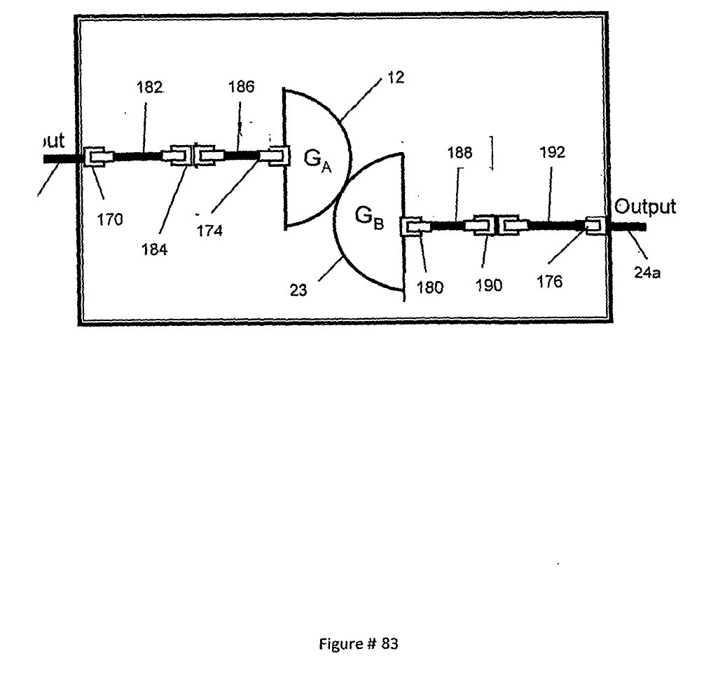

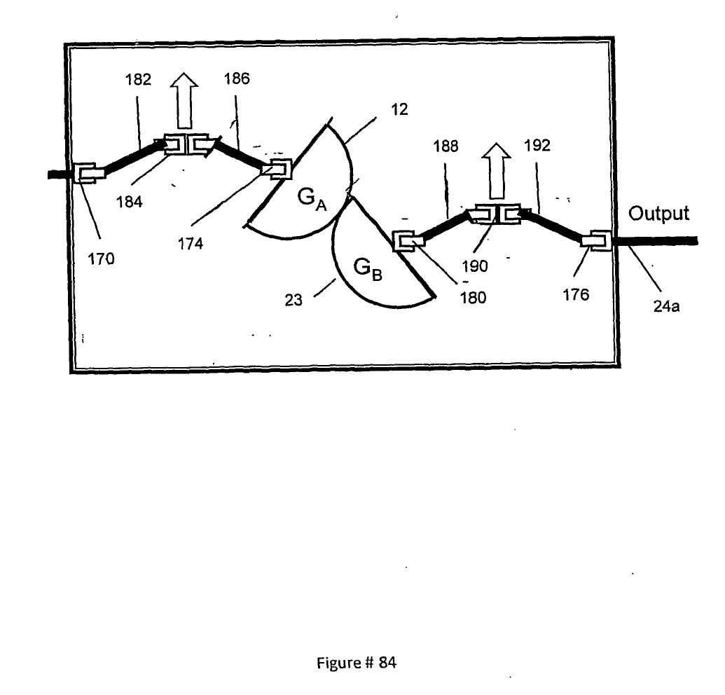

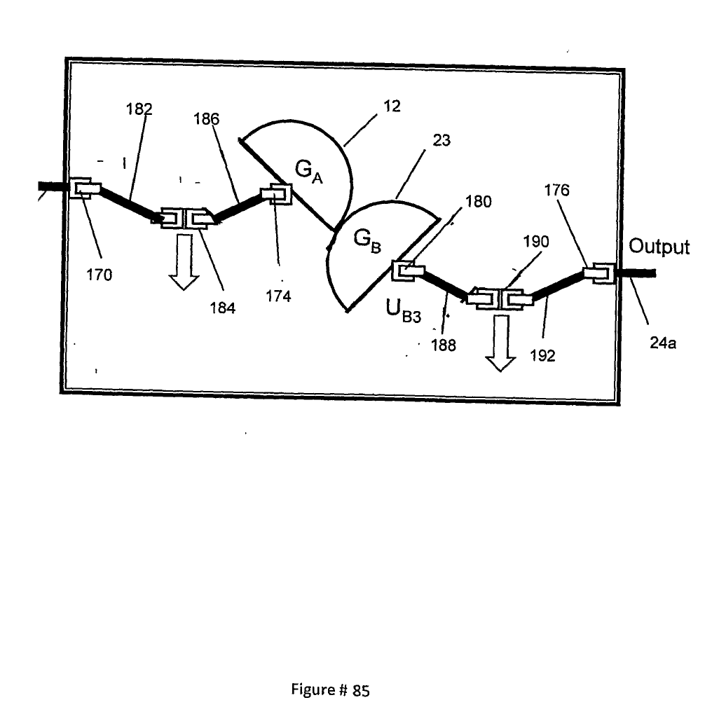

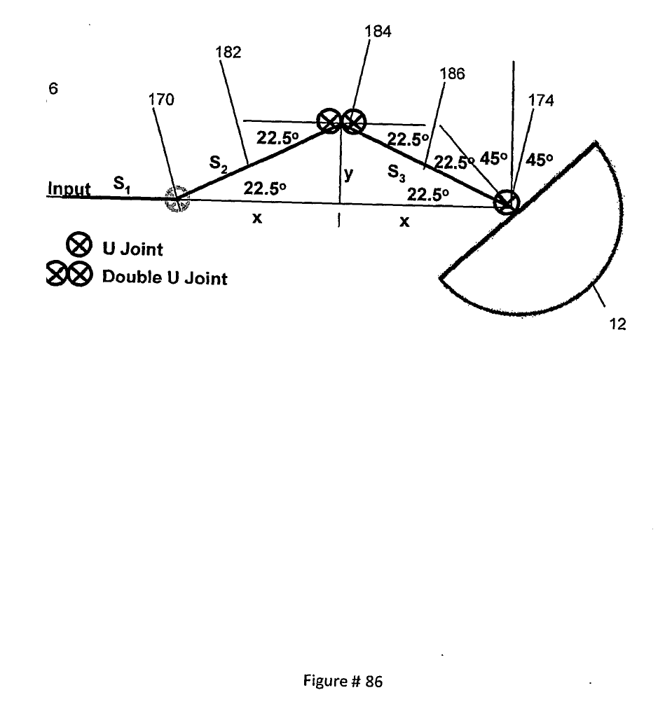

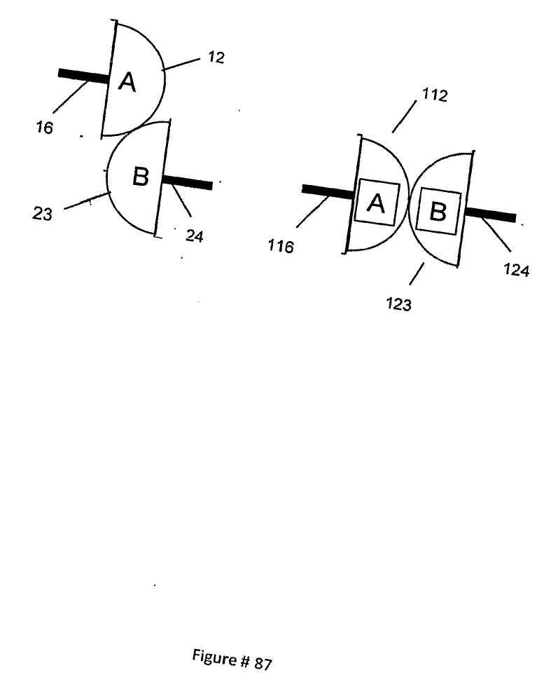

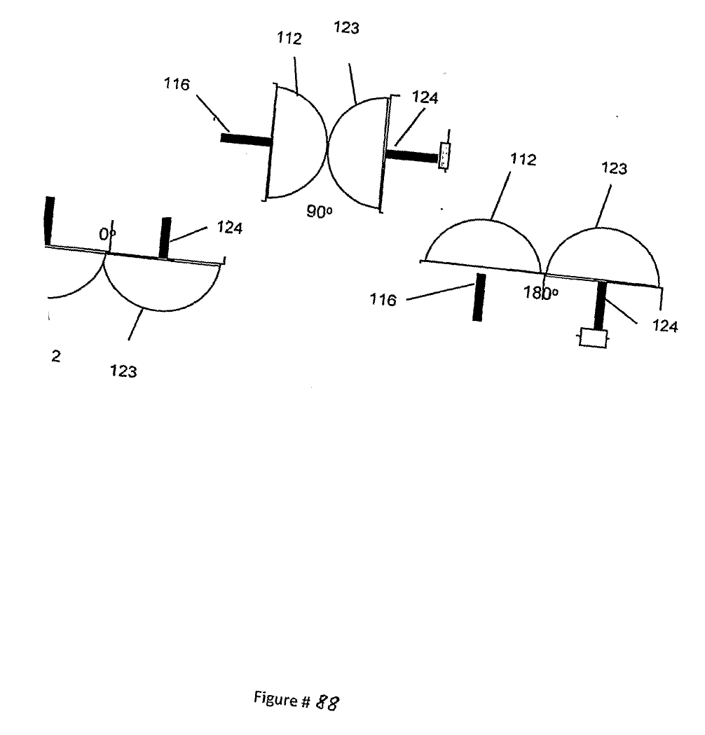

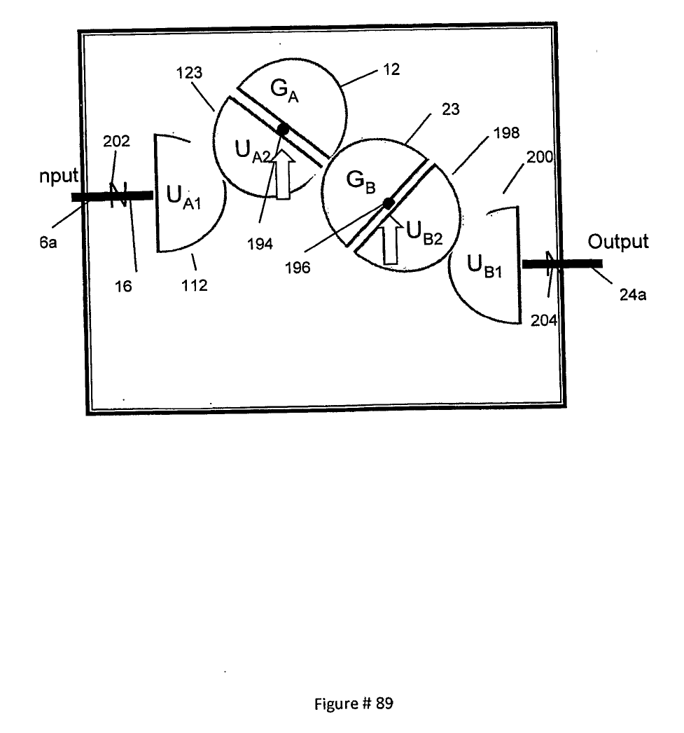

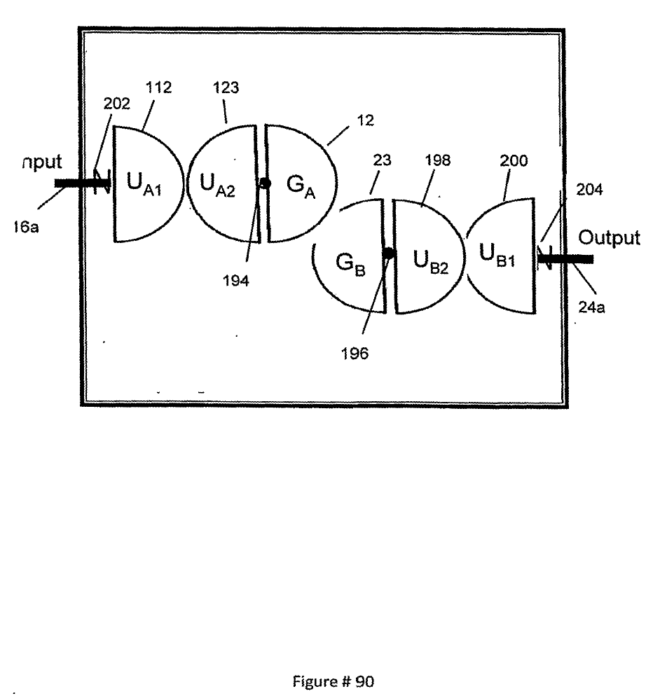

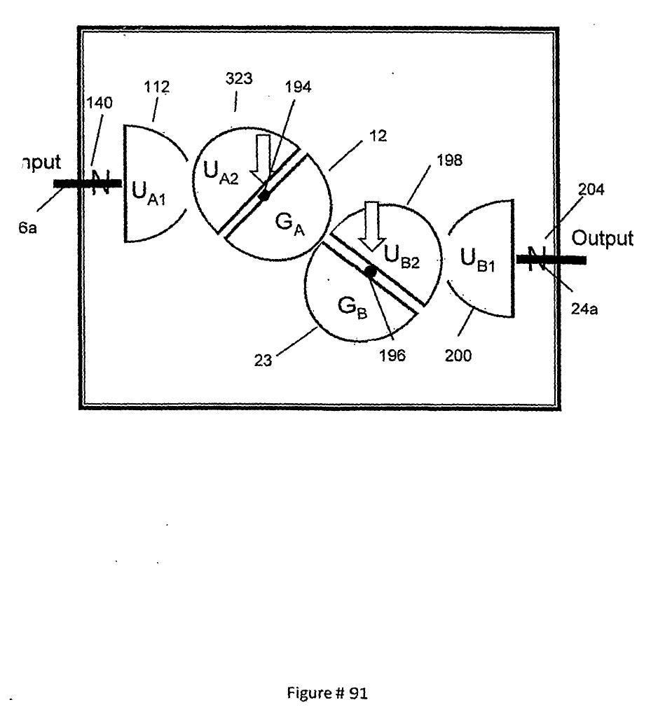

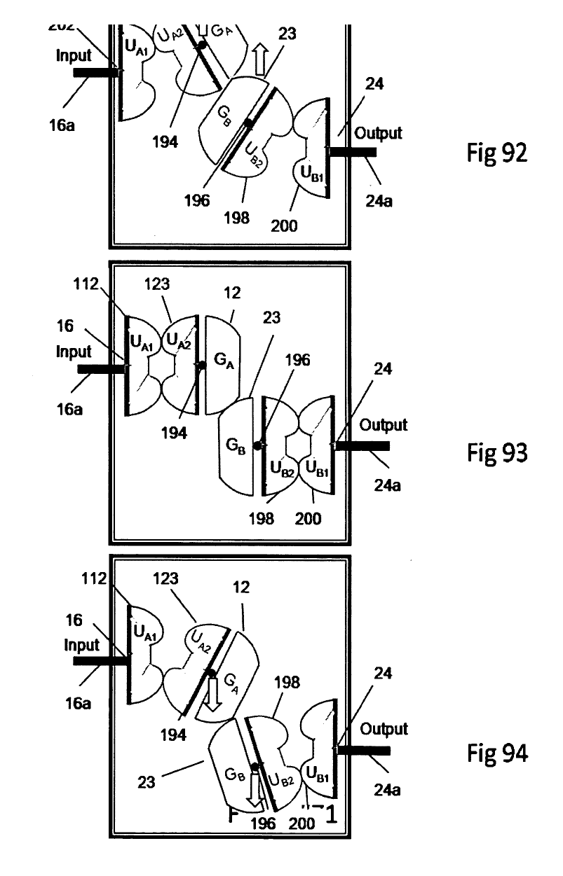

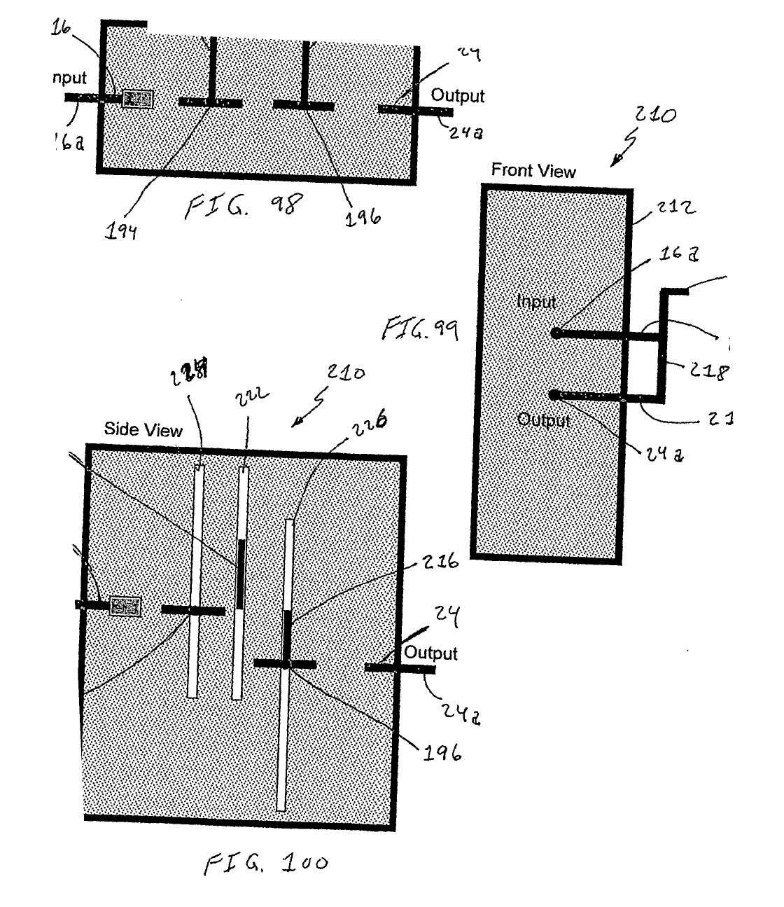

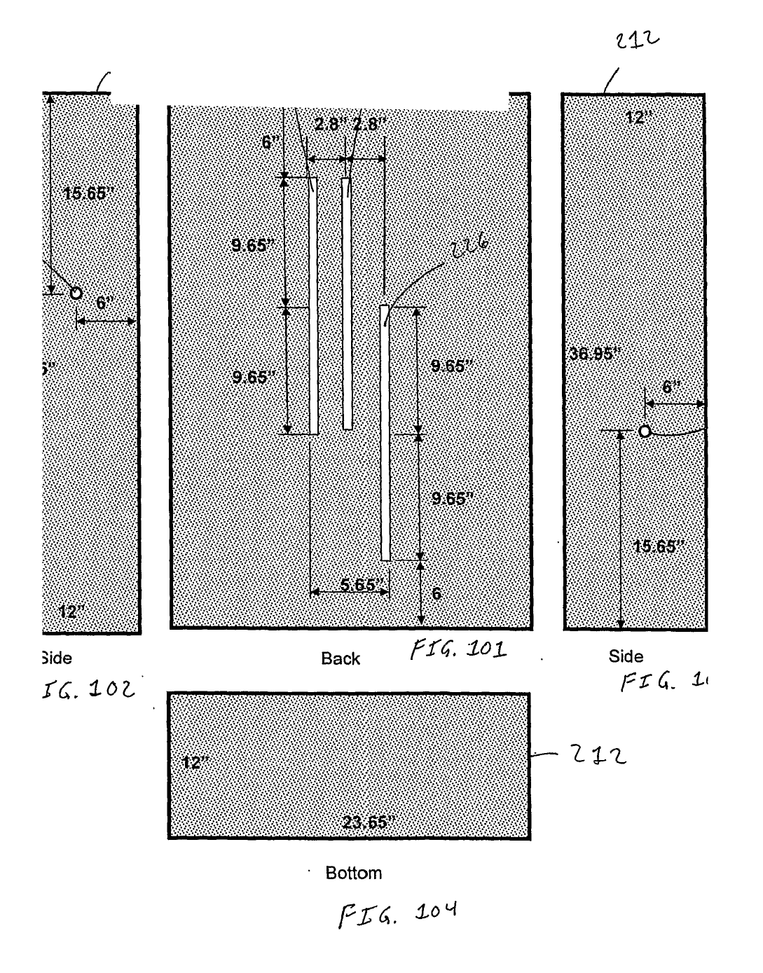

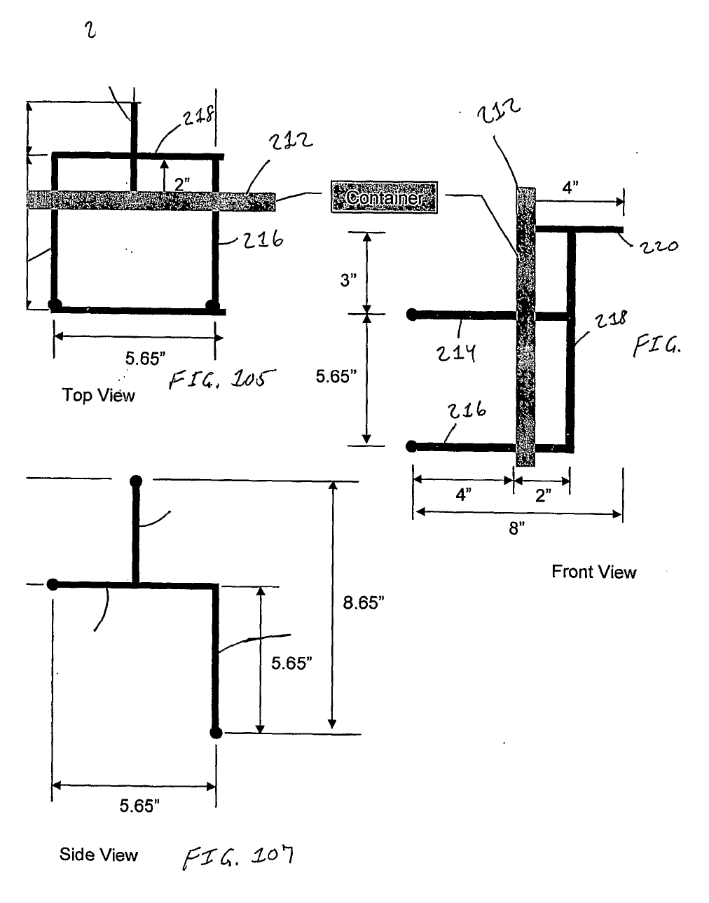

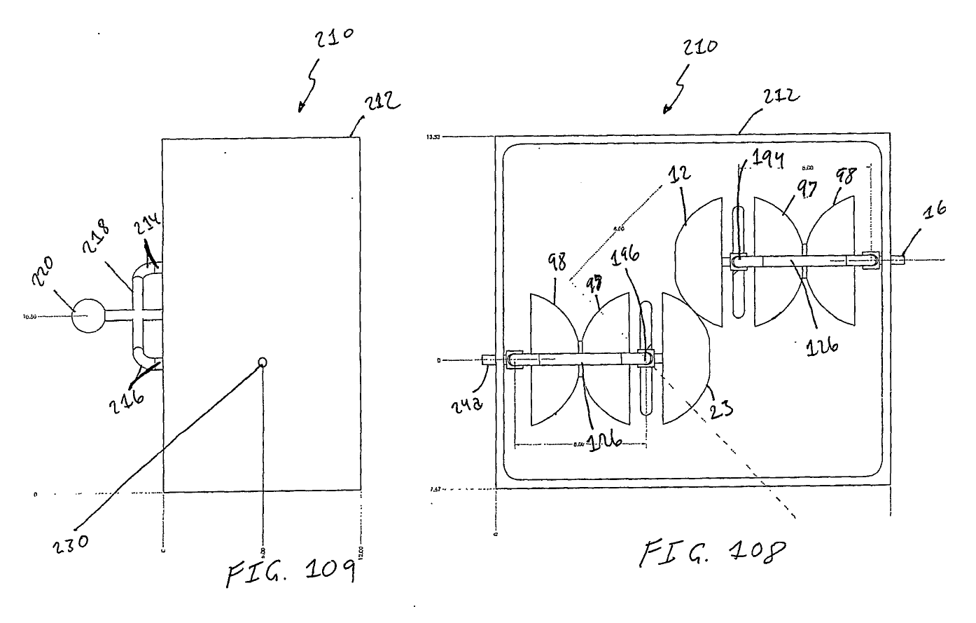

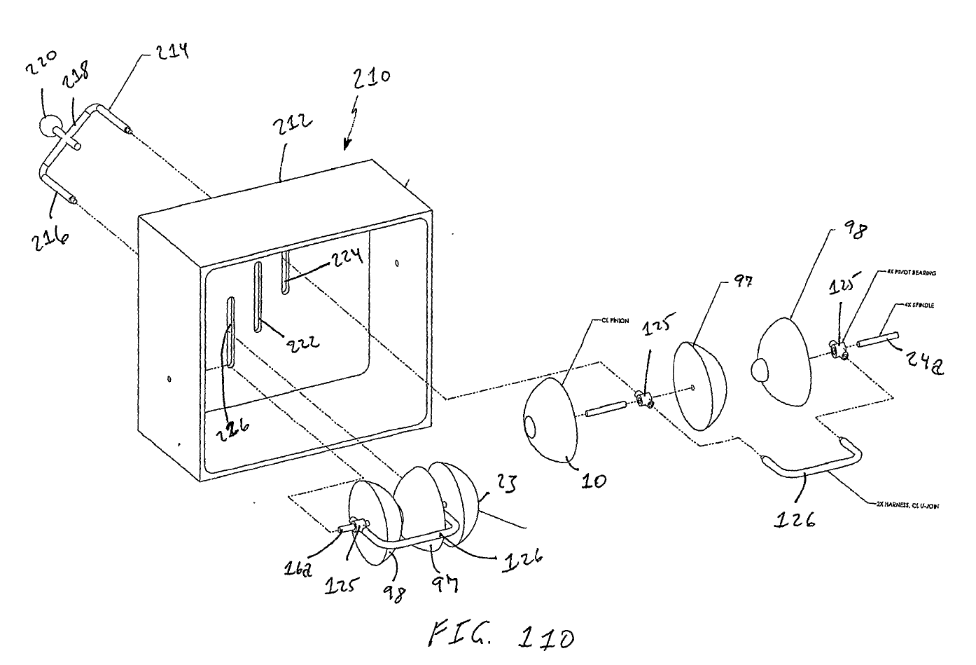

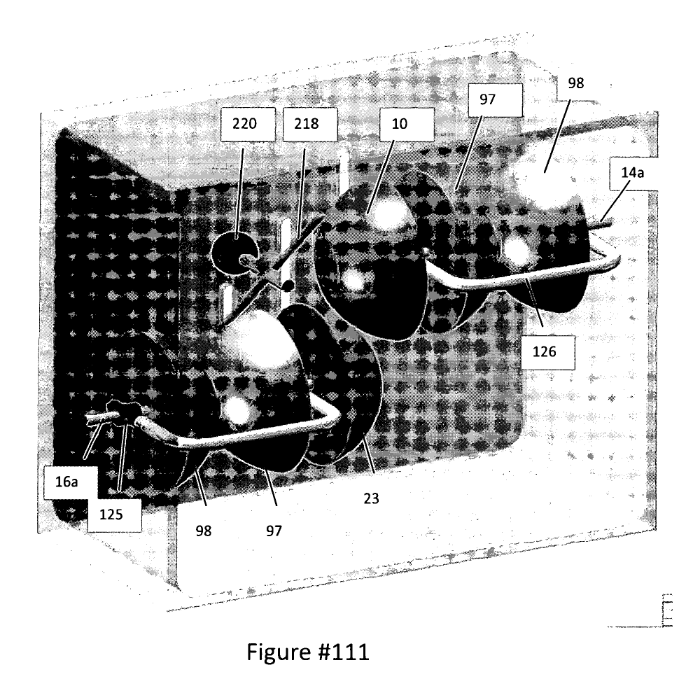

Referring to FIGS. 92-107, a curvilinear transmission apparatus, shown generally as 210, incorporates modified gear heads to eliminate the need to change the lengths of the fixed input and output shafts. The gear head configurations further address the development of a gap between the interacting gear heads when they rotate through their entire angular range of motion. Referring to FIGS. 108-111, a further embodiment of the transmission apparatus is shown with the “no gap” curvilinear gear heads used in the curvilinear U Joint segments of the apparatus.

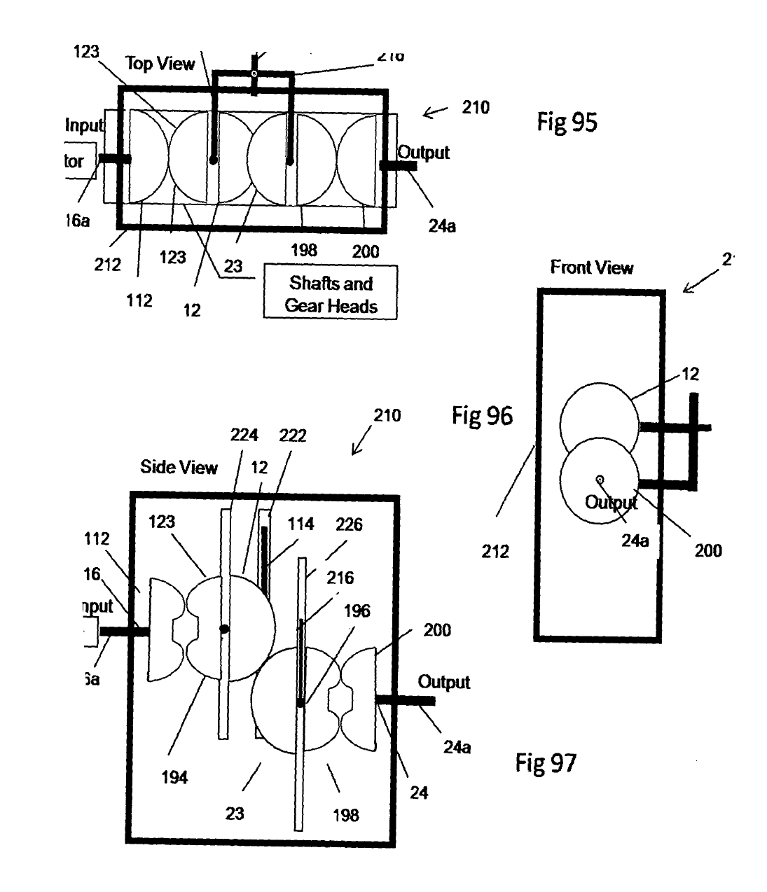

More specifically, as shown in FIGS. 95-111, the gear heads are contained in a gear casing 212 that includes apertures dimensioned to receive input and output shafts, 16a and 24a, so that the shafts rotate freely in the apertures. Casing 212 includes slots 222, 224 and 226 to receive control shafts that control movement of the common pivot points 194 and 196 in a vertical direction in the exemplary embodiment. The slot lengths are dimensioned to allow the pivot points to move throughout the full range of motion to allow the gear heads of the curvilinear gear segment and the curvilinear universal joint segments to rotate throughout the entire range of motion.

An input control shaft 214 connects to common pivot point 194 to control the rotation of input gear head 12 and input universal joint gear head 123. Moving control shaft 214 upwardly results in gear head 12 rotating to 0°. Conversely, moving control shaft 214 in a downward direction results in gear head 12 rotating to 90°.

An output control shaft 216 connects output common pivot point 196 to control the rotation of output gear head 23 and output universal gear head 198. Moving output control shaft 216 upwardly results in gear head 23 rotating to 90°. Conversely, moving control shaft 216 in a downward direction results in gear head 12 rotating to 0°.

To move control shafts 214 and 216 in unison, a shaft connector 218 is used. Shaft connector 218 is connected to ends of shafts 214 and 216. A center shaft 22 is used to manipulate the control shafts in a controlled uniform manner.

Having described a transmission constructed from curvilinear universal joints and curvilinear gears, attention is drawn to interacting surfaces between interacting gear heads. Options include friction surfaces and physical mechanisms including teeth and spline configurations. The tooth and spline descriptions provided herein apply equally to gear heads employed in a curvilinear transmission apparatus.

The gear system heretofore described provides a considerable reduction in parts with respect to power transfer devices such as transmissions. This reduces the costs associated with production, reduces part counts, increases reliability, increases maintainability, and provides a means to reduce device volume and weight. The novel system further allows gear ratios to change in a continuous manner as opposed to the step manner resulting from conventional technologies.

It has been shown that the curvilinear u joint is geometrically different than current U Joints and that its operational characteristics are also different. It was also shown that the Curvilinear Gear builds on the basic component of a Curvilinear Gear, the curvilinear gear head. And it was shown how the Curvilinear Universal Joint compliments the Curvilinear Gear.

The Curvilinear U Joint simplifies the concept of a universal gear and results in fewer moving parts. This concept can also support higher torque applications and more than double the range of motion now available using current technology.

While the present invention has been described in connection with one or more embodiments thereof, it will be apparent to those skilled in the art that many changes and modifications may be made without departing from the true spirit and scope of the invention. Accordingly, it is intended by the appended claim to cover all such changes and modifications as come within the true spirit and scope of the invention.

Having thus described my invention, what I claim as new and desire to secure by United States Letters Patent is:

1. A curvilinear gear system comprising:
a first gear having a curvilinear hemispherical surface and a flat surface opposite the hemispherical surface;
a first shaft attached to the flat surface at an axis of rotation for the first gear;
a second gear having a second curvilinear hemispherical surface and a second flat surface opposite the second hemispherical surface;
a second shaft attached to the second flat surface at an axis of rotation for the second gear wherein the hemispherical surfaces of the gears interact to transmit torque and speed.

2. The curvilinear gear system of claim 1 further comprising:
a harness having portions defining two opposing apertures; and
two bearings, a first bearing having a bore for receiving the first shaft and a second bearing having a bore for receiving the second shaft wherein the bearings are dimensioned to fit within the harness apertures.

3. The curvilinear gear system of claim 2 wherein the first gear and the second gear have friction surfaces.

4. The curvilinear gear system of claim 2 wherein the first gear and the second gear have surfaces comprising intermeshing structures.

5. The curvilinear gear system of claim 4 wherein the intermeshing structures are gear teeth.

6. The curvilinear gear system of claim 4 wherein the intermeshing structures are splines.

7. The curvilinear gear system of claim 1 wherein the second gear has an elliptical curvilinear surface.

8. The curvilinear gear system of claim 1 wherein the first gear has a planar surface at an apex adjacent to the curvilinear surface.

9. The curvilinear gear system of claim 8 further comprising a radiused transition between the curvilinear surface and the planar surface wherein the planar surface is recessed.

10. The curvilinear gear system of claim 9 wherein the second gear has a planar surface at the apex.

11. The curvilinear gear system of claim 10 wherein the second gear has an involute surface between the curvilinear surface and the planar surface.

12. The curvilinear gear system of claim 10 further comprising a radiused transition between the curvilinear surface and the planar surface wherein the planar surface is recessed.

13. A curvilinear universal joint system comprising:
a first gear having a curvilinear hemispherical surface and a flat surface opposite the hemispherical surface;
a first shaft attached to the flat surface at an axis of rotation for the first gear;
a second gear having a second curvilinear hemispherical surface and a second flat surface opposite the second hemispherical surface;
a second shaft attached to the second flat surface at an axis of rotation for the second gear wherein the axis of rotation of the first gear is coplanar with the axis of rotation of the second gear.

14. The curvilinear universal joint system of claim 13 further comprising
a first spring housing connected to an end of the first shaft and connected to the flat surface of the first gear;
a first spring positioned in the first spring housing so that one end registers against the end of the first shaft and the other end registers against the inside of the spring housing;
a second spring housing connected to an end of the second shaft and connected to the flat surface of the second gear; and
a second spring positioned in the second spring housing so that one end registers against the end of the second shaft and the other end registers against the inside of the second spring housing.

15. The curvilinear universal joint system of claim 14 further comprising a harness to receive the first shaft and the second shaft to maintain the first gear in contact with the second gear.

16. The curvilinear universal joint system of claim 15 further comprising:
a first universal joint connected to the first gear at one end and to the first shaft at the other end;
a second universal joint connected to the second gear at one end and to the second shaft at the other end.

17. The curvilinear universal joint system of claim 16 further comprising a second set of universal joints connected to free ends of the first shaft and the second shaft.

18. A curvilinear transmission system comprising:
at least one curvilinear gear system comprising:
a first gear having a curvilinear hemispherical surface and a flat surface opposite the hemispherical surface;
a first shaft attached to the flat surface at an axis of rotation for the first gear;
a second gear having a second curvilinear hemispherical surface and a second flat surface opposite the second hemispherical surface;
a second shaft attached to the second flat surface at an axis of rotation for the second gear wherein the hemispherical surfaces of the gears interact to transmit torque and speed;
at least one curvilinear universal joint system comprising two curvilinear gears and two shafts, each connected to a curvilinear gear wherein one gear shares a common pivot point with one gear of the curvilinear gear system.

19. The curvilinear transmission system of claim 18 further comprising an enclosure for maintaining the gears in physical contact and a control lever for controlling the angular orientation of the curvilinear gears.

20. The curvilinear transmission system of claim 18 further comprising a at least one cam;
at least one cam housing having an irregular chase wherein the cam is positioned in the housing and the chase surrounds the housing:
a first bearing having a bore and positioned in the chase;
a rod having an end secured in the bore of the first bearing;
a second bearing having a bore for receiving the first shaft wherein the other end of the rod is connected to the second bearing.
